(19) United States
(12) Patent Application Publication
(10) Pub. No.: US 2005/0122549 A1
(43) Pub. Date: Jun. 9, 2005

(54) Computer assisted hologram forming method and apparatus

(76) Inventors: Emine Goulanian, British Columbia (CA); Faouzi Zerrouk, British Columbia (CA)

Correspondence Address: Vermette & Company, Box 40 Granville Square, Suite 230 200 Granville Street, Vancouver, BC, V6C 1S4, CA

(21) Appl. No.: 10/497,360

(22) PCT Filed: Dec. 3, 2002
(86) PCT No.: PCT/CA02/01863

(30) Foreign Application Priority Data
Dec. 3, 2001 (CA) 2,364,601

(51) Int. Cl. G03H 1/02

(52) U.S. Cl. 359/3

(57) ABSTRACT

The present invention provides a computer-assisted hologram forming method and apparatus. More particularly, the present invention provides a method for forming a hologram that can be illuminated to produce a more accurate three-dimensional optical image of an object.

### FIELD OF THE INVENTION

The present invention relates generally to holography, and more particularly to methods and apparatuses for forming holograms of any object by means of optical techniques handled or controlled by a computer in accordance with three-dimensional data representing said objects in a computer database, and thereby for recording their three-dimensional images which are reproducible by such hologram imaging or rendering to be preferably used for viewing.

### BACKGROUND OF THE INVENTION

Holograms can be used for diverse visual applications in a wide variety of fields, including but not limited to, art, advertisement, design, medicine, providing of amusement, entertainment, engineering, education, scientific research, and others associated with examination of information filling a three-dimensional space containing an object and visual perception of this information in the form of three-dimensional images. Affording an observer (a viewer) better conditions for improving an observation of images reproducible by such holograms and facilitating a perception of their depth and variability at different perspectives, and presenting a higher image quality by providing a better reproduction of details and shades of the objects stored in said database are all important for visual applications in said fields, while having an opportunity of on-line communication (or transmission) of proper data to a remote user or users for producing a hologram or holograms is highly desirable. The present invention allows for producing the hologram(s) adapted for such visual applications in all aspects and offers great opportunities in communicating or transmitting proper data for providing reproduction high quality images by such holograms.

Since the beginnings of holography a multiplicity of concepts have been proposed by researchers for realistically reproducing three-dimensional images of three-dimensional objects using holograms. This interest has intensified with the increasing importance of using three-dimensional (3-D) data in computer based systems, which may correspond to 3-D virtual objects resulting from computer simulations in such fields as architecture and mechanical design, or to physical objects (i.e. objects which actually exist). There is an increasing importance for determining an object's relative location and orientation at remote work sites (see, for example, U.S. Pat. No. 5,227,898) or for analyzing results of CAT, MRI, and PET scans of human body parts (see U.S. Pat. No. 5,117,296), and so forth. This interest appears first and foremost due to the fact that a three-dimensional image is much more informative, expressive, illustrative and variable as compared with a two-dimensional image, to say nothing of the fact that taking visual information in the form of 3-D images is inherent to the very nature of human visual perception.

By viewing a two-dimensional (2-D) image of any actual or virtual object represented on a conventional photograph, transparency, drawing, picture, TV or CCD camera view and the like, or displayed on a CRT, moving picture screen, computer display and so on, one can see only the same image even when changing viewing position. Undoubtedly, by observing a multiplicity of relevant 2-D images, an observer may create a 3-D mental image or model of a physical object or physical system. The accuracy of the 3-D model created in the mind of the observer is a function of the level of skill, intelligence and experience of the observer, as well as the complexity of the object or its parts to be observed and other circumstances. Evidently, an integration of a series of 2-D images into a meaningful, understandable 3-D mental image places a great strain on the human visual system, even for a relatively simple three-dimensional object (see, for example, U.S. Pat. No. 5,592,313). As to the complex object, it can then become understood from its successive 2-D projections onto a computer display screen to those who spend hours studying this object from many different viewpoints, rather than to a common viewer not skilled in such a mental integration. The use of computer programs, such as multifunctional graphics for a large computer system, enables the viewer to quickly and easily grasp relationships between large amounts of data projected on the visual display. But, the convenience and flexibility of such visual displays is often purchased with expensive computer processing power because, for instance, changing a viewpoint at which the object is viewed essentially requires a recomputation of all points in the display. Moreover, as a matter of fact, conventional visual displays fail to present three-dimensional images in any case due to a loss of 3-D information on flat screens. Only monocular cues to distance are preserved such as size, linear perspective, and interposition. No binocular or accommodative cues to distance are available (see U.S. Pat. No. 5,227,898). This circumstance is very important because the loss of 3-D information is one of the fundamental reasons why viewing different 2-D images by means of conventional techniques turns out to be insufficient for creating an impression of a single 3-D mental image.

That is why at least some new concepts have been proposed to facilitate integrating (or combining) different 2-D images in the mind by providing favorable conditions for their observation and perception. One of these concepts pertaining to a noticeable trend in 3-D imaging techniques is based on providing an observer with images of different sectional components of an object (sectional images) in such a way as to create an effect of a three-dimensional image continuous in the depth direction. Diverse implementations of this concept are useful especially when 3-D data representing an object in a computer database is specified as a set of points in 3-D virtual space, all of which should be visible simultaneously and each of them is assigned with some intensity value. The sectional components of that object may be serial planar sections made through the object and represented by photographic transparencies. The components may be a set of 2-D intensity pictures generated by mathematically intersecting a plane at various depths within the 3-D collection of points and represented by intensity modulated regions on a CRT screen. The components may be a number of cross-sectional views of the 3-D physical system (e.g., of a human body part) represented by results of CAT, MR and PET scans or other medical diagnosis and so on (see U.S. Pat. No. 5,117,296 mentioned above, U.S. Pat. No. 4,669,812 and U.S. Pat. No. 5,907,312).

In another method embodying this concept, images of sectional components of the object are successively displayed on a cathode-ray tube (CRT) and then presented to a deformable mirror system varying its focal length in respective states of mirror deformation to cause the appearance of these sectional images at different distances from the observer. A process of presenting sectional images is repeated at a rate which causes perceptual fusion to the observer of these images into a 3-D mental image (see, for example, U.S. Pat. No. 3,493,290 and U.S. Pat. No. 4,669,812).

Another method embodying this concept uses a flat screen moving from an initial position to a final position at a constant speed and instantly returning to the initial position, and further repeating this cyclic movement substantially in a saw-tooth-like profile. Images of successive sectional components representing different depths within an object (called “depth planes”) are focused in turn onto the moving flat screen at times when its respective position corresponds to the appropriate relative depth of said sectional component. When the process of presenting images of different depth planes is performed beyond the flicker fusion rate, the observer sees all depth plane images simultaneously at the positions corresponding to the depths of such sectional components within the object, i.e., these images appear as a single 3-D image (see U.S. Pat. No. 4,669,812).

Still another method is realized by a volumetrically scanning type of three-dimensional display. The images of depth planes in this method are projected in turn to the moving flat screen by means of raster scanning with laser light under control of a computer (in accordance with control data) through an X-Y deflector and a modulator assigning said laser light intensity. The 3-D image appears as an afterimage in the viewer's eyes on the condition that the scanning speed of the laser beam and speed of the moving flat screen are sufficiently synchronized with each other (see U.S. Pat. No. 5,907,312).

However, all these methods require the use of complex mechanisms to assure synchronization of mechanical movement (or deformation) of an optical element (moving screen or deformable mirror) in such a way that an image of each sectional object component (a sectional image) presented to said optical element at the precise moment appears at the proper depth within the 3-D mental image. This circumstance, as well as the process of the complicated mechanical movement (or deformation) seriously limits the performance capabilities of the respective apparatus (visual display) and the flexibility of its transformation. Besides said circumstances, a sufficiently large memory should be provided prior to the initiation of said process to store data processing, i.e., 2-D data relating to each sectional object component (sectional data or depth data), as well as original 3-D data representing said object. Further, due to flicker fusion rate requirements, a necessity of updating the CRT once for each sectional component is a limiting factor in achieving desired resolution of each sectional image, and hence of the complete 3-D image. Furthermore, the 3-D image obtained by these methods is a semi-transparent one in which its rear side (hidden line and/or hidden surface area) appears due to scattering light by conventional (e.g., diffuse) screens in all directions. This last circumstance as well as problems associated with using complicated mechanical movement is a principal drawback of these methods.

One of embodiments disclosed in U.S. Pat. No. 5,907,312 provides for using the relative position data of points of each depth plane image and data relating to a plurality of viewpoints in a field of view for eliminating hidden lines and/or hidden surface areas when preparing control data. All embodiments, instead of the conventional screen, use a moving flat screen composed of a large number of pixels each having a plurality of diffraction elements (elementary holograms) each capable of diffracting light in a different predetermined direction. Diffracted rays of light from elementary holograms of each pixel are controlled so as to be seen as being emergent from one point source. All pixels composing the moving flat screen are made to be similar. The employment of reflection (Lippman) type elementary holograms requires scanning means for scanning the moving flat screen with laser light. By contrast, using transmission (Fresnel) type elementary holograms requires means for enlarging a laser beam in size and means for spatially modulating the intensity of transmitted light (like a liquid crystal panel) to illuminate each pixel of the screen. The liquid crystal panel having a large aperture number is integrally overlaid on the moving flat screen in such a way that its pixels can be correctly matched with diffraction elements (elementary holograms) of the screen. Thereby, only necessary diffraction elements corresponding to the pixels selected under control of the computer are illuminated with laser light of the desired intensity. The computer determines directions from the viewpoint towards hidden line and/or hidden surface areas. The computer then determines rays of light to be directed or not from a plurality of diffraction elements of each screen pixel and then controls modulation of light illuminating each diffraction element of this pixel. That is why the 3-D image thus obtained may be observed from any desired viewpoint without the hidden rear side of the object appearing.

However, this 3-D image is purchased with a redundancy in information to be processed due to the necessity of selecting each diffraction element as being seen or not from a plurality of viewpoints. A multiple control of the direction of every diffracted ray of light emanating from each of the point sources representing pixels of the moving flat screen results in a considerable increase in the amount of both computation time and information to be updated at respective positions of the moving flat screen. This circumstance causes, when maintaining the field of view, either the imposition of limitations on the achievable resolution of each depth plane image to compensate for such an increase in information to be processed or the setting of a widened depth plane interval (spacing) within the object to meet flicker fusion rate requirements. However, as a result of such limitations, fine image details (or small image fragments), perhaps important to the observer, are substantially lost, hence reducing the quality of the three-dimensional image to be reproduced. On the other hand, if the depth plane spacing becomes too large, the impression of a 3-D image continuous in the depth direction can disappear and be substituted by a set of separate depth plane images in the field of view. One of the fundamental reasons for such a circumstance is a loss of three-dimensional aspects in each depth plane image (i.e., in the image of each sectional object component) when calculating and presenting this image by means of the moving flat screen.

Another fundamental reason for such a circumstance may be associated with the lack of mutual information pertaining to a visually perceived relationship between sectional data stored in different depth plane images. This other reason is explained by the fact that each depth plane comprises only data related to a particular depth within an object or, in general, that any given point in 3-D virtual space containing an object is represented by only one point in one depth plane. Therefore, when employing the concept of the sectional representation of the object in 3-D imaging techniques, said circumstances and peculiarities relating to conditions of using computational and optical techniques turn out to be important, and so they should be taken into account as being able to limit the possibilities of improving conditions of the observation and perception of depth plane images and increasing the image quality as well.

To avoid some of the problems associated with using complicated mechanical movement, a further method providing for the employment of off-axis multiple component holographic optical elements (called mcHOEs) in combination with transparencies representing a set of serial planar object sections has been proposed in U.S. Pat. No. 4,669,812. These holographic optical elements (HOEs) are transmission or reflection type holograms each made with two point sources of diverging light and termed “off-axis” if either of the point sources lies off the optical axis. Each hologram acts as a lens-like imaging device with an assigned focal length and causes an image of a respective transparency to appear centered along the optical axis at a predetermined depth. Each of said transparencies has a diffuser screen (a ground glass type) and is disposed on a holder in order to be illuminated sequentially. When the rate of sequential illumination of the transparencies exceeds the flicker fusion threshold of the viewer, the individually projected depth plane images are fused (to the viewer) into a 3-D mental image in the field of view. The rate of sequential illumination, hence, is a limiting factor, and if said illumination is too slow, the depth plane images will flicker and no fusion will result. Were all transparencies evenly (or simultaneously) illuminated, the viewer would see a discrete set of depth planes images each at a different depth, rather than a continuous, fused 3-D image of the object.

However, the employment of mcHOEs requires a great deal of intermediate representations, i.e., transparencies, scans or similar hardcopies, to be preliminarily created, especially when executing in the assigned field of view a procedure of removing hidden lines and/or hidden surface areas, which otherwise would be plainly visible to the viewer. If any available set of transparencies is not the one that the viewer would like to select due to poor quality of depth plane images or his (or her) desire of having other discernible image details, an additional set of HOEs, one for each additional transparency, should be created. This also applies for other cases when the depth plane spacing needs to be changed. The necessity of creating numerous transparencies or like hardcopies and an equal number of HOEs and also matching positions of depth plane images along the optical axis is a limiting factor requiring a large amount of time, restricting flexibility of furthering the method and limiting the possibility of using this method to those who are skilled in the relevant art, rather than allowing use by common users.

A still further method and apparatus described in U.S. Pat. No. 5,117,296 provides for the employment of similar off-axis multiplexed holographic optical elements (mxHOE) in combination with CRT addressed liquid crystal light valves (LCLVs) instead of transparencies, thus removing problems related with preparing and using the latter. Each object section may be computer-generated, for example, by the mathematical projection of each 3-D point (x, y, z) to one appropriate section at a position along the optical (z) axis corresponding to the location of an image of that respective section (a sectional image). Since each section is independent from any others, some parallel processing means in a master controller or graphics processor may be employed for producing sections from 3-D data and for subsequent writing each sectional data set to its respective LCLV. The mxHOE contains independent (multiplexed) holographic optical elements each relating to one of object sections and having a definite focal length to place an image of that section in a certain position at a predetermined depth along the optical axis. This method and apparatus provide for composing the 3-D image prior to recording it as a hologram.

However, in contrast to the preceding method, from U.S. Pat. No. 4,669,812, all sectional images are created simultaneously. This circumstance greatly deteriorates the conditions of their perception and, in practice, a common observer (viewer) not skilled in their mental integration usually watches a set of separate sectional images disposed at discrete distances along the optical axis, rather than a single 3-D image. Simultaneous sectional images have also been produced in other methods, for example as described in U.S. Pat. No. 4,190,856.

This situation requires affording an observer an extended field of view and an increased number of sectional images to improve perception of a relationship between sectional data stored in these images and thereby facilitate their integrating into a meaningful and understandable 3-D mental image. But, the method of U.S. Pat. No. 5,117,296 just described has a limited field of view permitting the viewer to watch along the optical axis. A larger field of view requires much more information content for each of the sectional images to be presented for providing variability when viewing from different viewpoints. As a result, a redundancy in information to be processed arises due to a necessity of representing each object point in each sectional image from numerous viewpoints. Accordingly, a sufficiently larger memory for storing data processing (sectional data) as well as the original 3-D data is required. Further, the larger the number of sectional images the more in turn the number of off-axis LCLVs which increases the complexity of the sectional image combining means and the bulkiness of said apparatus as a whole. Each of such circumstances relating to conditions of using said optical and computational techniques is capable of limiting possibilities of improving conditions of the observation and perception of depth plane images in every particular implementation. As a result, taking into account these circumstances is important when producing holograms adapted for visual applications in the various mentioned fields above. Moreover, as in the preceding method, additional HOEs must be created and matched with sectional images when increasing their number. This requires a large amount of time and restricts the flexibility of the method of U.S. Pat. No. 5,117,296 and limits the possibility of using it to those who are skilled in the relevant art, rather than allowing its use by common users. Because of that, a redundancy in information to be processed as well as a necessity of creating additional HOEs and using qualified personnel when increasing the number of sectional images, are the limiting factors for the U.S. Pat. No. 5,117,296 method and apparatus.

It is worth noting that coherent radiation is used in optical techniques handled by the computer in the mentioned methods and apparatus relating to 3-D imaging techniques only for presenting images of sectional object components. For providing variability in each of the sectional images and eliminating a plainly visible rear side in a 3-D image thus obtained, a procedure like a hidden line and/or hidden surface area removal has to be used with respect to each of the different viewpoints. A plurality of holograms in these methods and apparatuses are employed to preferably function as optical elements such as diffraction elements capable of diffracting light in different directions or holographic optical elements each acting as lens-like imaging devices and so forth. By contrast, in Display Holography a hologram is itself a representation of an object or its components and when properly imaged (or rendered) is capable of showing its image or images recorded thereby.

A method and apparatus relating to Display Holography and using a set of data slices (cross-sectional views) typically presented in the form of 2-D transparent images (sectional images) are disclosed by U.S. Pat. No. 5,592,313 in the context of medical imaging. Sectional images are projected with an object beam onto a projection screen having a diffuser and then onto a film of photosensitive material (a recording medium) for sequentially exposing thereon each image along with a reference beam. Thereby a large number, e.g. one hundred and more, relatively weak superimposed holograms are recorded within said medium, each consuming an approximately equal, but in any event proportional, share of photosensitive elements therein. In particular, for the purposes of projecting sectional images, the apparatus comprises an imaging assembly configured with a spatial light modulator and including preferably a cathode ray tube (CRT), a liquid crystal light valve (LCLV) and a projection optics rigidly mounted together with the projection screen in the assembly. After each exposure of the recording medium, the assembly is axially moved in accordance with the data slice spacing, and a subsequent sectional image is projected onto the diffuser of the projection screen and then onto the medium for a predetermined period of time while using the same reference beam, and so a subsequent hologram is thus superimposed onto the medium. The diffuser scatters the light of the object beam transmitting therethrough over an entire surface of the medium and in such a way that scattered light seems to be emanating from one of the points on the diffuser. As a result, every point on the film “sees” each and every point within the projected sectional image when this image appears on the diffuser and embodies a fringe pattern containing encoded amplitude and phase information for every point on the diffuser. The hologram when illuminated enables the observer, e.g., physician, to view an image of each of the data slices and properly integrate all of these sectional images for creating a 3-D mental image of said physical system.

Similar sectional representation of a 3-D virtual space containing objects is used in a holographic display system to allow an operator of an equipment controller to view a 3-D mental image of the remote site for determining the relative location and orientation of remote objects, and thus for facilitating solutions of close-range manipulation tasks by operators (see U.S. Pat. No. 5,227,898). 3-D numerical data collected by a laser range scanner is stored in this system in a database and then divided or “sliced” into multiple 2-D depth planes each representing surface points of the object at a predetermined depth position. Images of said depth planes are subsequently visually reproduced with laser light transmitted through one or more spatial light modulators (SLM's) to expose a photosensitive medium separately or in groups of three depth planes using a stack of three SLM's. The latter case is preferred to reduce the amount of time required for recording all of these images. After each exposure the SLM stack is repositioned at a distance corresponding to the actual (real-world) location of the images currently presented by means of this stack. Thus, depth planes images are recorded in the photosensitive medium in a multiplane-by-multiplane fashion and this multiplane, multiple exposure process is repeated until the entire space of the remote work site containing the selected objects is recorded.

Meanwhile, the ability of the human mind to integrate 2-D images of sectional object components (depth planes or cross-sectional views) into a 3-D mental image is limited, especially when using a restricted number of them. This circumstance seems to be just the same as in 3-D imaging techniques when presenting all of sectional images simultaneously, and definite difficulties of mentally transforming their series into the 3-D image are explained by the loss of three-dimensional aspects in each of these sectional images and the lack of mutual information pertaining to a visually perceived relationship between sectional data stored in them. This situation thus requires more complicated visual work to create an impression of a single 3-D mental image, and places a great strain on the human visual system. That is why this visual work may usually only be performed by those who are skilled in such mental integration. To expect a common observer (viewer) to be able to integrate said 2-D images into a 3-D mental image without affording such an observer more favorable conditions for observation and perception of these images is beyond reasonable expectation.

For this reason, it is highly desirable to enable the common observer, while viewing such a 3-D image, to observe its right-to-left aspects and top-to-bottom aspects as well as offering a changing observation distance to make it easier to visually understand the depth of the object and perceive its variability from different perspectives. Such variability requires that the particular image, depending on the viewpoint, will show certain features and will obscure other features because they are behind the former ones. So a procedure like the hidden line and hidden surface area removal has to be applied to each of the data slices by controlling, for instance, the visibility of any given point on any sectional image from each of a plurality of viewpoints to provide thereby a variability in 2-D images when changing viewpoints and the elimination of the plainly visible rear side in the 3-D image thus obtained. Therefore, the more viewpoints used, the more the information content of each sectional image to be presented as well as the redundancy of this information due to the necessity of representing each of the object points from numerous viewpoints. In turn, the longer the period for updating LCLVs, SLMs or other means for projecting or displaying sectional images and the longer the time for producing a hologram. Also, larger memory should be provided for storing data processing, namely, 2-D data relating to each of said sectional object components (sectional data), as well as the original 3-D data representing said object as a whole in a computer database. Each of such circumstances relating to conditions of using said optical and computational techniques is able to restrict the possibilities of improving conditions of the observation and perception of depth plane images in every particular implementation. That is why taking into account these circumstances is important when producing holograms adapted for visual applications in the mentioned fields.

Due to the reasons mentioned above it is necessary also to reduce the spacing between data slices within the object to improve the revealed relationship between data stored in different 2-D sectional images. Such a relationship varies depending on the nature of the image, conditions of its observation and perception, as well as the state of the observer's visual system and the observer's experience. Such a relationship becomes more apparent in the presence of similar details, fragments, shades and like features in various sectional images, and because of that facilitates their integration into a meaningful and understandable 3-D mental image. This circumstance may be explained by the fact that any details of apparent minor significance in a separate sectional image, when evaluated in the context of a set of sectional images may reveal close peculiarities being important for perceiving such a relationship. Obviously, the narrower said spacing between data slices the more such features (and, therefore, mutual information) there are in each sectional image for grasping more easily the relationship between the sectional images, but, simultaneously, the greater is the number of these images and so the larger is the memory for storing data processing (said sectional information) as well as the amount of time required for producing a hologram. Also, the amount of time is also larger for communicating or transmitting image data relating to these sectional images to a remote user when it is required for producing the hologram(s) by this user.

On the other hand, to facilitate integrating sectional images in the mind, compressed sectional data could be used for each sectional image (see, for example, U.S. Pat. No. 5,117,296 and U.S. Pat. No. 5,227,898) instead of the increased number of these images. When making this in a system disclosed by U.S. Pat. No. 5,227,898, depth planes segmented in the database are grouped into a set of depth regions sequentially disposed in 3-D virtual space and then compressed in each group into one depth plane by projecting the volume within each region into such compressed depth plane. Each compressed 2-D depth plane thus contains the surface points of the object(s) for a given region of depth, facilitating thereby the perception of the 3-D mental image as continuous. But, the extent of this region limits the effective depth resolution of such a 3-D image, while the information content of each compressed depth plane image to be presented increases considerably the period of updating image data and, therefore, the amount of time required for producing the hologram. And so, these circumstances have to be taken into account as well, when producing holograms adapted for visual applications in mentioned fields. The number of compressed depth planes can be in the range of 20 to 80 depending on the resolution and amount of time desired.

The analysis made shows that, irrespective of embodiments and purposes of applications of methods and apparatus in 3-D imaging techniques or in sectional Display Holography, the problems of mentally transforming a series of sectional images into a 3-D image of the object(s) are related with using the very concept of sectional representation of a 3-D virtual space containing an object (or objects) and explained by the loss of 3-D aspects in each sectional image and the lack of mutual information for visually perceiving a relationship between data stored in different sectional images. Complicated visual work is required for integrating sectional images in the mind into a meaningful and understandable 3-D image, and places a great strain on the human visual system. Such circumstances have caused diverse attempts for simulating the variability in sectional images, to improve conditions for their observation and perception of the relationship between data stored in them, to facilitate creating an impression of 3-D mental image continuous in the depth direction. Unfortunately, these attempts result in other problems. In particular, a necessity of having much more information content for each sectional image and/or an increased number of sectional images is, in general, a limiting factor as it requires a large amount of time for computing and processing 2-D images and for updating screens, LCLVs, SLMs, displays or other means for projecting or displaying these images, or a large memory for storing data preliminarily processed. Decreasing said requirements by imposing limitations on an achievable resolution of each sectional image and, hence, on the complete 3-D image resolution is not acceptable for the purposes of visual applications in the mentioned fields, because this results in reducing the quality of a 3-D image to be reproduced due to the loss of fine image details (or small image fragments) displaying the particular peculiarities of the object(s) represented in a computer database.

The problems pertaining to the perception of the 3-D mental image as continuous in the depth direction could be partly avoided when using another concept based on providing an observer with images of different perspective views of an object (instead of its sectional images) to facilitate combining different 2-D images in the mind.

This concept provides for presenting to one eye of the viewer an image of a slightly different view than that presented to the other eye, these views being in a proper order as being taken from a set of sequential viewpoints. The presentation of disparate images to the eyes provides an observer with binocular cues to depth. The differences in the images are interpreted by the visual system as being due to relative size, shape and position of the objects in the field of view and thus create an illusion of depth. Such conditions of the observation make it easier to fuse images of these views in the brain into an image that appears to the viewer as being a three-dimensional one according to stereoscopic effect. Consequently, the viewer is able to see depth in the 3-D mental image he or she views. This is caused by the fact that images of adjacent perspective views contain much more mutual information as compared with sectional images because each of the points of an object is presented at least in several perspective views improving thereby a relationship between data presented in them and facilitating the perception of the 3-D image as continuous. Diverse 3-D display systems (including holographic ones) providing simultaneously a plurality of 2-D images of an object from different viewing (or vantage) points or viewing directions are generally discussed in U.S. Pat. No. 5,581,378. Display Holography based on a representation of perspective views of 3-D virtual space containing an object (or objects) uses a holographic representation of each perspective view.

One method embodying this concept comprises calculating a plurality of two-dimensional images of an object from different viewpoints on a single line or along one arc, plotting these images onto the microfilm frames, and then sequentially projecting them onto a diffused screen with coherent radiation for holographically recording 2-D images projected from said screen on to the separate areas of a recording medium as a series of adjacent, laterally spaced thin strips. Thus, recorded individual holograms form together a composite hologram. Calculations were performed from 3-D data stored in the computer database as a multitude of points specifying a 3-D shape of the object. About two hundred computer-generated views of the object from different viewpoints were derived from 3-D data using an angular difference between adjacent views of 0.3 degrees (see U.S. Pat. No. 3,832,027). Holographic recording makes the image of each view taken from a particular viewpoint visible only over a narrow angular range centered at this viewpoint. Therefore, each viewpoint determines an angle at which the object is viewed, while each individual hologram representing the respective perspective view records the direction of the corresponding image light. This is so that a viewer moving from side to side sees a progression of views as though he or she were moving around an actual object. If these images are accurately computed and recorded, a 3-D mental image obtainable by rendering the composite hologram (a composite image) looks like a solid one. Said composite hologram is also termed a “holographic stereogram” (as in U.S. Pat. No. 4,834,476) being, in fact, a stereoscopic representation of a 3-D virtual space containing an object (or objects).

Because each of the individual holograms in the composite hologram is quite narrow, each eye of the viewer sees the image through a different hologram. Because each individual hologram is a hologram of a different view, this means that each eye sees images of slightly different view. And because the composite hologram is comprised of a plurality of individual holograms, the viewer is able to see images from different viewpoints simply by changing the angle at which he or she views the composite hologram. It is possible otherwise for a single viewer to obtain multiple views by keeping his position at a constant point with respect to the recording medium while rotating the latter. Taking into account that the viewer's eyes are always flickering about even when viewing an image, the transition from one viewpoint to another may be imperceptible (see U.S. Pat. No. 3,832,027 and U.S. Pat. No. 5,748,347). The latter depends on the number of 2-D images recorded by individual holograms, though.

Various methods of making holographic stereograms, multiplex holograms, rainbow holograms and others, including white light viewable ones are briefly described in the U.S. Pat. No. 5,581,378. In particular, photographic film footage is utilized for a formation of holographic stereograms and multiplex holograms where, for example, in the latter each slit hologram is a single photographic frame recorded through a cylindrical lens. Each strip hologram in the holographic stereogram represents a different frame of the motion picture film projected onto the diffusion screen and has only a 3 mm width that corresponds to approximately one pupil diameter, while each pair of strips are 65 mm apart (inter-pupil spacing) and constitute a stereo pair visible for a particular viewpoint (or vantage point) of the viewer. A method and apparatus described by U.S. Pat. No. 5,216,528 provide for recording the holograms of two-dimensional images with overlap when the film carries many image frames, and each individual hologram is recorded in three successive areas of a photosensitive material. A method of making achromatic holographic stereograms viewable by white light is described in U.S. Pat. No. 4,445,749 and requires a series of photographic transparencies taken from a sequence of positions preferably displaced along a horizontal line. A holographic printer for producing white light viewable image plane holograms is provided in U.S. Pat. No. 5,046,792 using images formed on transparent film, such as movie or slide film. A system of synthesizing relatively large strip-multiplexed holograms is disclosed in U.S. Pat. No. 4,411,489. The resultant composite hologram is rendered after bending it into cylindrical shape and placing a white light point source on the axis of the cylinder. A further development of this system allows synthesizing strip-multiplexed holograms without the use of a reference beam.

It becomes clear that all these methods and apparatus, irrespective of their particular peculiarities and different purposes, require the previous creation of some hard copies of 2-D images, each hard copy being an intermediate representation of a particular perspective view. These hard copies may be a set of computer-generated plots, a series of photographic images on the film, a number of transparencies or may be formed, for example, by a motion picture film of a slowly rotating object such that each image is a view of the object from a different angle. Hence, this is just the same circumstance as in Display Holography based on the sectional representation of 3-D virtual space containing an object that requires a great deal of intermediate representations, i.e. transparencies or like hardcopies, to be preliminary created and so causes the similar problem of needing a large amount of time for carrying this out. Besides, two major problems are encountered when producing holographic stereograms in such a way: vibrations caused by sequentially stepping transparent film of view images and by the movement of the vertical slit aperture, and the misalignment of vertical strip holograms caused by the horizontally movable slit aperture. The influence of vibration may, of course, be eliminated by allowing the system to stabilize in a non-vibrational state after each exposure, but this process is also time consuming.

Said problems of known methods and apparatus are partially solved in U.S. Pat. No. 5,748,347 by using a liquid crystal display in place of transparencies (or other hard copies) for direct modulation of an object beam. Information relating to images of perspective views is generated by a control computer and sequentially sent to the liquid crystal display (LCD). A collimated beam from a laser source is focused to form an essential point source. Light from this source is modulated, by transmitting it through the LCD, with image information of the respective perspective view and then projected onto a recording medium to expose a separate area thus producing a strip hologram. The next sequential image corresponding to the next viewpoint in the sequence is recorded adjacent the preceding area of the medium in the same manner. The image of each perspective view can be used for such holographic recording as soon as it is ready, without delay, and without the need for intermediate storage (e.g., in the form of a hard copy). Since production of each individual hologram is independent from any others, some parallel processing means may be employed for calculating the appropriate views from 3-D data stored in the computer database. Another liquid crystal display is used in place of the vertical slit aperture in the system described by U.S. Pat. No. 4,964,684.

Meanwhile, regardless of the perspective view representation to be employed, a discrepant circumstance exists in improving conditions of the perception of a 3-D mental image by means of a holographic stereogram. On the one hand, because each image is visible over the narrow angular range, there is a necessity of increasing a number of views for reducing discernable differences between 2-D images of such views from adjacent viewpoints. Otherwise, the viewer may perceive the 3-D mental image as being discontinuous, i.e., composed of 2-D discrete images. On the other hand, the number of views cannot be too large to provide sufficient differences between images for the appearance of the stereoscopic effect. The viewer sees a 3-D object because both eyes see disparate images presenting views of the object from various viewpoints. To meet these discrepant requirements, a minimal angular difference between adjacent views (or a minimal distance between the adjacent viewpoints) has to be selected for providing images of adjacent views to be marginally perceived as disparate ones. The minimal angular difference thus selected is approximately equal to one-third of one degree (see U.S. Pat. No. 5,748,347). The same angular interval is used in the method disclosed by U.S. Pat. No. 3,832,027.

Therefore, the requirement of providing disparate images is a limiting factor because said angular interval is far beyond the value determined by the resolution limit of the unaided eye (about 1/60 degree—see U.S. Pat. No. 5,483,364). In this case, 2-D images obtainable by rendering a holographic stereogram appear simultaneously in the field of view with a minimal but still perceivable discontinuity between them and so are fundamentally seen. This circumstance prevents the clear observation of a 3-D mental image, thus creating a discomfort for the observer and causing weariness. Moreover, the position of the 3-D image observed by both eyes does not coincide with the surface at which the focal point of the eyes is located. Such a mismatch in its position creates a difficult condition for viewing a composite image (i.e., a 3-D mental image obtainable by rendering a composite hologram or holographic stereogram). In such circumstances a definite visual work for removing this mismatch is required that places an additional strain on the human visual system causing weariness and eye fatigue (see U.S. Pat. No. 5,748,347 and U.S. Pat. No. 5,907,312). Particularly, observing an image of a deep depth increases said strain on the eyes. Furthermore, for specific groups of observers suffering from accommodative dysfunctions (disorders) or binocular anomalies such a visual work turns out to be very difficult or even impossible in contrast to the observation of the actual 3-D image. Thus, avoiding the problems inherent to Display Holography based on a sectional representation of 3-D virtual space containing an object, Display Holography based on a representation of its perspective views creates other problems in the observation and perception of the obtainable 3-D mental image.

Apart from the problems in its observation and perception, a composite image has an incomplete dimensionality as it lacks vertical parallax. This circumstance arises when a variety of vertical views are not collected, and independent individual holograms are recorded on separate areas of the recording medium in the form of thin strips disposed side by side in the horizontal direction. Therefore, the three-dimensionality is retained only in this direction, and an appearance of depth of an image to the viewer rises also from horizontal three-dimensional characteristics, but 3-D characteristics in the vertical direction are substantially lost. In other words, when the composite hologram is viewed with both eyes of the viewer in a horizontal plane, the three-dimensional aspects of the image are available, and the movement of the viewer in a horizontal direction will show the same relative displacement of image elements (details, fragments). Ordinarily, vertical parallax and vertical 3-D characteristics are sacrificed in known methods and apparatus in the relevant art for the purposes of reducing computational requirements and information content of the hologram. Also, vertical parallax is traded for the ability to view the hologram by white light as in the rainbow hologram approach that uses a slit to overcome the diffusion or “smearing out problem”. However, using the slit requires the viewer to be at the properly aligned position to view the object image (see, e.g., U.S. Pat. No. 5,581,378). The removal of vertical parallax thus restricts the field of view and creates a definite inconvenience for viewing the composite image because the observer is prohibited from seeing over or under the image. In other words, with the viewer at a fixed point, relative positions of details or fragments of the image in the vertical direction do not change with changes in vertical position of the hologram. That is why it would be advantageous if a full-parallax, three-dimensional image (or 3-D display) with binocular as well as accommodative cues to depth and in true color similar to natural vision, could be achieved (see also U.S. Pat. No. 5,227,898 and U.S. Pat. No. 5,581,378).

If, however, it is desired that the composite image exhibit vertical parallax as well as horizontal parallax, a multiplicity of images of additional perspective views of the object should be computed from 3-D data stored in the computer database. However, this results in a considerable increase in the amount of time for computing and processing these 2-D images and time for updating screen, LCD, SLMs, displays or other means for projecting or displaying these images as well as time for producing individual holograms representing perspective views. In particular, the period of time for transmitting data relating to these images to a remote user should be considerably larger when it is required for producing the hologram. In another variant, when these images are precomputed, much more memory for storing data processing, i.e., image data relating to all of 2-D images, is required as well as an amount of time for producing the composite hologram. In both variants, therefore, a considerably larger number of exposures would have to be taken as well to provide said “full-parallax” feature. As exemplified in U.S. Pat. No. 5,748,347, n² (e.g., 135² or 18225) images would have to be exposed on the medium, if squares were used instead of strips. All of these circumstances are important for producing holograms adapted for visual applications in mentioned field because they are capable of limiting the possibility of having a full-parallax 3-D mental image.

In addition to incomplete dimensionality, the composite image has essential limitations in its resolution resulting from the independence of individual holograms from each other. These limitations of composite (multiplex or lenticular) holography are not inherent to classical (conventional) holography (see, for example, U.S. Pat. No. 4,969,700). The lateral resolution is limited by a strip size (a lateral size of an individual hologram) denoted beneath as “a”, rather than the hologram size as is normally the case for classical holograms. Therefore, the angular resolution determined by the strip size is approximately λ/a radians, where λ is a wavelength of light used for rendering the hologram. This is the minimum angle over which no variations in amplitude occur, in lack of other reasons further limiting it, of course. Thus, the smaller the value of “a” (as in the composite hologram) the larger are the unresolved details or fragments in the obtainable image. However, this is not acceptable for the purposes of visual applications in mentioned fields because of reducing the quality of a 3-D image to be reproduced due to the loss of fine image details (or small image fragments) displaying the particular peculiarities of the object(s) in the computer database.

The analysis made shows that methods and apparatus using the concept based on presenting images of different perspective views to represent a 3-D virtual space containing an object (or objects) facilitate combining different 2-D images in the mind with respect to those using the concept of a sectional representation of the same 3-D virtual space. This comes from improving conditions for a perception of some 3-D characteristics in an obtainable 3-D mental image (in one direction) due to considerable increase in the amount of mutual information pertaining to visually perceived relationships between data stored in images of adjacent perspective views. But, this is purchased by increasing a redundancy in information to be processed and in information content of a composite hologram because of representing each of object points in numerous perspective views as well as by creating other problems. Also, said circumstances or factors resulting from the employment of the selected concept of a representation of a 3-D virtual space impose definite restrictions upon conditions of using optical and computational techniques and upon conditions for forming a hologram. Therefore, said circumstances or factors are capable to restrict possibilities of improving conditions of the observation and perception of the obtainable 3-D mental image and obtaining a high degree of image resolution or its higher quality as a whole. That is why these circumstances and factors turn out to be important for producing holograms adapted for visual applications in mentioned fields and should be taken into account when selecting a concept of a representation of a 3-D virtual space for embodying in respective methods and apparatus.

The redundancy in image information may be illustrated by the fact that more than, perhaps, a thousand views should be selected for providing said minimal angular difference between adjacent views that places an unnecessary burden upon the electronic processing system. The same number of exposures (i.e., separate individual holograms) must be made for recording the composite image having, however, the essentially limited resolution and incomplete dimensionality without vertical parallax. Because of that, the task of obtaining the composite image with full parallax seems to be not practicable, as it requires at least one order of magnitude more exposures to be made (see example above with reference to U.S. Pat. No. 5,748,347) that stretches the dynamic range of the recording medium beyond its limit.

Despite the redundancy in said information the employment of the concept of presenting images of different perspective views fails to compensate the loss of 3-D aspects in each of these 2-D images. This is a reason that difficulties in the visual work causing weariness and eye fatigue as well as other problems in the observation and perception of the composite image remain. And this explains the principal difference in viewing a 3-D mental image while seeing, in fact, a set of 2-D images, and a 3-D actual image.

Such redundancy in image information could be reduced when using a further concept based on providing an observer with images of discrete points of light in positions corresponding to coordinates of selected surface points of the object(s) in a 3-D virtual space, which allows the observer to view a solid 3-D image.

In one method embodying this further concept, two point sources of coherent light are moved relative to a recording medium according to a predetermined program and various fringe patterns recorded for each of their positions are superimposed upon each other to form a complex hologram (see, for example, U.S. Pat. No. 3,698,787). The first point source is moved from position to position in a fixedly disposed surface so as to synthesize separately each particular cross section of the object to be represented, while the second point source is disposed at a fixed position during synthesis of each part of said cross section so as to provide a reference beam. Then the first point source repeats its moving on said surface so as to synthesize other particular cross sections of the object (scene), while the second point source being moved along a line transverse to said surface to a different position for each particular cross section.

So, any given point in a 3-D virtual space containing an object in this particular implementation is represented by only one point on the respective synthesized cross section. An apparatus providing movements of point sources comprises conventional equipment for producing object and reference beams of laser light. An object beam is deflected by two acoustooptic deflector/modulator combinations in response to signals from a programmed electronic control and directed to strike a transparent glass sheet having a diffuse (ground) surface and being disposed to be parallel with a photographic film used as the recording medium. Light striking any point of the diffuse glass surface forms the first point source. A reference beam is converged to a point by a focusing lens to form the second point source moving in the direction perpendicular to the plane of the glass sheet, or along the z-axis of the apparatus. The intensity of light emanating from point sources is controlled so that it corresponds to the intensity of light from the respective of object points represented by those point sources in each of their predetermined positions. In operation, to form a typical hologram the point sources are placed in many different positions, for example 1000 to 10000, and the photographic film is exposed to light from each of those positions. If the z-ordinate dimensions of a desired object are small compared with the smallest distance between the glass sheet diffuse surface and the recording film, a hologram can be formed by moving the first point source substantially on the projection of that object onto the plane of said glass surface.

Hence, this method turns out to be similar to ones used in Display Holography based on sectional representation of a 3-D virtual space containing the object(s) in that the individual holograms are superimposed upon each other to form within the recording medium a complex hologram capable, when illuminated, of simultaneously reproducing images of all object sections recorded thereby. But, in this method an image of each selected point arranged in one respective of object sections has to be recorded separately in contrast to sectional Display Holography where the image of every section (sectional image) is recorded as a whole. So, apart from problems of mentally transforming sectional images into a meaningful and understandable 3-D image, two serious problems associated with reducing image quality and stretching dynamic range capabilities of a holographic recording material have to be solved. These problems arise usually when using an immense number (N) of points in such a meaningful 3-D record because of a necessity of sharing photosensitive elements within the recording medium among separate exposures to produce weak individual holograms each having (with equal exposures) only 1/N of the optimum exposure where N may be in the range of 10⁸. The resulting minute fraction of the coherent light available for each pixel in the image has stretched the dynamic range of the recording material beyond its limit (see U.S. Pat. No. 4,498,740). Furthermore, several hours are required to record successively tens of thousands of points, so that the number of selected points is less than 10000 in practice (see U.S. Pat. No. 4,834,476). The achievable point brightness is reduced accordingly, making 3-D image dim and so less expressive and informative. So, taking into account all these circumstances when using this method, serious limitations upon the achievable 3-D image resolution (e.g., by reducing a number of pixels in the image) and/or the object size have to be imposed. But, this is not acceptable for the purposes of applications in mentioned fields due to reducing a quality of a 3-D image and a variety of objects that could be presented for viewing.

The problem concerning dynamic range capabilities is partly solved by other methods embodying the further concept (see U.S. Pat. No. 4,498,740 and U.S. Pat. No. 4,655,539), in which an object (information) beam is focused to a point closely adjacent to the holographic recording medium at a location established according to data representing x, y, z coordinate information of selected surface points. This is carried out by controlling said focal point to be at a predetermined distance from a plane of the recording medium for representing z data points, while directing said information beam across and along the recording medium to its individual areas having their positions representing x and y data points. A reference beam is directed to the recording medium in conjunction and simultaneously with said information beam to form an interference pattern in each of said areas being a small fraction of the total area of the recording medium in contrast to a hologram recorded according to U.S. Pat. No. 3,698,787. The size of each area may be controlled also by maintaining a relatively small angle α of diverging radiation directed from said focal point (as a point source) to the recording medium. But at the same time this reduces the field of view, and so it is more preferable to maintain a small distance instead of small angle.

An apparatus for recording a hologram of individual x, y, z data points has two mirrors rotatable at right angles to each other to scan an information beam in x and y coordinates and a movable lens to focus this beam in the z direction. The focal point may be located closely adjacent in front of the recording medium, behind it, or even within it for certain z coordinate positions. The size of the collimated reference beam is controlled by an iris to have the same size as the information beam in each area. If said area has a size no more than 1/10 medium dimensions, the requirements for severely stretching dynamic range capabilities are reduced by 10² with a consequent increase in quality (as proposed). The area reductions may well reach as much as 1:10000 to bring about new holographic capabilities (see U.S. Pat. No. 4,498,740).

But, this increase in image quality is related to achievable point brightness rather than to an image resolution that, on the contrary, is decreased when reducing the area size, i.e., the size of independent individual holograms. Actually, when the area size, is “a” in one dimension, the resolution of an image point at a distance R from the hologram is approximately Rλ/a, where λ is the wavelength of light rendering the hologram. The smaller the value of “a” the larger are the unresolved details or fragments in the image. This is just the same situation as for a composite hologram where an image resolution is determined by the lateral size of individual holograms (see U.S. Pat. No. 4,969,700 and U.S. Pat. No. U.S. Pat. No. 5,793,503). Thus, in said method and apparatus embodying this concept, requirements for dynamic range capabilities of the recording material are in contradiction with requirements for the image resolution, so that dynamic range capabilities are a limiting factor for the achievable image resolution and 3-D image quality as well. Smaller details that could be provided by increasing the number of image pixels turn out to be redundant in this case, as they do not allow increasing the image resolution limited by the size of individual holograms. However, this limitation is not acceptable for the purposes of visual applications in mentioned fields because of reducing the quality of a 3-D image to be reproduced due to the loss of fine image details (or small image fragments) displaying the particular peculiarities of the object(s) in the computer database.

The improvements performed according to U.S. Pat. No. 4,655,539 do not change this situation as they pertain to implementation of structural elements of the apparatus for hologram recording, while retaining the very concept unchanged. Actually, the apparatus has additionally a focusing lens and a diverger element (a diffuser) being adapted to receive an object beam essentially at a point and send a diverging object beam having a fixed shape (or angle α) to a recording medium. An equivalent point source thus formed is progressively moved to scan in z coordinate by moving the diverger element closer to or further from the recording medium. The focusing lens is moved together with the diverger element to maintain a beam focus thereon. The same scanners are used for scanning the object and reference beams in the x-y plane. An iris adjustably controlling a size of the collimated reference beam is made as a spatial light modulator. The iris contracts and expands synchronously with scanning z coordinate, so that the object and reference beams could be maintained substantially equal in size at the recording medium as the effective distance changes between the equivalent point source and the recording medium.

The analysis of methods and apparatus embodying said further concept shows that recording a multitude of independent individual holograms representing one-dimensional object components (its selected surface points) to synthetically form a complex hologram creates problems pertaining to dynamic range capabilities of the photosensitive recording material and image quality. Recording in small areas of the recording medium to partly avoid said problems imposes serious limitations upon the achievable 3-D image resolution and the object size in the depth direction. Besides, mentally transforming a series of different 2-D images into a 3-D image of the object requires a complicated visual work, like in sectional Display Holography, for perceiving the image depth and its variability at different perspectives that places a great strain on the human visual system. All of these circumstances seriously limit possibilities of using said methods and apparatus for producing holograms adapted for said visual applications in mentioned fields.

Thus, irrespective of embodiments and purposes of applications of methods and apparatus realizing said concepts, the employment of one- or two-dimensional representations of a 3-D virtual space containing an object (or objects) creates problems and limitations in the observation of images of such representations and in the visually perception of relationships between them for their mentally combining into a meaningful and understandable 3-D image. As mentioned above, most of these problems and limitations are caused by the loss of 3-D aspects in the image of each of such representations as well as by circumstances and factors resulting from the employment of the respective of said concepts and relating to conditions of using optical and computational techniques and/or conditions for forming a hologram. The latter is explained by the fact that said circumstances or factors impose restrictions on possibilities of improving conditions of the observation and perception of the 3-D mental image and/or obtaining higher degree of this image resolution and its higher quality as a whole.

It is worth emphasizing once more that coherent radiation in said methods and apparatus is used by available optical techniques handled with the computer for presenting images of respective object components only. None of said methods and apparatus provides (or simulates) variability in an obtainable 3-D mental image when changing viewpoints, or some other 3-D aspects therein without increasing a redundancy in information to be processed or transmitted for producing a hologram and in information content of the hologram accordingly.

On the other hand, none of said methods and apparatus realizing any of such concepts employs the very hologram capability to store 3-D image information while preserving its 3-D aspects. The resulting hologram being a representation of the 3-D virtual space containing the object(s) is actually used for recording images of 1-D or 2-D representations exclusively. E.g., the composite hologram as a stereoscopic representation of the 3-D virtual space is exclusively used for recording 2-D images of numerous perspective views. The similar situation occurs in Display Holography based on presenting 2-D images of sectional object components or images of one-dimensional object components. Thus, said hologram capabilities are incompletely and ineffectively employed.

In contrast to this, all hologram capabilities in preserving 3-D aspects of a 3-D image of an object are provided when recording classical (conventional) holograms. Such a hologram does not require presenting images of one- or two-dimensional object components as intermediate representations and creating an impression (or illusion) of a single 3-D mental image of the object(s). Because such a hologram provides a true image reproduction of the entire object in which an actual 3-D image is free of said problems and limitations. This is explained by the fact that the actual 3-D image exhibits full parallax by affording an observer a full range of viewpoints of the image from every angle, both horizontal and vertical, and full range of perspectives of the image from every distance from near to far (see U.S. Pat. No. 5,592,313).

A classical hologram is commonly recorded in the form of a microscopic fringe pattern resulting from an interaction between the reference and object beams within a volume occupied by a film emulsion (photosensitive medium) and from an exposure of its light sensitive elements by a standing interference pattern. The fringe pattern comprises encoded therein amplitude and phase information about every visible point of an object. When the hologram is properly illuminated said amplitude and phase information is reproduced in free space, thus creating an actual (true) three-dimensional image of sub-micron detail with superb quality (see U.S. Pat. No. 5,237,433). In contrast to composite holograms, classical holograms retain all information in the depth direction, and this allows them to have infinite depth of focus. Moreover, with classical holograms, adjacent portions of the hologram and different views are not independent of each other and related by complex relationships (U.S. Pat. No. 5,793,503). That is why such a holographic representation of an object (objects) provides significant advantages over its (their) stereoscopic representation. While viewing a holographic stereogram, only an illusion of the 3-D image in the mind is created that requires a complicated and difficult visual work to be made for perceiving the image depth and its variability at different perspectives, as mentioned above.

However, the unique characteristics of a classical hologram are based on its capability of storing an enormous amount of image information. The fringes of a typical hologram are very closely spaced providing the resolution of about 1000 to 2000 lines (dots) per millimeter. For instance, a hologram of dimensions 100 mm by 100 mm contains approximately 25 gigabytes of information and can resolve more than 10¹⁴ image points. Such an amount of information and processing requirements are far beyond current processing capabilities (see, for example, U.S. Pat. No. 5,172,251 and U.S. Pat. No. 5,237,433). This is one of reasons that classical holograms are incompatible with any computer based system and that respective image data recorded thereby is impossible to transmit to remote users, e.g., through global computer networks, including the Internet.

To a certain extent, a computer-generated hologram preserves 3-D aspects in an obtainable 3-D image, while being compatible with computer based systems and having an essentially less information content with respect to a classical hologram. This circumstance is explained by the fact that classical holograms carry far more data than a viewer can ever discern. So, information used for producing a computer-generated hologram of an object (objects) may be essentially reduced by eliminating or substantially eliminating unnecessary data. A capability of preserving some of 3-D aspects in an obtainable 3-D image is provided in respective methods for producing computer-generated holograms due to synthesizing elements of the hologram itself rather than images of object components intended for their further holographic recording as in Display Holography. Diverse concepts have been proposed in Computer Generated Holography for reducing the information content of computer-generated holograms in different ways.

A method described in U.S. Pat. No. 4,510,575 realizes one of these concepts. According to a program stored in a computer, a hologram of an object is formed from a graphic representation by dividing the total representation into a multiplicity of cells for reducing information to be computed. A large or macro sized image of each cell is created, preferably on a fine resolution CRT or other display device and this image is projected on and focused on a recording medium (a photographic plate) ordinarily by a microscope. Stepwise, these cells are individually projected with a precise positional adjustment for each projection until the entire graphic representation is recorded. But, due to interferometric positioning an image of each cell relative to the photographic plate, this method is time consuming. Also, when rendering such a computer-generated hologram, the image turns out to be not satisfactory in quality (in image resolution). This circumstance is explained by independence of cells from each other and their small size (see hereinabove a description of the similar situation relative to U.S. Pat. No. 4,498,740).

Other concepts pertaining to the art of Computer Aided Holography, and more particularly to methods using a combination of numerical and optical means to generate a hologram of an entire object from its computer model (see U.S. Pat. No. 4,778,262 and U.S. Pat. No. 4,969,700). This model works by providing data concerning an illumination of an object and its reflection and transmission properties as well. Both the object and a hologram surface are stored in a computer database. The hologram surface is divided (like in the preceding method) into a plurality of smaller individual grid elements each having a view of the object. Light rays from the object with paths lying along lines extending through each grid element within its field of view are sampled by the computer. Each ray is specified by an intensity (in U.S. Pat. No. 4,778,262) or amplitude (in U.S. Pat. No. 4,969,700) function. An intensity (amplitude) of each light ray arriving at a given grid element is determined by tracing this ray in the computer from an associated part of the object onto the grid element in accordance with the illumination model. In order to construct a hologram element at each grid element, an associated tree of light rays is physically reproduced using coherent radiation and made to interfere with a coherent reference beam. The entire hologram is finally synthesized by assembling all constituent hologram elements. Since the object is described by the computer model, any image artificial transformations turn out to be possible with current computer graphic techniques such as rotation, scaling, translation, and other manipulations of 3-D data. A flexibility of said image transformations provides significant advantages over classical holograms. Moreover, with a non-physical object, a hologram surface may geometrically be defined in any location (in a virtual space) close to the object or even straddled by it. This is important when making image-plane or focused-image types of holograms to improve their white-light viewing.

Meanwhile, a capability of preserving some of the 3-D aspects in the obtainable 3-D image is providing by essentially increasing a redundancy in information to be processed and in information content of a computer-generated hologram because of representing each of object points by numerous constituent hologram elements. For reducing the information content of the hologram to be synthesized, a sample of light rays from a limited set of object points is selected by the computer to construct each hologram element. Additionally, a window for each grid element is introduced, through which light rays are sampled and by means of which the field of view of this grid element is restricted. Each window is partitioned into pixel elements. For each pixel element the computer applies a visible surface algorithm. Hidden line removals are carried out by any of methods common to computer graphics. Multiple rays striking a single pixel element are averaged to determine that pixel's intensity (or amplitude) value. This procedure is repeated so that each grid element's view of the object is encoded as a pixel map. An intensity (amplitude) distribution pattern across each of windows is then employed in corresponding methods as a 2-D intermediate representation to form its respective hologram element, either optically or by further computer processing (see also U.S. Pat. No. 5,194,971).

In one of these methods, a camera is used to make transparency for each window, one for every grid element. This transparency is then employed to physically reproduce in light said selected sample of rays associated with each grid element by spatial modulating a coherent light beam transmitted therethrough. Other embodiments of this method provide for using a high resolution electro-optical device in place of transparencies (like in Display Holography). The electro-optical window, which is pixel addressable by the computer, modulates coherent light transmitted through each pixel element according to the intensity (amplitude) value associated with it. This allows each hologram element to be created as soon as computed data becomes available for the electro-optical device.

Despite the limitation of the set of object points and the restriction of the selected sample of light rays this procedure remains too expensive in terms of computer processing time. Computation problems in this method are caused by a necessity of performing an extremely large amount of intermediate calculations for creating an intensity (amplitude) distribution pattern across the window for every individual grid element of a hologram surface. At least five data arrays should be used that relate to: small areas dividing an object surface; light rays emanating from each said area when object illuminating; an intensity (or amplitude) function of each light ray (gray scale information) and its direction; pixel elements of each window defining a field of view of the respective grid element; and viewpoints for carrying out hidden line removals for each pixel element. Thus, circumstances relating to the preliminary creation of 2-D intermediate representations cause relevant problems and limitations due to a necessity of requiring a large amount of time to produce them (e.g., in the form of transparencies) or time for computing and processing these patterns and time for updating SLMs, displays or other electro-optical devices. In embodiments where these patterns are precomputed a sufficiently large memory for storing data processing is required. As a result, these circumstances are similar to that discussed hereinabove in relation to methods described in U.S. Pat. No. 3,832,027 and U.S. Pat. No. 5,748,347.

Moreover, multiple control of the direction of each light ray is required for physically reproducing said sample of light rays with coherent radiation. This circumstance is explained by incapability of the 2-D intermediate representations to preserve directions of light rays due to a loss of 3-D aspects by each representation. The implementation of such a control causes a further increase in the amount of both computation time and information for updating said electro-optical devices (SLMs, displays and so forth).

Additionally, the number of grid elements is too large because their sizes should be small enough to meet high resolution requirements of a fringe-form hologram interference pattern approximately 1000 to 2000 dots per millimeter. This accordingly requires using a great number of said 2-D intermediate representations for providing these requirements. These resolution requirements are not necessary when using holograms for visual applications in mentioned fields, as nothing beyond the resolution of unaided eye will be needed in this case. That is why such resolution requirements are redundant for these applications, being in fact a limiting factor in this method that places an excess burden upon the electronic processing system.

Hence, on the one hand, said circumstances relating to conditions of using a combination of numerical and optical means and conditions for forming a hologram turn out to be inevitable, as they are a result of embodying the selected concept of synthesizing a hologram itself of holographic elements in this particular method for providing such a holographic representation of the object(s). On the other hand, said circumstances relating to conditions for forming the hologram create unfavorable conditions for using numerical means because of a redundancy in information to be processed and in an information content of the computer-generated hologram. Such a redundancy arises from both a representation of each object point by numerous hologram elements and high resolution requirements in conditions for forming a hologram. Therefore, this is a reason that the amount of information to be processed and the information content of the computer-generated hologram is increased so that this method fails to provide a 3-D image with complete dimensionality. Thus, unfavorable conditions in using numerical means require imposing a restriction upon utilizing the hologram capability of preserving 3-D aspects in the obtainable image.

Some embodiments of this method disclosed by U.S. Pat. No. 4,778,262 and U.S. Pat. No. 4,969,700 provide for creating holograms without vertical parallax. The holographic plane is partitioned into vertical strips instead of grid elements. An elimination of vertical parallax permits further reducing the information content of the hologram and resulting computation problems. Producing image-plane composite holograms retaining parallax only in the horizontal direction is also provided in other embodiments of this method disclosed by U.S. Pat. No. 5,194,971. The removal of vertical parallax restricts, however, the field of view and creates a definite inconvenience for viewing an image because the viewer is prohibited from seeing over or under the image. In other words, with the viewer at a fixed point, relative positions of details or fragments of the image in the vertical direction do not change with changes in vertical position of the hologram (see also the analysis hereinabove in relation to U.S. Pat. No. 5,748,347).

In addition to incomplete dimensionality, a circumstance pertaining to using too small grid elements in this method results in a poorly resolved image. In other words, image resolution turns out to be limited by a size of grid elements due to independence between them. Hence, this circumstance is similar to that discussed hereinbefore in relation to methods disclosed by U.S. Pat. No. 4,498,740 and U.S. Pat. No. 5,748,347. But, the employment of far smaller hologram surface grid elements, as compared with individual holograms used in the latter methods, results in respective increasing in size of the unresolved details in the image and elements in the pixel map as well. So, this circumstance imposes a severe restriction on the possibility of obtaining a higher degree of the image resolution or higher quality as a whole. Because of this restriction, computation problems in this method are reduced, as there is no need to specify the object in the virtual space better than the resolution limit determined by the grid element size. But, this circumstance causes the creation a crude hologram providing reproduction of a 3-D image with blurring due to a loss of high frequency components in an intensity (amplitude) distribution of diffraction light. With this restriction, an observer is prohibited from viewing fine image details (or small image fragments) displaying the particular peculiarities of the object represented in a computer database. Thus, the purposes of this method turn out to be in contradiction with the purposes of visual applications in mentioned fields in relation of preserving vertical parallax in an obtainable 3-D image and increasing the image resolution. In other words, when taken into account all circumstances and factors discussed, this method turns out to be not coordinated for such visual applications as it fails to improve conditions of the observation and perception of the obtainable 3-D image and provide high degree of the image resolution or its higher quality as a whole.

This situation is not improved in other methods disclosed by U.S. Pat. No. 5,237,433, U.S. Pat. No. 5,475,511 and U.S. Pat. No. 5,793,503. Embodiments of these other methods provide for diverse transformations, which allow computer data (representing an entire 3-D object scene and its illumination in a virtual space) to be converted into the required elemental views (which hologram surface elements, called elemental areas as well, see through respective windows). Some embodiments of these other methods provide collecting a multiplicity of conventional views of the object scene, instead of selecting said sample of light rays. These views are transformed into images of arrays of window pixels defining elemental views so that an image of each array of window pixels is used for creating a hologram element in a respective elemental area. A completed hologram is then formed from hologram elements. These conventional views may be computer-generated image data or video views of a physical object, collected from different perspectives by means of a video camera. These other methods retain the most of computation problems of the previous method because of using the same concept of synthesizing a hologram itself of holographic elements. For reducing the amount of both computation time and information to be updated, some embodiments of these methods provide for constructing a composite hologram lacking vertical parallax. Vertical parallax is deleted from the computer-generated object when a variety of vertical views are not collected, and because of that the procedure is simplified. For instance, if the conventional views are collected from positions along a straight line or on an arc of a circle instead of collecting views from points on spherical surface for the object having full parallax.

However, the employment of conventional views removes 3-D aspects of the reproducible image from a holographic record because a 3-D object is represented in this case only by a number of 2-D images when reconstructing a hologram. In other words, presenting the actual 3-D image (with incomplete dimensionality) to a viewer is substituted in this case by creating an impression or illusion of the 3-D image in the mind. As is clear from above discussions (see, for example, those in relation to U.S. Pat. No. 5,748,347), this circumstance means that in addition to incomplete dimensionality and the essential limitation of its resolution this image has problems and limitations in its observation and perception like the composite image in Display Holography. Therefore, conditions of using computational means turn out to be unfavorable for preserving 3-D aspects of a reproducible 3-D image and providing high degree of an image resolution due to a redundancy in both the representation of each object point by hologram elements and in the resolution requirements to conditions for forming a computer-generated hologram. But, at the same time, a capability of this hologram to preserve 3-D characteristics and other 3-D aspects in the obtainable 3-D image becomes unclaimed and ineffectively employed. Because of these circumstance and factors, said 3-D characteristics and a higher image quality as a whole are sacrificed in these other methods due to a necessity of reducing computation problems and the information content of the hologram. This is not acceptable for the purposes of said visual applications in mentioned fields.

The similar situation takes place in Computer Generated Holography where data processing means are used for computing an appropriate diffraction pattern to generate the desired hologram representing an entire object in a virtual space. For example, a holographic display system and related method described in U.S. Pat. No. 5,172,251 provide for, first, not computing vertical parallax in a hologram. This allows one to minimize its information content by several orders of magnitude. Second, the field of view is limited to 15 degrees. This relates to at least two standard eye spacing that should be sufficient for one viewer to readily see an image. Larger field of view requires much more information content. Third, the resolution of the image is decreased to the limit of resolution of the data. These three limitations make the information content of the hologram manageable. Also, an extremely complex and costly electronic apparatus inaccessible to a common user should be used as data processing means. The optical means (acousto-optic modulator) is employed in said display system for realizing said diffraction pattern to produce a 3-D image. This image is comprised of distinct luminous points defining surfaces that exhibit occlusion effects to aid a viewer in perceiving depth of the holographic image.

In the interference computation type Computer Generated Holography, where phase information relating to an entire object image is recorded in the interference fringe form, phase errors can be minimized to lead to an enhancement of image quality. However, the amount of computations is essentially increased because the phase and amplitude of signals that would arrive at each point on a recording surface from each point of an object are calculated. A computer-assisted hologram recording apparatus (see U.S. Pat. No. 5,347,375) may be one particular illustration of this circumstance. A diffraction pattern computation is repeatedly executed with respect to each of sampling points representing the 3-D object. Such a computation is carried out with a lower sampling density of about 10 dots per millimeter. The computed diffraction pattern data is stored in the intermediate page memory and then subjected to an interpolation process for increasing the sampling density to provide a high resolution necessary for the interference fringe pattern. The interference fringe pattern between the interpolated diffraction pattern and reference light is computed thereafter by converting amplitude and phase distributions into the intensity distribution and is recorded on a previously selected recording medium by means of a multi-beams scan printer with a resolution of approximately 1000 to 3000 dots per millimeter. The employment of the interpolation process in said apparatus makes it possible to enhance computation efficiency without lowering the image quality in the hologram. But, because of the enormous amount of computations that must be performed due to the resolution requirements of the fringe-form hologram interference pattern, it is time consuming to create a hologram in such a way even with high speed computing apparatus. In addition, extra large-capacity memories are necessary to execute the computation for the amount of information that increases undesirable the scale of the hologram recording system. This makes almost impossible the accomplishment of a high-speed computation process with the use of a smaller computer system.

The analysis made shows that methods and apparatus using concepts based on first synthesizing with a computer a hologram itself of holographic elements in order to represent a 3-D virtual space containing an object (or objects) and then viewing a 3-D image of the object(s) by reconstructing the hologram allow facilitation of a visual work to be made for perceiving the image depth and image variability at different perspectives with respect to those using in Display Holography. This comes from the capability of a computer-generated hologram produced by the respective of methods and apparatus in Computer Aided Holography or in true Computer Generated Holography to preserve some of 3-D aspects in an obtainable actual 3-D image. But, circumstances (or factors) resulting from the employment of the selected concept and relating to conditions of forming the hologram restrict utilizing this capability, namely, only for a 3-D image with incomplete dimensionality without vertical parallax and vertical 3-D characteristics defining this image's variability. In particular, this is explained by increasing considerably an amount of calculations and, hence, computer processing time due to a redundancy in the representation of each object point by numerous constituent hologram elements and in the resolution requirements in conditions for forming the computer-generated hologram, when producing this hologram for visual applications. And because of this redundancy, an extremely large amount of image information is contained in a computer-generated hologram.

An extremely large amount of intermediate computations made for creating a plurality of 2-D intensity (amplitude) distribution patterns, 2-D images or other 2-D intermediate representations is another reason that makes the methods and apparatus using said concepts more expensive both in computer processing time and in the amount of calculations. Intermediate representations are used for constructing small hologram elements in Computer Aided Holography or for obtaining diffraction pattern data at each of small areas on the recording surface with respect to every of selected object points in true Computer Generated Holography. Thus, circumstances relating to said intermediate computations and conditions for forming the computer-generated hologram are responsible for creating said unfavorable conditions of using computational means (or processing techniques) and for imposing these restrictions upon utilizing the hologram capability of preserving 3-D aspects in the obtainable image, and for removing 3-D aspects from a holographic record in some cases. As a result, conditions of forming the computer-generated hologram are not coordinated with conditions of using computational means in methods and apparatus embodying said concepts when producing holograms adapted for visual applications in mentioned fields. Due to an excess burden upon the electronic processing system said hologram capability is ineffectively employed or unclaimed in methods and apparatus in true Computer Generated Holography and Computer Aided Holography.

Further, irrespective of the embodiments and purposes of applications of methods and apparatus for producing computer-generated holograms, unfavorable conditions using computational means (or processing techniques) require imposing a severe limitation on an image resolution as well as eliminating vertical parallax and vertical 3-D characteristics in the obtainable 3-D image. This is not acceptable for the purposes of visual applications in the mentioned fields due to deteriorating conditions of the observation and perception of the 3-D image. In particular, this is explained by suggesting that a viewer is prohibited from viewing fine image details or small image fragments displaying particular peculiarities of the object represented in a computer database and from viewing variability in relative positions of these details or fragments in the vertical direction. Thus, because of an extremely large amount of information to be processed and an information content of a computer-generated hologram caused, e.g., by high resolution requirements of a fringe-form hologram interference pattern, these possibilities for improving conditions of the observation and perception of the 3-D image are not accomplished in these methods and apparatus. Moreover, they are in contradiction with purposes of these methods and apparatus.

One more example that conditions for forming computer-generated holograms turn out to be in contradiction with purposes of said visual applications in mentioned fields is provided in U.S. Pat. No. 3,547,510 disclosing a holographic image system and method employing narrow strip holograms. The image is created by producing a composite of identical vertically aligned strips, or by providing a single strip with vertical movement. The resultant reconstructed image has horizontal 3-D characteristics and parallax. But, vertical 3-D characteristics and parallax are sacrificed to reduce image information that must be transmitted for producing a hologram by this image system and method. Otherwise, because the amount of image information in a computer-generated hologram is quite large as compared with a conventional 2-D image, transmitting corresponding image signals would require a respective system having a bandwidth four orders of magnitude larger than that of a 2-D image transmission system. This requirement is beyond the capability of conventional input and output systems. Hence, capabilities of the latter systems turn out to be not coordinated with conditions for forming a computer-generated hologram to have vertical parallax as well as horizontal parallax. That is why, for producing a hologram adapted for said visual applications, it is important that (functional) capabilities of computational, transmission and optical means (or techniques) would be properly coordinated with conditions of using said means.

For further reducing the computation problems and information content of a hologram, a noticeable trend in Computer Generated Holography provides for an employment of concepts based on presenting 2-D images of perspective views of an object or images of different object components rather than presenting a 3-D image of an entire object as in Computer Aided Holography and true Computer Generated Holography. A hologram, being a respective representation of a 3-D virtual space containing the object(s), is electronically expressed.

A method and apparatus described in U.S. Pat. No. 5,483,364 carry out one of the latter concepts that provides for calculating a phase distribution relating to a holographic stereogram with respect to sampling points of 2-D images obtained by seeing an object represented by 3-D computer data from a number of viewpoints. By setting different sampling density, the amount of the phase calculation can be reduced without substantially deteriorating an object image quality. A part having a feature such as edge part of the object or a part of a high contrast difference is sampled at a high resolution, corresponding to the resolution limit of the human eyes, so that sampling points of that part are set at fine intervals (1/60 degree). While a smooth part of a small contrast is sampled at a low resolution and so sampling points in such non-feature part of the object are set at coarse intervals (1/30 degree). Thereby, the total number of sampling points used in the calculation is reduced as a whole. Also, for points of a non-feature part, phase distributions are discretely calculated so as to cause a blur in the reproduced image, thereby enabling a continuous plane to be displayed even when using the coarse intervals between them. Those points can be seen as if it were a plane. On the other hand, the resolution of human eyes varies depending on conditions such as observation distance, nature of the image, and so forth. Because of this circumstance, a coarse resolution is set for those sampling points that are far from the observer. Further, a part which is seen as a dark part for human eyes is not sampled at all. Therefore, by changing the sampling interval the phase calculation amount can be decreased. Calculated phase distributions are expressed by a display device such as a liquid crystal device or the like which can change an amplitude or a phase of the light.

Inventions disclosed by U.S. Pat. No. 5,436,740 and U.S. Pat. No. 5,754,317 provide transformations of an intensity distribution of diffraction light expressing a stereoscopic image, which enables the drive system of the display device for visually reproducing the stereoscopic image to be simplified. It has been suggested that the employment of a conventional computer-generated 2-D holographic stereogram permits using simple methods of the calculation by means of a computer.

An electro-optical holographic display integrated with solid-state electronics for sensing data and computing a hologram is provided in U.S. Pat. No. 5,581,378. Computation of a holographic fringe pattern is decomposed into two parts. The first part is based on using standard computer graphic techniques to produce a series of 2-D projections identical to that used by the holographic stereogram approach. These calculations must be re-computed in detail for every picture. The second part utilizes wavefront interference calculations based on a diffusion screen at a fixed position relative to the display device. Thus, although the second part calculations are time consuming, they need be done only once per device geometry. The results of the second part type calculations can be encoded in tables and generator functions, thereby enabling fast computation of a holographic fringe pattern. In a simplified version the display will operate in a horizontal parallax mode in a manner similar to the lenticular photographic or multiple hologram approach.

Embodiments of the latter concepts may be exemplified by a method described in U.S. Pat. No. 5,400,155. By reducing the information content of the hologram and calculation amount by decreasing the resolution, a plurality of slice planes which are parallel with the horizontal plane are set in the virtual space containing an object represented by a set of micro polygons. Line segments which intersect the polygons are obtained for every slice plane. Sampling points are set to each line segment with an interval determined on the basis of a resolution of the human eyes at which an array of said sampling points could be seen as a continuous line. A 1-D phase distribution on the hologram surface is calculated for every sampling point, and the calculated 1-D hologram phase distributions are added for every slice plane.

The employment of similar 2-D representations (a plurality of depth images) is provided in a hologram forming method disclosed by U.S. Pat. No. 5,852,504 (see also U.S. Pat. No. 5,570,208, U.S. Pat. No. 5,644,414 and U.S. Pat. No. 5,717,509). 3-D data representing an object in a virtual space is divided in the depth direction to produce depth images, thereby setting a plurality of 3-D regions (zones). In each region (zone) a 2-D plane parallel with a hologram forming surface is set. The hologram forming surface is divided into small areas (called “minimum units”) in a matrix manner. 3-D data relating to each zone, including the respective part of the object when it is seen by setting a visual point to the assigned areas (unit), is converted into the plane pixel data of the 2-D plane. By overlapping data obtained for every depth image of each zone, a synthesized 2-D image data can be obtained. The hidden area process is executed so that hidden parts of the object do not appear on the respective 2-D plane. The small area size is set to about 1 mm or less in each of vertical and horizontal directions. A phase distribution as the hologram forming surface is calculated from depth images and displayed on a liquid crystal display or the like as an electronic hologram.

However, employment of these concepts results in removing 3-D aspects of a reproducible image from a holographic record, so that a capability of the hologram to preserve 3-D characteristics and other 3-D aspects is unclaimed at all in respective methods and apparatus. That is why, when using the latter, problems and limitations or difficulties in the observation and visual perception of an image are similar to those in methods and apparatus relating to sectional Display Holography or Display Holography based on presenting images of perspective views and embodying the same concept of the representation of a 3-D virtual space containing an object. Thus, the lack of 3-D aspects in the holographic record places an excess burden upon the electronic processing system due to increasing a redundancy in information to be processed and in the information content of the hologram. Such a redundancy may be caused by providing, for example, a variability in 2-D images when changing viewpoints, or some other 3-D aspects therein, and the elimination of the plainly visible rear side in the 3-D image thus obtained (see above in relation to U.S. Pat. No. 5,592,313). Whereas such a redundancy in the information content of the composite hologram is caused by representing each of object points in numerous perspective views (see U.S. Pat. No. 5,748,347).

Further, the lack of 3-D aspects deteriorates conditions of the observation and perception of the 3-D image due to problems discussed hereinabove with respect to methods using in Display Holography. For instance, while viewing the composite hologram, only an illusion or impression of a 3-D image in the mind is created. This requires a complicated and difficult visual work to be made for perceiving the image depth and its variability at different perspectives, because a 3-D object is represented in this case only by a number of 2-D images when reconstructing the hologram and 3-D aspects in each of such representations are lost. Such work places an additional strain on the human visual system causing weariness and eye fatigue in contrast to viewing the actual 3-D image having 3-D aspects therein.

Similar to that in Display Holography, conditions for forming a hologram are not coordinated with conditions of using computational means in methods and apparatus embodying the latter concepts in Computer Generated Holography, since they are determined by circumstances or factors resulting from the employment of the selected concept of a representation of a 3-D virtual space. But, unlike that in Display Holography, unfavorable conditions in using computational means according the latter concepts in Computer Generated Holography require far more redundant image information to be processed due to high resolution requirements and conditions for forming a computer-generated hologram. This is explained by the large number of small areas of the hologram forming surface (see, e.g., U.S. Pat. No. 5,852,504) as well as selected points in the object. Many more 2-D intermediate representations (for instance, a number of depth images) are required to calculate the resulting phase distribution to be expressed. Therefore, it is time consuming to generate a hologram in this manner even when performing all computations in parallel at an increased processing speed. Actually, for simple computer-generated holograms, about 106 points are used in the computations, whereas high quality holograms of complex objects, however, require up to 109 points (see U.S. Pat. No. 3,832,027). In contrast to the methods embodying the latter concepts in Computer Generated Holography, the representation of selected object points in 2-D object view images in Display Holography requires far less resolution than in a computed interference pattern to be recorded or printed. That is why these methods seem to be impracticable, since an amount of computer time to compute 2-D views used in Display Holography to form a composite hologram is much less than computer time to calculate this hologram itself (see again U.S. Pat. No. 3,832,027).

Additionally, these methods embodying the latter concepts in Computer Generated Holography provide for expressing a phase distribution electronically by means of a space light modulator (SLM) such as a liquid crystal display. Such devices are also used, for example, in the method described in U.S. Pat. No. 5,119,214 and intended for optical information processing by displaying the computer-generated hologram. An electric voltage applied to each of SLM pixels is controlled according to data associated with computer-generated hologram so as to modulate spatially the transmittance or the reflectance of pixels.

It is clear that SLM pixels should be as small as possible so that they will not be easily visible to the viewer. However, for expressing a phase distribution accurately and obtaining a clear reconstruction of the image, it is necessary to reduce the liquid crystal cell to a size on the order of the wavelength. Generally, about 1000 lines (or dots) per millimeter is necessary as a resolution of such a display. Therefore, the size of pixels has to be determined on the basis of such a resolution (see, e.g., U.S. Pat. No. 5,400,155 and U.S. Pat. No. 5,852,504). These requirements are far beyond the current capabilities of liquid crystal displays or other similar devices. So, the size of pixels of the available devices is a limiting factor in these methods as it results in creating a crude hologram providing reproduction of the 3-D image with blurring due to the loss of high frequency components in the intensity distribution of diffraction light. Hence, this is not acceptable for the purposes of visual applications in mentioned fields.

That is why, it is important for producing holograms adapted for said visual applications that functional characteristics (or capabilities) of optical means (such as liquid crystal displays) would be properly coordinated with requirements for conditions for forming a hologram for providing a higher image resolution or higher quality as a whole, and with capabilities of computational means (or techniques). The last factor is caused by the excess amount of calculations associated with said 2-D intermediate representations and so requires a large amount of time for computing and processing 2-D images and time for updating SLMs (or displays)—another limiting factor in these methods.

The analysis made shows that diverse concepts of a representation of a 3-D virtual space containing an object (or objects) have been proposed in methods and apparatus in the related art to provide for reproducing (or presenting) many kinds of images to be observed and affording an observer (a viewer) different conditions for an observation and perception of a 3-D image of the object(s) thus obtained. But, while selecting a concept, circumstances and factors resulting from its employment and relating to all required conditions of using computational, optical, transmission means (or techniques) and conditions for forming a hologram should be taken into account irrespective of embodiments and purposes of applications of methods and apparatus realizing the concept to be selected. This is caused by the fact that said circumstances and/or factors are capable of restricting possibilities of improving conditions of the observation of the obtainable 3-D image and/or facilitating its perception, and/or obtaining high degree of an image resolution or its higher quality as a whole, and/or transmitting (or communicating) proper data relating to images of representations or the very hologram representing the object(s). That is why all these circumstances and factors are important for producing holograms adapted for visual applications in mentioned fields.

Moreover, such restrictions come about every time said conditions of using computational, optical, transmission means (or techniques) and conditions for forming a hologram are not proper coordinated with respect to each other and with the purposes of said visual applications as well. All of these conditions turn out to be interrelated, resulting from the employment of the same concept. Thereby, when one of said means is in unfavorable conditions, being often beyond its capabilities, other of said means (or hologram capabilities) turns out to be incompletely and ineffectively employed. But when so, this implies, on the other hand, it is due to an non-coordination or even contradiction within the concept itself with respect to purposes of said visual applications. As a result, severe limitations on an image dimensionality and/or image resolution, and/or other characteristics of the obtainable 3-D image as well as upon conditions of the observation and perception of this 3-D image are imposed. That is why, the availability of such uncoordinated conditions are not acceptable for the purposes of visual applications in mentioned fields to say nothing of methods and apparatus where purposes are in contradiction with the latter ones.

Meanwhile, none of said concepts provides all of necessary conditions to be properly coordinated or even taken into account in known methods and apparatus, and with respect to conditions of using computational means and conditions for forming a hologram, especially.

Thus, because of such uncoordinated conditions, none of the known methods and apparatus provides (or simulates) 3-D aspects in the obtainable 3-D image without increasing a redundancy in information to be processed or transmitted for producing a hologram and/or in an information content of the hologram. In particular, such a redundancy in information and/or in the information content of the hologram comes from a necessity of:
representing each of the object points from numerous viewpoints in sectional Display Holography or in Three Dimensional Imaging Techniques for providing a variability in each of sectional images and eliminating a plainly visible rear side in a 3-D image thus obtained (see mentioned U.S. Pat. Nos. 5,592,313, 5,227,898, 4,669,812 and 5,907,312);
computing and processing a great deal of 2-D images of different perspective views of an object as intermediate representations to provide presenting disparate images to an observer, as in respective Display Holography (see U.S. Pat. No. 5,748,347);
representing each of the object points in numerous constituent hologram elements when calculating 2-D intensity (or amplitude) distribution patterns across windows used as intermediate representations to form respective hologram elements in Computer Aided Holography (see hereinabove, for example, in relation to U.S. Pat. Nos. 4,778,262 and 4,969,700);
performing a large amount of intermediate computations for previously obtaining diffraction pattern data at each of small areas on a recording surface with respect to every selected object point when calculating an intensity distribution of diffraction light in true Computer Generated Holography (see hereinabove, for example, U.S. Pat. No. 5,347,375).

Such redundancy in information not only places an unnecessary burden on an electronic processing system and creates computation problems, but is often a reason that functional characteristics or current capabilities of computational, transmission, optical means (techniques) become limiting factors in known methods and apparatus such as:
a time period of updating the CRT once for each sectional component at respective positions of the moving flat screen to meet flicker fusion rate requirements in Three Dimensional Imaging Techniques (see hereinabove U.S. Pat. No. 5,907,312);
a large amount of time for computing and processing 2-D images and time for updating screens, LCLVs, SLMs, displays or other means for projecting or displaying these images, or a large memory for storing data preliminarily processed in sectional Display Holography or in Three Dimensional Imaging Techniques (see hereinabove U.S. Pat. No. 5,592,313, 5,227,898, or 5,117,296, respectively);
a minimal angular difference between adjacent perspective views to meet the requirement of providing disparate images in respective Display Holography (see hereinabove U.S. Pat. No. 3,832,027 and U.S. Pat. No. 5,748,347);
a large amount of time for producing intensity (or amplitude) distribution patterns as 2-D intermediate representations or time for computing and processing them and time for updating SLMs, displays or other electro-optical devices; or a sufficiently large memory for storing data processing for embodiments where these patterns are precomputed—in Display Holography based on presenting images of perspective views (see above U.S. Pat. Nos. 3,832,027 and 5,748,347) and in Computer Aided Holography (see hereinabove U.S. Pat. Nos. 4,778,262 and 4,969,700);
the size of small grid elements in Computer Aided Holography or the size of small areas of the hologram forming surface in Computer Generated Holography to meet high resolution requirements of a fringe-form hologram interference pattern (see hereinabove U.S. Pat. Nos. 5,347,375 and 5,852,504).

Moreover, such redundancy in information and computation problems are the reason of selecting concepts presenting to a viewer a number of 2-D images when rendering the hologram for creating an impression or illusion of a 3-D image in the viewer's mind, rather than a 3-D actual image. Although mentally transforming 2-D images into a meaningful and understandable 3-D image requires complicated and difficult visual work and deteriorates conditions of the observation and perception of 3-D image due to problems associated with the lack of 3-D aspects, or limitations in image dimensionality and in image resolution and discussed hereinabove in relation to methods using in 3-D Imaging Techniques, different types of Display Holography or Computer Generated Holography (see, generally U.S. Pat. Nos. 5,907,312, 5,117,296, 5,592,313, 5,227,898, 5,748,347, 4,498,740, 4,778,262 and 5,852,504).

On the other hand, none of known methods and apparatus embodying any of said concepts utilizes the hologram capability of preserving 3-D aspects in the obtainable 3-D image for reducing said redundancy in information to be processed and/or in the information content of the hologram or for facilitating said visual work and/or improving conditions of the observation and perception of this 3-D image. On the contrary, the achievable image resolution and 3-D image quality as a whole is frequently limited in known methods and apparatus because of requirements to the conditions for forming the hologram, for instance, such as:
each of individual holograms in the composite hologram should be quite narrow to provide that each eye of the viewer sees the image through a different individual hologram (see above U.S. Pat. Nos. 3,832,027 and 5,748,347);
the size of each independent individual holograms should be small enough to meet requirements to dynamic range capabilities of the recording material (U.S. Pat. No. 4,498,740);
the size of grid elements in Computer Aided Holography should be small enough to meet high resolution requirements of a fringe-form hologram interference pattern (see hereinabove U.S. Pat. Nos. 4,778,262 and 4,969,700).

Also, the capability of the hologram to preserve 3-D characteristics and other 3-D aspects in the obtainable 3-D image is unclaimed at all in methods and apparatus in true Computer Generated Holography (see above, for example, U.S. Pat. No. 5,852,504).

Therefore, the analysis made of the diverse methods and apparatus in the related art shows that most of problems and limitations (or restrictions) pertaining to visual applications of holograms in the mentioned fields are associated with selected concepts of the representation of the 3-D virtual space containing the object(s). None of known concepts is capable of providing all conditions of using computational and optical means (or techniques), transmission or other means when employed, as well as conditions for forming a hologram to be coordinated or proper coordinated with respect to each other and with the purposes of said visual applications in mentioned fields. So, it is highly desirable to apply a nontraditional approach to a development of concepts to provide not only an appropriate presentation of an object (or objects) in the real world, but also such a coordination of all these conditions by taking into account a lot of circumstances or factors concerned. Hence, this approach requires finding a way that these problems of the prior art can be solved and limitations (or restrictions) overcome as well as selecting what is to be specified in a 3-D virtual space and what is to be presented to an observer (viewer) when producing holograms adapted for visual applications in all aspects mentioned above as well as in capabilities of communicating (or transmitting) respective data for such purposes.

It is an important object of the present invention to provide a complex of basic concepts to be employed in computer-assisted methods and apparatus for forming holograms that solve (or avoid) the principal problems (or difficulties) of the prior art and overcome the main limitations (or restrictions) inherent to the prior art for producing holograms adapted for visual applications in mentioned fields in all aspects discussed hereinabove. These concepts to be selected into the complex relate essentially to:
a representation of a 3-D virtual space containing an object (or objects);
conditions for using computational and/or transmission means and optical means (techniques) being in proper cooperation with each other for forming a hologram;
conditions for forming a hologram (holograms).

It is another important object of the present invention to provide the complex with such concepts that permit carrying out a coordination of conditions of using computational (as well as transmission means, if employed) and optical means (or techniques) in methods and apparatus embodying these concepts in order to avoid a redundancy in the information to be processed or transmitted for producing a hologram and/or in information content of the hologram, and because of that to avoid an unnecessary burden on an electronic processing system.

It is yet another object of the present invention to provide the complex with such concepts that permit carrying out a coordination of said conditions so that the hologram capability of preserving 3-D characteristics and other required 3-D aspects in the optical image to be produced could be employed more completely and effectively, and, thereby, enable additional reduction of the burden upon the electronic processing system as well as computation problems in order to create more favorable conditions of using computational means.

It is still another important object of the present invention to provide a computer-assisted method and apparatus for forming a hologram (or holograms) that embodies the proposed complex of such concepts for attaining purposes of said visual applications in mentioned fields and, thereby, for improving conditions of an observation and perception of a 3-D optical image to be produced and obtaining a high degree of image resolution or its higher quality as a whole.

It is a further object of the present invention to provide the complex with a new concept, which pertains to a representation of the 3-D virtual space containing the object(s) and is based on an employment of a specific representation relating to each of object components specified in the virtual space and allowing 3-D aspects in each of such representations to be retained in contrast to that in the prior art, when using 1-D and 2-D representations.

It is yet further object of the present invention to provide a computer-assisted method and apparatus for forming a hologram (or holograms), which embodies the new concept of said representation together with other concepts of the complex for reducing strain on the human visual system while viewing a 3-D image produced, as well as for avoiding said problems and difficulties associated with the observation and perception of images of 1-D and 2-D representations in the prior art, where 3-D aspects in each of them being lost.

It is a still further object of the present invention to provide a computer-assisted method and apparatus for forming a hologram (holograms), which embodies the new concept of said representation together with other concepts of the complex to enable producing an actual three-dimensional optical image of the entire object or its parts and thereby facilitating a visual work to be made for perceiving an image depth and variability at different perspectives as compared with that to be made for creating an impression or illusion of a 3-D image in the viewer's mind according to the prior art.

It is another object of the present invention to provide the complex with a new concept that relates to conditions of using optical means (or techniques) and is based on retaining 3-D aspects in specific representations optically and individually for each of object components, while using respective data in the computer database directly without calculating, processing and employing any of 2-D intermediate representations or carrying out any intermediate computations, as in the prior art, that enable recreating or providing some of 3-D aspects with computational means.

It is still another object of the present invention to provide the complex with said new concepts to enable carrying out a proper coordination of said conditions so that computational means would not be used for performing functions or operations that can be better performed by other means (and/or the hologram itself). In other words, said conditions should be so that computational means could be used only for what they do best: for storing data relating to object components, respectively selecting this data and handling or controlling said optical means (or techniques) in accordance with selected data for purposes mentioned above or for transmitting (or communicating) selected data to remote users for such purposes.

It is yet another object of the present invention to provide a computer-assisted method and apparatus for forming a hologram (or holograms), which embodies said new concepts together with other concepts of the complex to permit reducing with respect to the prior art an amount of calculations for producing the hologram(s) as well as computer processing time and/or memory for storing data processing. This is highly important when on-line communication or transmission of respective data to remote users is desirable.

It is a specific object of the present invention to provide a computer-assisted method and apparatus for forming a hologram (or holograms), which embodies the proposed complex of such concepts for carrying out the proper coordination of said conditions so as to overcome limitations in image dimensionality and restrictions in image resolution, like those associated with size of individual holograms in the prior art, and permits thereby reproducing image details like a classical hologram.

### SUMMARY OF THE INVENTION

These and other objects and advantages are attained in accordance with the present invention that provides a computer-assisted hologram forming method and apparatus. More particularly, the present invention provides a method for forming a hologram that can be illuminated to produce a three-dimensional optical image of an object, comprising the steps of:
providing a computer database with three-dimensional data representing the object composed of local components, each local component being specifiable in a three-dimensional virtual space with respect to a reference system by at least its position and its optical characteristics associated with an individual spatial intensity (or amplitude) distribution of directional radiation extending from that local object component in its respective spatial direction and in its respective solid angle,
selecting data relating to each of a representative sample of local object components having its associated individual directional radiation lying within an assigned field of view of the three-dimensional optical image to be produced,
physically reproducing in light the individual spatial intensity (or amplitude) distribution of directional radiation associated with each of said sample of local object components using a first coherent radiation beam and transforming this beam in a coordinate system by varying parameters of at least one part thereof to be used in accordance with selected data, individual directional radiation thus reproduced from a local region and revealing itself individually and having definite spatial specificity in its optical parameters in the assigned field of view to provide three-dimensional aspects in the optical image to be produced,
establishing the local region of thus reproduced individual directional radiation with respect to said coordinate system to be at a location coordinated with the position of its associated local object component in the virtual space and directing said reproduced individual directional radiation onto a corresponding area of a recording medium,
holographically recording said reproduced individual directional radiation using a second radiation beam coherent with first radiation, adjusting parameters of the second radiation beam with respect to the coordinate system in accordance with selected data and directing a reference beam thus produced onto the area of the recording medium along with said reproduced individual directional radiation so as to form in this area a hologram portion storing said reproduced individual directional radiation and preserving thereby its individuality and definite spatial specificity in its optical parameters in the assigned field of view, a respective spatial intensity (or amplitude) distribution of directional radiation stored in said hologram portion being, therefore, a three-dimensional representation of optical characteristics of its associated local object component as well as the position of this component in the virtual space, and
integrating hologram portions by at least partial superimposing of some of them upon each other within said recording medium for forming together a superimposed hologram capable, when illuminated, of rendering simultaneously said respective spatial intensity (or amplitude) distributions of directional radiation stored in all of the hologram portions thereby producing an actual three-dimensional optical image of at least a part of the object, such an image having a complete dimensionality and exhibiting all required three-dimensional aspects preserved due to storing said three-dimensional representations in the superimposed hologram.

The essence of the present invention is based on an inventor's interpretation of problems of the prior art and on a conception of a necessity of a coordination of conditions of using computational means (and transmission means, if employed) and optical means (or techniques), and conditions for forming a hologram between each other when producing holograms adapted for visual applications in mentioned fields. That is why, none of known concepts of diverse representations of a 3-D virtual space containing an object could be used, and a nontraditional approach is required to propose a complex of concepts including a new concept of such representation for providing the coordination of said conditions in a proper manner and selecting what is to be specified in a 3-D virtual space for such purposes.

This new concept is based, according to the present invention, on employing spatial optical characteristics of object components (rather than images thereof as in the prior art) for simulating optical properties of an object in the 3-D virtual space. Such characteristics should be related to each local object component for simulating particular peculiarities in optical properties of fine object details or small fragments of any surface area of an object are they are presented to an observer when viewing in the real world. Further, such optical characteristics should be specified individually for each of the local object components representing individuality and definite spatial specificity in optical properties of each corresponding object details or each corresponding surface areas of the object, when viewing thereof from different points in the assigned field of view. These are some of reasons due to which spatial optical characteristics of each local object component specified in the computer database are represented in the virtual space, according to the present invention, by individual directional radiation extending from that object component in its respective spatial direction and in its respective solid angle. Thus, such unique specific representation of said optical characteristics of that local object component is associated, in fact, with an individual spatial intensity (or amplitude) distribution of directional radiation. But, the principal reason of employing such unique specific representation is associated with a possibility of retaining individuality and definite spatial specificity of said optical characteristics in the assigned field of view when reproducing individual directional radiation in the real world by using capabilities of available optical means (or techniques). Because of that, the proposed complex of concepts is provided with a new concept relating to conditions of using optical means (or techniques) and being based on retaining only optically and individually 3-D aspects in each of such specific representations and, thereby, individuality and definite spatial specificity of optical characteristics of each local object component.

The reproduced individual spatial intensity (or amplitude) distribution of directional radiation should be recorded holographically for preserving, thereby, its individuality and definite spatial specificity in the assigned field of view in a respective portion of a hologram to be formed. That is why a respective individual spatial intensity (or amplitude) distribution of directional radiation stored in said hologram portion is a 3-D representation of spatial optical characteristics of that local object component and provides thereby all appearing 3-D aspects in the optical image to be produced. All 3-D representations are stored in respective hologram portions of a superimposed hologram capable, when illuminated, of rendering simultaneously a variety of actual individual spatial intensity (or amplitude) distributions of directional radiation each revealing itself individuality and definite spatial specificity in the assigned field of view. Thus, an actual three-dimensional optical image composed of rendered distributions of individual directional radiation, each displaying independently particular peculiarities in spatial optical properties of one corresponding of object details or one corresponding of surface areas of the object, is presented to the observer. As a result, the actual 3-D optical image thus produced has a complete dimensionality and exhibits all required 3-D aspects, when viewing thereof from different viewpoints in the assigned field of view.

Optical retaining individuality and definite spatial specificity of said optical characteristics in reproduced individual directional radiation is accomplished due to capabilities of optical means (or techniques) to perform diverse transformations of coherent radiation. The transformation of each reproduced individual directional radiation is accomplished so that its optical parameters, such as its respective spatial direction and its respective solid angle, turn out to be coordinated with optical characteristics of its associated local object component specified in the virtual space.

Such individual retaining said individuality and definite spatial specificity of optical characteristics of each object component in respective reproduced individual directional radiation imparts required 3-D aspects to the latter and permits one to independently preserve said particular peculiarities in spatial optical properties of said object detail (or surface area of the object) in the respective hologram portion. Therefore, the hologram capability of preserving 3-D characteristics and other required 3-D aspects in the optical image to be produced turns out to be employed more completely and effectively than in the prior art.

The fact that 3-D aspects in rendered distributions of individual directional radiation are preserved due to using such unique specific representations proposed, said capabilities of optical means (or techniques) and the hologram capability as well is a crucial factor resulting from the employment of the entire complex of such concepts. That is why computer-assisted methods and apparatus embodying proposed concepts for forming holograms permit carrying out a coordination of said conditions in such a manner to provide attaining significant advantages over those used in the prior art.

Actually, there is no necessity, when embodying such concepts, to recreate 3-D aspects by using computational means, e.g., by providing a variability in each of sectional images to be viewed from different viewpoints to improve perceiving 3-D mental images, as is done in Display Holography or in Three Dimensional Imaging Techniques (see U.S. Pat. Nos. 5,592,313 and 5,227,898, or U.S. Pat. Nos. 4,669,812 and 5,907,312). Also, there is no necessity to provide said 3-D aspects by computing and processing a great deal of 2-D images of different perspective views of the object to be holographically recorded directly, or by employing their intermediate representations previously produced thereto, for presenting disparate images to the observer, as it is done in respective Display Holography (see, e.g., U.S. Pat. No. 5,748,347), or 2-D intensity (or amplitude) distribution patterns across the windows for forming hologram elements in Computer Aided Holography (see U.S. Pat. No. 4,778,262 and U.S. Pat. No. 4,969,700).

Both circumstances are explained by preserving said 3-D aspects in each of said 3-D representations stored in respective hologram portions in contrast to the prior art, which uses 1-D and 2-D representations. Further, the last factor is explained also by using respective data in the computer database directly for reproducing individual spatial intensity (or amplitude) distributions of directional radiation by optical means (techniques), without calculating, processing and employing any of 2-D intermediate representations or carrying out any intermediate computations. Because of that, the amount of calculations for producing a hologram as well as computer processing time and/or memory for storing data processing can be greatly reduced with respect to that in the prior art. On the other hand, a redundancy in information to be processed or transmitted for producing the hologram that is associated with recreating or providing some of 3-D aspects with computational means in the prior art can be avoided, while computation problems (like those in U.S. Pat. Nos. 5,237,433, 5,475,511, and 5,793,503) can be reduced.

Furthermore, due to employing the proposed concept of using capabilities of optical means (or techniques) and the hologram capability as well, individuality and definite spatial specificity of said optical characteristics of each local object component in the assigned field of view are retained individually and independently in the respective individual spatial intensity (or amplitude) distribution of directional radiation stored as their 3-D representation in said hologram portion. That is why the employment of these concepts together with the proposed new concept of said representation permits avoiding any redundancy in information to be processed or transmitted for producing a hologram and/or in information content of the hologram and thus avoiding an unnecessary burden on the electronic processing system. Such results of the employment of the proposed complex of said concepts are very important and provide significant advantages of computer-assisted methods and apparatus embodying thereof over those ones employing computational means for recreating or providing 3-D aspects in the 3-D image produced. These advantages are associated, with creating more favorable conditions of using computational means for forming holograms than in the prior art.

These favorable conditions are expressed in that computational means can not be used for performing functions or operations that can be better performed by other means (or the hologram itself) used according to the proposed complex of concepts. This is unlike the prior art where, e.g., computational means are used for creating and expressing a hologram electronically in the form of a phase distribution like in Computer Generated Holography, and the large amount of redundant image information is to be processed due to high resolution requirements to conditions for forming a computer-generated hologram (see, e.g., U.S. Pat. No. 5,852,504). In other words, said favorable conditions turn out to be such that computational means can thus be used only for what they do best: for storing data relating to local object components specifiable in the 3-D virtual space, selecting respectively this data and handling or controlling said optical means (or techniques) in accordance with selected data to reproduce said specific representations of optical characteristics of local object components for their holographic recording.

The possibility of the coordination of said conditions in such a proper manner is a very important result of employing the proposed complex of such concepts. Thus, released capabilities of computational means can be used more effectively for the purposes of said visual applications. Namely, for improving conditions of the observation and perception of a 3-D optical image to be produced and obtaining a high degree of image resolution or its higher quality as a whole, or for transmitting (communicating) selected data to remote users for such purposes. In particular, the number of local object components specified in the virtual space could be increased to provide smaller object details and increase therefore the optical image resolution. Accordingly, fine image details (or small image fragments) displaying particular peculiarities of the object, e.g., such as delicate features, perhaps important for the observer, can be presented thereto. Moreover, such an increase in the achievable 3-D image resolution is not limited by sizes of individual hologram portions, in contrast to that in the composite image (see, e.g., U.S. Pat. No. 5,748,347 or U.S. Pat. No. 4,969,700) or in the image composed of images of discrete points of light to be presented to the observer (see U.S. Pat. No. 4,498,740). This comes from the fact that, generally, sizes of hologram portions in the present invention are not as small as those ones in the prior art methods. On the contrary, the sizes of hologram portions are changed in a wide range depending on optical characteristics and positions of local components specified for the particular object, the assumed location of its optical image with respect to a recording medium and on other circumstances. Therefore, there are no limitations for reproducing image details like a classical hologram by computer-assisted methods and apparatus embodying the proposed complex of concepts. Furthermore, there are no redundant requirements such as resolution requirements of a fringe-form interference pattern in Computer Aided Holography and Computer Generated Holography for producing holograms adapted for visual applications in mentioned fields. Hence, such image resolution can be accomplished by proper specifying data relating to spatial optical characteristics and positions of local object components in the 3-D virtual space, as exemplified above, and taking into account that nothing beyond the resolution of unaided eye is needed when presenting fine image details to the observer.

Thus, the discussed coordination of conditions of using computational means, optical means (or techniques) and conditions for forming holograms in proposed computer-assisted method and apparatus permits, due to avoiding any redundancy in information to be processed, overcoming limitations (or restrictions) in a 3-D image dimensionality and in image resolution with respect to the prior art. In particular, those restrictions associated with size of individual holograms like in Composite Holography (multiplex or lenticular) or Display Holography and with said resolution requirements in Computer Aided Holography and Computer Generated Holography are avoided as mentioned above.

Also, inasmuch as each specific representation, according to the proposed complex of concepts, is reproduced individually and completely by optical means (techniques) in the form of a respective spatial intensity (or amplitude) distribution of directional radiation, only information relating to optical parameters of the individual directional radiation to be reproduced is required for handling or controlling optical means (or techniques). In other words, according to the present invention, only such control data should be transmitted (or communicated) by transmission means to the remote users as proper data to form hologram portions of a superimposed hologram. This result is unlike to that in the prior art where information relating to 2-D images of respective representations or the hologram itself is required for producing the hologram (see, e.g., U.S. Pat. No. 5,227,898). So, this is an important result of employing the proposed complex of concepts in computer-assisted methods and apparatus to reduce considerably the amount of information to be processed or transmitted for producing a hologram. This result not only permits overcoming limitations of the prior art in the image resolution and 3-D image dimensionality, but also provides said and other significant advantages, when on-line communication or transmission of proper data to remote users is desirable to produce the superimposed hologram.

It is to be noted that said unique specific representations provide complete and exhaustive 3-D information about an object due to the fact that individual directional radiation associated with each of local object components represents fully its spatial optical characteristics. Whereas the latter are merely a simulation of actual radiation scattered, reflected, refracted, transmitted, radiated or otherwise directed toward an observer by one respective of fine details or by one respective of small fragments of one of surface area of the particular object or its part observable in the real world. Thus, the 3-D optical image produced according to the present invention can be perceived by the viewer as the actual 3-D optical image in the real world. There is a definite advantage in representing an object in the 3-D virtual space by said spatial optical characteristics of its local components, rather than by images of such components or whatever other components, as in the prior art.

One more important result of employing the proposed complex of concepts in computer-assisted methods and apparatus is associated with selecting what is to be presented to an observer (viewer) in order to produce holograms adapted for visual applications. According to the present invention, this is a variety of actual individual spatial intensity (or amplitude) distributions of directional radiation stored in all of hologram portions as 3-D representations of spatial optical characteristics of object components and rendered simultaneously when illuminating the hologram. This is in contrast to the prior art where a great deal of images of 1-D and 2-D representations of respective object components or different perspective views of the object are presented to the observer and where 3-D aspects are lost in each of such images. 3-D representations preserve themselves all required 3-D aspects of an actual optical image to be produced and so facilitate a visual work to be made for perceiving an image depth and its variability at different perspectives as compared with those which create an impression or illusion of a 3-D image in the observer's mind, according to the prior art.

Actually, each actual individual spatial intensity (or amplitude) distribution of directional radiation reveals itself individuality and definite spatial specificity in the assigned field of view, as mentioned above. So, for instance, said image variability appears itself when simply changing viewpoints. As a result, the actual optical image composed of rendered distributions of individual directional radiation exhibits all required 3-D aspects and has horizontal and vertical parallax, i.e., a complete dimensionality. So, an actual 3-D image that is similar to natural vision can be achieved. Because of that, the strain on the human visual system is considerably reduced as compared with the prior art, while problems and difficulties associated with viewing said images of 1-D and 2-D representations or images of perspective views are avoided. Said problems mean, for example, those ones associated with the complicated visual work required for integrating sectional images in the mind into the meaningful and understandable 3-D image, which places the great strain on the human visual system. Whereas said difficulties mean, e.g., those associated with hard conditions for viewing a composite image having the mismatch in its position that places the strain on the human visual system causing weariness and eye fatigue, as mentioned above. These examples specifically explains the principal difference between viewing 3-D mental image, while seeing, in fact, a set of 2-D images, and viewing an actual 3-D image produced according to the present invention.

Thus, computer-assisted methods and apparatus embodying the complex of proposed concepts permit presenting to the viewer said variety of actual individual spatial intensity (or amplitude) distributions of directional radiation stored as 3-D representations of spatial optical characteristics of local object components, rather than images of these components, and thereby have said significant advantages over those presenting images of said 1-D and 2-D representations of the 3-D virtual space containing the object (see background discussion above).

Meanwhile, individuality of each specific representation does not prevent one from reproducing independently and simultaneously in groups respective spatial intensity (or amplitude) distributions of directional radiation for their holographic recording. This permits overcoming problems pertaining to dynamic range capabilities of the photosensitive recording material, if it is necessary, for example, to form the hologram of a complex object. So, this results in attaining serious advantages over those methods in the prior art where dynamic range capabilities are a limiting factor for an achievable image resolution or a 3-D image quality and, in particular, over those presenting the image composed of images of discrete points of light to the observer (see, e.g., U.S. Pat. No. 3,698,787 or U.S. Pat. No. 4,498,740).

Apart from this, the definite advantage of the proposed computer-assisted method and apparatus is the possibility of using available optical means (or techniques) for reproducing said spatial intensity (or amplitude) distributions of directional radiation independently and simultaneously in respective groups, e.g., such as described in U.S. Pat. No. 5,907,312. Said optical means, as mentioned above, are composed of a large number of pixels each having a plurality of diffraction elements (elementary holograms) for diffracting light in different predetermined directions and comprise also means for enlarging a laser beam in size and means for spatially modulating the intensity of transmitted light (like a liquid crystal panel) to illuminate each pixel. However, the method of employing said optical means fails to preserve 3-D aspects, as they are lost in each of sectional images presented to the viewer, and so the method uses computational means for their recreation, as discussed hereinabove.

The analysis made of the essence of the present invention shows that the proposed complex of concepts providing said significant advantages over the prior art is realized in the proposed computer-assisted method by the following distinctive features:
employing spatial optical characteristics of object components for simulating optical properties of an object in a 3-D virtual space;
specifying such optical characteristics individually for each local object component for representing individuality and definite spatial specificity in optical properties of each corresponding of object details or each corresponding of surface areas of the object when viewing thereof from different points in the assigned field of view;
representing said optical characteristics of each local object component in the virtual space by individual directional radiation extending from that local object component in its respective spatial direction and in its respective solid angle; such unique specific representation of said optical characteristics of that local object component being associated with an individual spatial intensity (or amplitude) distribution of directional radiation;
selecting data to be used directly to provide reproduction of said individual directional radiation in the real world;
physically reproducing in light said individual directional radiation by optical means (or techniques) in accordance with selected data for retaining individually and optically said individuality and definite spatial specificity of optical characteristics of each local object component in the assigned field of view;
recording said reproduced individual spatial intensity (or amplitude) distribution of directional radiation holographically for its storing in a respective hologram portion to be a 3-D representation of said optical characteristics of its associated local object component and preserving thereby its individuality and definite spatial specificity in the assigned field of view;
integrating hologram portions by at least partial superimposing some of them upon each other within the recording medium to form together a superimposed hologram and thereby integrating said 3-D representations stored in all hologram portions, the superimposed hologram capable when illuminated to present a variety of actual individual spatial intensity (or amplitude) distributions of directional radiation rendered simultaneously and thus combined into an actual 3-D optical image having a complete dimensionality and exhibiting all required 3-D aspects.

These distinctive features are essential for preserving 3-D aspects in each of 3-D representations and thus for displaying independently particular peculiarities in spatial optical properties of one corresponding of object details or surface areas of the object when viewing said 3-D optical image from different viewpoints.

Further objects, advantages, and features of the present invention, which are defined by the appended claims, will become more apparent from the following detailed description with reference to the drawings.

### BRIEF DESCRIPTION OF THE DRAWINGS

FIG. 1 illustrates a diagrammatic view of specifying spatial optical characteristics of local object components for a representation of an object in 3-D virtual space;

FIG. 2 shows a diagrammatic view of one variant using constituent distributions for the presentation of an individual distribution of directional radiation;

FIG. 3 shows a diagrammatic view of another variant using constituent distributions for the presentation of, an individual distribution of directional radiation;

FIG. 4 is a schematic illustration of a procedure for reproducing individual directional radiation according to one embodiment of the present invention;

FIG. 5 is a schematic illustration of a procedure for recording individual directional radiation reproduced according to the embodiment of the invention shown in FIG. 4;

FIG. 6 shows a structure of a computer-assisted apparatus for forming a hologram according to one embodiment of the present invention;

FIG. 7 shows a different structure of a computer-assisted apparatus for forming a hologram according to one embodiment of the present invention;

FIG. 8 shows a different structure of a computer-assisted apparatus for forming a hologram according to one embodiment of the present invention;

FIG. 9 is a general view of a computer-assisted apparatus for forming a hologram according to first and second preferable embodiments of the present invention;

FIG. 10 is a fragmentary view of the apparatus shown in FIG. 9 and an illustration of its use;

FIG. 11 is a fragmentary view of the apparatus according to the second preferable embodiment of the present invention and illustration of its use;

FIG. 12 shows a schematic views of a modification in the structure of optical means for transforming a first coherent radiation beam for the apparatus according to the second preferable embodiment of the invention;

FIG. 13 shows a schematic view of a different modification in the structure of optical means for transforming a first coherent radiation beam for the apparatus according to the second preferable embodiment of the invention;

FIG. 14 shows a schematic view of a different modification in the structure of optical means for transforming a first coherent radiation beam for the apparatus according to the second preferable embodiment of the invention;

FIG. 15 shows a fragmentary view of a means for creating a representative optical element and an illustration of its use for transforming a first coherent radiation beam for the apparatus according to the second preferable embodiment of the invention;

FIG. 16 shows a fragmentary view of a means for creating a representative optical element and an illustration of its use for transforming a first coherent radiation beam for the apparatus according to the second preferable embodiment of the invention; and

FIG. 17 shows a picture of pixel maps created in one representative optical element in the structure shown in FIG. 15.

### DETAILED DESCRIPTION OF THE PREFERRED EMBODIMENTS

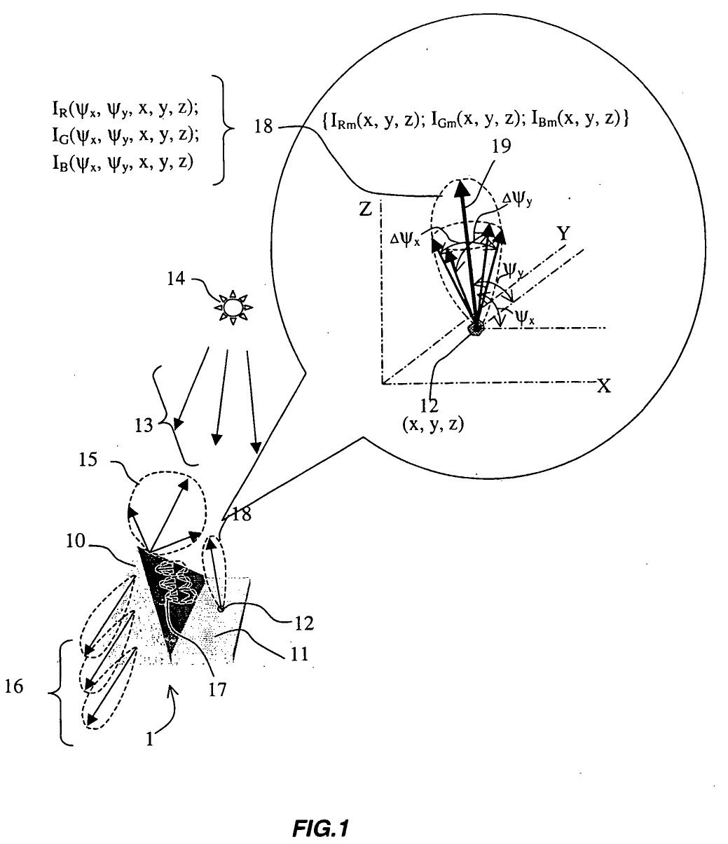

The process of forming a hologram by directly using 3-D data representing an object composed of a plurality of components in a computer database is referred to in this disclosure as a procedure performed independently for each of the components. In this procedure, each of the local object components is specified in 3-D virtual space by at least its position and its spatial optical characteristics having a unique specific representation in the form of individual directional radiation extending from that local object component in its respective spatial direction and in its respective solid angle. An individual spatial intensity (or amplitude) distribution of directional radiation is reproduced in light in the real world for optically retaining individuality and definite spatial specificity of said optical characteristics in the assigned field of view. Individual directional radiation reproduced is thereafter holographically recorded and stored in a respective hologram portion as a 3-D representation of optical characteristics of its associated local object component. Individuality and definite spatial specificity of optical characteristics are thereby preserved providing the appearance of 3-D aspects in an optical image produced by rendering simultaneously respective actual individual spatial intensity (or amplitude) distributions of directional radiation stored as 3-D representations in all hologram portions when illuminating the hologram. Such a procedure, with respect to one of the local object components, the procedure being a subject of this disclosure of one embodiment of the present invention, is described in detail with reference to FIG. 1. The object 1 is shown schematically as a pyramid 10 with a flat plate 11 attached thereto near its base. Optical properties of small surface elements (or fragments) disposed at edges or on faces of the pyramid 10, or on the surface of the plate 11 (e.g., such as one denoted by 12) and illuminated by light 13 from a source 14 are simulated by spatial optical characteristics of radiation reflected (or scattered) therefrom. Because of that, said optical characteristics are represented by respective individual spatial intensity (or amplitude) distributions of directional radiation extending from such surface elements, like those symbolically depicted by 15, 16, 17 and 18 respectively (shown by dashed lines). Spatial optical characteristics and positions of surface elements are specified in virtual space with respect to a reference system associated with the object 1 and represented by X, Y and Z axes shown in the inset into FIG. 1, where Z axis is oriented in the depth direction. Thus, a typical surface element 12 is specified by its coordinates (x, y, z) in this reference system and its associated individual spatial intensity (or amplitude) distribution of directional radiation 18 extending from the element 12 in a spatial direction of its maximum and in its respective solid angle. This spatial direction is shown by a vector 19 and determined by angles •ₓ and •_{y} between vector 19 and planes XY and YZ accordingly. Whereas this solid angle is specified by angular width ••ₓ and ••_{y} of said distribution of directional radiation 18 in directions parallel to X and Y axes respectively. The width ••ₓ (or ••_{y}) of said distribution is determined at a level of, for example, 0.5 the radiation intensity (or 0.7 the radiation amplitude) of the maximum and depicted as an angle between vectors (not marked in FIG. 1) traced from the position of element 12 to opposite points of distribution 18 that are arranged at said level (shown by a dashed line) along said direction parallel to X (or Y) axis. Intensity functions of directional radiation having wavelengths in the red, green or blue ranges of the visible spectrum are given as an explanation in the reference to said distribution of directional radiation 18.

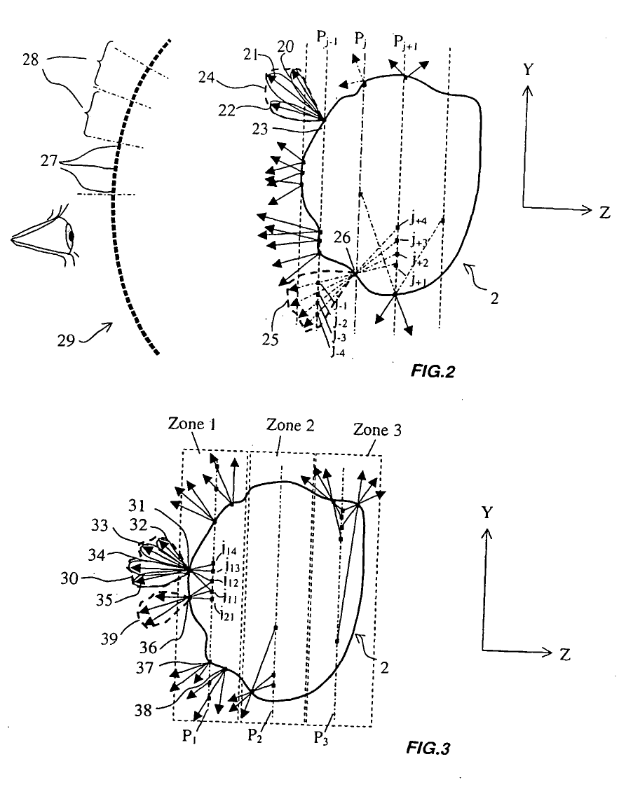

Thus, individuality and definite spatial specificity of optical characteristics of element 12 in the assigned field of view may be represented by optical parameters •ₓ, •_{y} and ••ₓ, ••_{y} as well as by a radiation intensity (or amplitude) value at the maximum of said distribution of individual directional radiation 18 and coordinates (x, y, z) of element 12. This is so, of course, if the form of said distribution is previously determined and approximated, e.g., by a Gaussian curve. Further, if the form of said distribution turns out to be close to that of the distribution of radiation reproducible by the available optical means (or techniques) in the real world, as it does, nothing more than these parameters is required for reproducing said distribution of directional radiation 18 by the optical means. In other words, there is no necessity to use for such a purpose all data relating to the whole distribution itself. So, the feasibility of handling or controlling said optical means (or techniques) for such a purpose, i.e., using only these optical parameters of individual directional radiation 18 as control data, becomes clearer. Furthermore, any of the known ways can be employed to provide the computer database with such control data for each and every surface element (or fragment) used for representing an object. Said parameters may be calculated in a master controller or graphics processor from available distributions using methods (or mathematical algorithms) common for such processing, or may be set into the computer manually using a suitable computer program, or be obtained from a local or global computer network. That is why the individual spatial intensity (or amplitude) distribution of directional radiation associated with optical characteristics of each of said surface elements (or respective fragments of any surface area of the object) can be completely and exhaustively specified in virtual space with respect to the reference system by appropriate characteristics of one respective directivity pattern. A directivity pattern is specified in spatial polar coordinates originating normally from the position of extending (emerging) radiation to be simulated or approximated in such a way. Because of that, each directivity pattern has its origin at a position of the respective local object component and also has characteristics including an angular width, a spatial direction of its maximum and a radiation intensity (or amplitude) value in this direction as well. Such a presentation can be applied to spatial optical characteristics of all said surface elements, or like local object components, relating to the entire object, or to those of a representative sample of local object components relating to any object part desirable to be presented. Said part of the object includes each of surface areas thereof that are visible from at least one of the segments of the assigned field of view. For example, such parts of object 1 shown in FIG. 1 may include two visible faces of the pyramid 10 (for one more example see below in FIG. 2).

Meanwhile, the present invention permits employing another presentation of the individual spatial intensity (or amplitude) distribution of directional radiation associated with optical characteristics of each of at least said sample of local object components in virtual space with respect to said reference system by selecting a respective bundle of multitudinous rays. Each ray is specifiable by an intensity (or amplitude) of radiation and one of different directions pre-established for said rays and lies within a solid angle of the local object component's individual distribution of directional radiation, and is oriented along this direction so as if all of rays emanate from its associated local object component. Some of said rays are represented by vectors (not marked in FIG. 1) traced from the position of element 12 to different points of distribution 18. Such a presentation seems to be similar to that employed in the volumetrical scanning type 3-D display disclosed by U.S. Pat. No. 5,907,312. But, a bundle of rays presented by each screen pixel in this display is selected during the process of moving the flat screen and intended for reproducing an image of the respective point in one of the separate depth plane images to be presented to the observer in the field of view at a precise moment of this process. By contrast, the bundle of rays in the present invention is specified by respective data in the computer database in advance and intended for reproducing the respective distribution of directional radiation to be recorded holographically in the respective hologram portion. Thus stored, the bundle of rays is rendered to produce the actual individual spatial intensity (or amplitude) distribution of directional radiation itself revealing individuality and definite spatial specificity in the assigned field of view. Bundles of rays associated with optical characteristics of all local object components are presented simultaneously to the viewer when illuminating the hologram. Therefore, with respect to the prior art such a presentation provides definite advantages described generally hereinabove. On the other hand, if compared with the former presentation using the directivity pattern, it turns out to be more expensive in the amount of information and in processing time because of the multitudinous number of rays to be employed.

Spatial optical characteristics of small surface elements (or fragments) arranged on each of the faces of pyramid 10 are specified by similar individual spatial intensity (or amplitude) distributions of directional radiation, like those depicted by 16 (or 17). This enables one to represent particular peculiarities in optical properties of each corresponding surface area of the object (such as, e.g., the faces of pyramid 10) when viewing from different viewpoints in the assigned field of view. Hence, local object components arranged on each of such surface areas could be combined in one of the groups as having optical characteristics specifiable by similar characteristics of directivity patterns in virtual space. Namely, each directivity pattern has the same angular width and the same spatial direction of its maximum for any local object component in the same group. These characteristics should be selected to provide for representing peculiarities in optical properties of said surface area of the object. Evidently, these characteristics depend as well on the position of such areas in the object, and its orientation with respect to the light source, like source 14. For representing said peculiarities in optical properties more realistically, e.g., by smoothing transitions between individual distributions of directional radiation (like those depicted by 16), characteristics of directivity patterns in virtual space are selected so as to provide partial overlapping of individual spatial intensity (or amplitude) distributions of directional radiation associated with some (for example, adjacent) of the local object components in the same group.

Meanwhile, when using at least two such groups, each of the directivity patterns relating to optical characteristics of local object components in one of the groups has its characteristics different in the angular width and/or in the spatial direction of its maximum from characteristics of any of the directivity patterns relating to optical characteristics of local object components in other groups, like one of the items 16 differs from any of 17. So, individuality and definite spatial specificity in optical properties of each corresponding surface area of the object (like one of the faces of pyramid 10), when viewing it from different viewpoints in the assigned field of view, can be represented in characteristics of directivity patterns relating to local object components of the respective group. This is highly important, because characteristics of directivity patterns can be transmitted (or communicated), e.g., to remote users, as control data for forming portions of the superimposed hologram. Thus, the amount of information to be processed or transmitted for producing such a hologram can be considerably reduced, as mentioned hereinabove.

It is to be noted that object 1 is described by way of the explanation only, it is not intended that the present invention be limited thereto. In other words, an object of any configuration, simple or complicated, of any shape, flat or deep in the depth direction, and of any composition with constituent parts having different orientations and arrangement and being composed of different types of local object components can be represented, according to the present invention (like the ones shown in FIGS. 2 and 3). The entire object or any of its parts, or separate details of a composition represented as the object, or any other detail thereof can be composed, for example, of fine 3-D details or respective fragments (or the like local object components) arranged in the virtual space.

Further, the present invention has no special requirements for the shape of local object components because the 3-D optical image to be presented to the observer is composed of its associated individual spatial intensity (or amplitude) distributions of directional radiation rather than images of such components, as in the prior art. Thus, diverse sets of 3-D data relating to different computer models can be adapted to the format appropriate for representing the object according to the present invention. A plurality of surface points specified by their coordinates (see U.S. Pat. No. 4,498,740) or a set of micro polygons (see U.S. Pat. No. 5,400,155) could be suitable for such purpose. In the latter case, coordinates of the center of gravity of each micro polygon can be used to determine a position of one of such local object components.

Furthermore, the size of each local object component can be varied depending upon the complexity of the particular object and purposes of its representation. Thus, it can be established to be not exceeding that determined by the resolution limit of the unaided eyes. This condition is conventional for the prior art and can be applied for specifying (or selecting) data representing fragments of any surface area in the computer database. Meanwhile, any fragment could contain several surface points. If so, the optical characteristics and position of such fragment are specified in virtual space with respect to said reference system as being averaged accordingly over all of said surface points. The conventional condition can also be employed for specifying a number of local object components to be selected. This implies selecting data with a sampling density not below its value as determined by the resolution limit of unaided eyes. Such a condition is usually used to remove the visually perceivable discontinuities that, otherwise, could prevent clear observation of the 3-D optical image produced and create discomfort for the observer. It is employed, e.g. for selecting data (like those associated with 16 in FIG. 1) relating to local object components arranged on each face of pyramid 10. Such a conventional condition is applied unless the discontinuity between local object components is used to represent peculiarities in optical properties of the particular object. The same condition could be used if data representing the object composed of local components is intended for further transformations in the computer database to perform size scaling of this object in virtual space. Namely, after proportional changing of the positions of local object components in virtual space with respect to said reference system, their resulting positions are established to provide a distance between any two adjacent local object components that do not exceed such a distance as determined by the resolution limit of the unaided eyes. These examples indicate that, in general, the present invention has no peculiarities with respect to the prior art in features relating to the shape and size of local object components. Only their positions and spatial optical characteristics expressed by said unique specific representations themselves are essential for representing an object.

On the other hand, the possibility of using diverse presentations of the individual distribution of directional radiation associated with optical characteristics of each of the local object components and said conventional conditions demonstrates a flexibility of the proposed computer-assisted method and apparatus in specifying data representing any object in a computer database and in performing diverse modifications of this data for the purposes of visual applications in the mentioned fields. This is confirmed once more by the fact that the individual spatial intensity (or amplitude) distribution of directional radiation associated with optical characteristics of each of at least a number of local object components in the computer database can be specified in virtual space as being composed of constituent spatial intensity (or amplitude) distributions of directional radiation. Such as those symbolically designated in FIG. 2 by 20, 21 and 22 (shown by solid lines). Each of the constituent distributions 20, 21 and 22 originates from its associated local object component 23, extends in a direction of its maximum shown by the respective vector (not labelled in FIG. 2) and, thus, is oriented in said reference system along a different line. This line lies within a solid angle specified for its respective individual distribution of directional radiation as a whole (depicted as 24 by dashed line). Such presentation of the individual distribution of directional radiation associated with optical characteristics of each of said local object components provides a flexibility of diverse modifications of its shape and, therefore, a possibility of representing particular peculiarities in optical properties of each corresponding fine object detail or in optical characteristics of each corresponding separate surface fragment of the object. An angular width, a spatial direction of maximum and a radiation intensity (or amplitude) value in this direction of each constituent distribution as well as their number can be changed differently to achieve these purposes. So, when using such a presentation, the individual spatial intensity (or amplitude) distribution of directional radiation can be specified in virtual space by appropriate characteristics of directivity patterns relating each to one of said constituent spatial intensity (or amplitude) distributions of directional radiation (e.g., depicted by 20, 21 and 22) associated with the respective local object component (such as denoted by 23). Each directivity pattern has an origin at a position of this local object component and characteristics including an angular width, a spatial direction of maximum oriented along the respective line of that constituent distribution (e.g., depicted by 21) and a radiation intensity (or amplitude) value in this direction. For representing said particular peculiarities more realistically, e.g., by smoothing transitions between constituent distributions of directional radiation (like those depicted by 20, 21, 22), these distributions are specified with partial overlapping in virtual space. A more effective result is obtained when this is carried out for at least some of said local object components.

This presentation can be used, for example, in the embodiment of the present invention, wherein data representing the object in the computer database is divided into sections disposed in virtual space in the depth direction to be parallel with the reference plane of said reference system (similarly to depth planes Pⱼ₋₁, Pⱼ, Pⱼ₊₁ depicted in FIG. 2). For this reason, the number of local object components means those of the representative sample thereof that are arranged in one section. This may be useful for representing flat or shallow (in the depth direction) objects. If the use of at least two sections is required, said characteristics of the directivity pattern relating to each constituent distribution are specified so as to take into account that some of the fine details or respective fragments of any surface area of the object (or other local object components) arranged in one section may obscure details or fragments arranged in another section which are behind the former ones. This procedure can be carried out in a similar way to the well known hidden line and hidden surface area removal process by controlling the visibility of any given detail on any section from each of a plurality of viewpoints in the assigned field of view.

Another embodiment of the invention provides for also specifying the individual spatial intensity (or amplitude) distribution of directional radiation (such as depicted by 25) associated with optical characteristics of each (like 26) of at least a set of local object components in virtual space as being composed of constituent spatial intensity (or amplitude) distributions of directional radiation. But, in contrast to the previous presentation, each constituent distribution (not designated in FIG. 2 for simplicity) originates from its respective separate spot (like one of those denoted by symbols j₊₁, j₊₂, j₊₃, j₊₄) located on a different line, extending in a direction of its maximum shown by the respective vector (depicted by dash-and-dot lines) and, thereby, is oriented along this line in said reference system. Said line lies within a solid angle specified for its respective individual distribution of directional radiation as a whole (shown by 25) and extends through its associated local object component (denoted by point 26). Each spot can be located generally at any position along its respective line. It is preferable, however, that separate spots of origin of all constituent spatial intensity (or amplitude) distributions of directional radiation associated with the respective of such local object components specified in the computer database are located in one depth plane, each at a point of intersection of its respective line and the same plane (e.g., denoted by symbol Pⱼ₊₁). This turns out to be more suitable for reproducing individual directional radiation associated with such local object components, and so said depth plane is called a representative plane for such individual directional radiation. To carry out such a presentation, a plurality of depth planes is used in the virtual space containing the object (denoted by 2 in FIG. 2) and disposed therein in the depth direction to be parallel with a reference plane of said reference system. Each of these depth planes (like those denoted by symbols Pⱼ₋₁, Pⱼ, Pⱼ₊₁ or others depicted in FIG. 2) disposed at different distances from the reference plane (such as XOY) may be selected as the representative plane for individual directional radiation associated with any of such local object components. However, for more effective employment of such individual directional radiation, when being reproduced, it is expedient to select that of depth planes, in which this local object component is arranged itself (like 26 in the plane Pⱼ), or which being the nearest one to this local object component in the depth direction (such as denoted by symbol Pⱼ₋₁ or Pⱼ₊₁). Such a presentation indicates clearly that the present invention allows for composing the individual directional radiation from constituent distributions formed independently and originating from any position in the virtual space inside or outside of the object (like those pointed out by symbols j₊₁, j₊₂, j₊₃ and j₊₄ or by symbols j₋₁, j₋₂, j₋₃ and j₋₄ respectively). This is very important since the individual directional radiation associated with each of such local object components arranged in a zone nearby the representative plane (like one of the zones depicted in FIG. 3) could be reproduced without any mechanical movement of optical means (or techniques). Hence, capabilities of these means can be used more effectively as compared with those in the prior art where each of the depth plane images is reproduced separately (as in U.S. Pat. No. 5,907,312). Additionally, when viewing the reproduced individual directional radiation from different viewpoints in any of the segments of the assigned field of view (as denoted in FIG. 2 by points 27, brackets 28 and symbolical curve 29 respectively), the radiation itself reveals its individuality and definite spatial specificity. Thus, its variability appears when simply changing viewpoints in said field of view. Evidently, this comes about due to specifying such individual directional radiation with a respective spatial direction and respective solid angle. Meanwhile, if any of such local object components is arranged itself in the representative plane (like 26 in the plane Pⱼ) for its associated individual directional radiation (like 25), the position of said point of intersection corresponds to the position of this local object component itself in said representative plane (Pⱼ in FIG. 2) The above presentation of the individual directional radiation in virtual space is considered to be preferable and described below in detail with the reference to the drawing in FIG. 3. It is most useful when data representing the object (like object 2) in the computer database is divided into three-dimensional zones disposed in virtual space in the depth direction along the Z-axis of the reference system. While the virtual space has a plurality of depth planes (like those denoted by symbols P₁, P₂ and P₃) disposed therein in the depth direction they should as well be parallel with a reference plane (XOY, in this case) of said reference system. The zones are established so as to provide the placement in each of them one of the depth planes to be used as a representative plane (like, e.g., P₁) for individual directional radiation (such as depicted by 30) associated with each of such local object components arranged in the respective zone (like that denoted by 31 in Zone 1). To this end, a set of local object components means those of the representative sample thereof that are arranged in one zone. This may be useful for representing objects having a reduced size in the depth direction. Each of the representative planes can be disposed in any position within its respective zone, e.g., in the middle thereof as designated in FIG. 3. All constituent distributions (depicted by 32, 33, 34 and 35) composing the respective individual distributions of directional radiation (such as depicted by 30 and others not labeled) associated with such local object components arranged in one of the zones (denoted by 31, 36, 37, 38, and others not labeled in Zone 1) can originate from different positions on the representative plane (P₁ in Zone 1) both inside and outside of the object 2. Said positions are shown by bold spots in the representative planes (P₁, P₂ and P₃ in Zone 1, Zone 2 and Zone 3 respectively). But, some of them relating to different individual distributions of directional radiation (depicted by 30 and 39) can originate from closely spaced or even the same positions (such as labeled respectively by symbols j₁₁, j₁₂, j₁₃ and j₁₄ and by symbols j₂₁, j₁₁ and j₁₂ on the plane P₁). This further improves the effectiveness of using capabilities of available optical means (or techniques) and permits reproduction of such constituent distributions simultaneously. Meanwhile, each individual distribution of directional radiation (like 30) when reproduced in such a way appears to be emanating from a location coordinated with the position of its associated local object component (like 31) in virtual space, rather than from said spots in the 2-D representative plain. That is why an actual 3-D optical image of the respective zone (Zone 1) is produced that exhibits a natural perception of an object's depth and other 3-D aspects, rather than the sectional image as in the prior art. The difference becomes clearer in the employment of the representative plane and the 2-D projecting plane specified in the method disclosed by U.S. Pat. No. 5,852,504 and discussed above. In this method, 3-D data representing an object in virtual space is also divided into 3-D regions (zones) in the depth direction, and each zone has a 2-D plane parallel with a hologram forming surface. But, these planes are used for presenting depth images of the object.

While illustrative embodiments of the present invention relating to the diverse employment of the unique specific representation of said optical characteristics of each local object component have been described above, it is, of course, understood that various further modifications will be apparent to those of ordinary skill in the art. Thus, there are no restrictions, when using such a representation, in establishing positions of local object components (and, hence, the assumed location of the optical image) with respect to a surface of the recording medium in virtual space, like those restrictions in U.S. Pat. No. 5,475,511 and U.S. Pat. No. 5,793,503. In other words, this surface may be disposed in any position with respect to the object in virtual space and the reference plane, and may, in particular, pass through the object. So, image-plane or focused-image types of holograms can be formed to provide for viewing an optical image under white light illumination without the elimination of vertical parallax therein. This is very important for improving conditions of white-light viewing and has a definite advantage when compared to the prior art.

The present invention permits diverse embodiments of physically reproducing said individual spatial intensity (or amplitude) distribution of directional radiation associated with each of a representative sample of local object components to be used. One of them is based on reproducing the individual directional radiation as a whole. This embodiment provides for transforming a first coherent radiation beam by varying parameters of at least one part thereof to be used for reproducing directional radiation having variable optical parameters such as a solid angle, a spatial direction and an intensity (or amplitude) in this direction. Different variants of changing these optical parameters with respect to the coordinate system in the real world can be used to adequately display (and, therefore, represent) in them data relating to optical characteristics of any of said sample of local object components in the computer database and provide directional radiation thus reproduced to arise from a local region. Said data may be presented, for example, by appropriate characteristics of the respective directivity pattern. Particular values of said optical parameters of thus reproduced directional radiation are established so as to be coordinated with selected data relating to optical characteristics of the respective local object component.

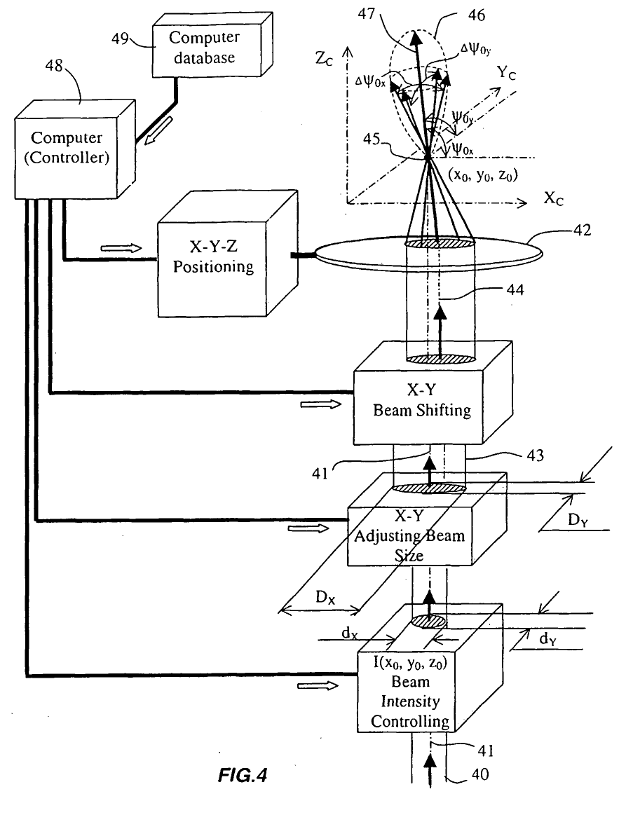

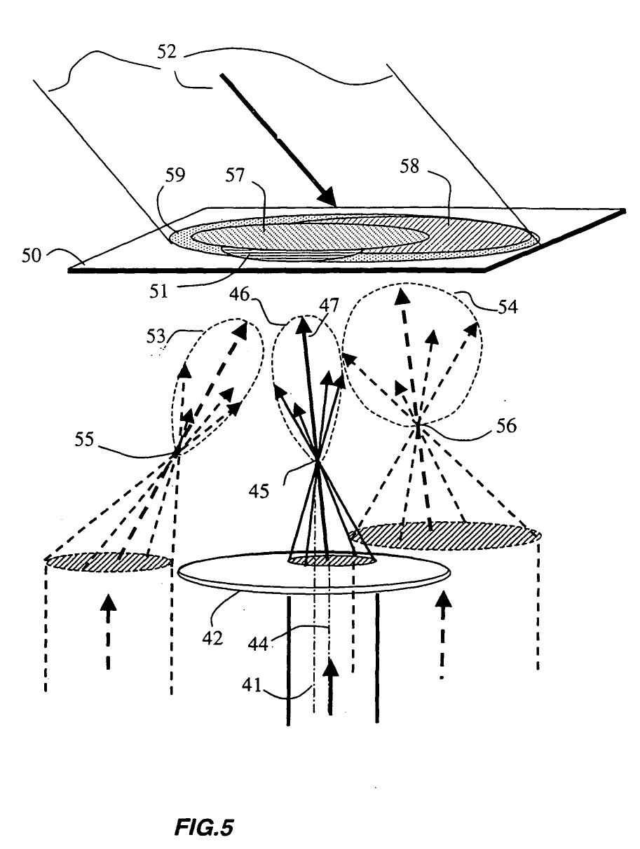

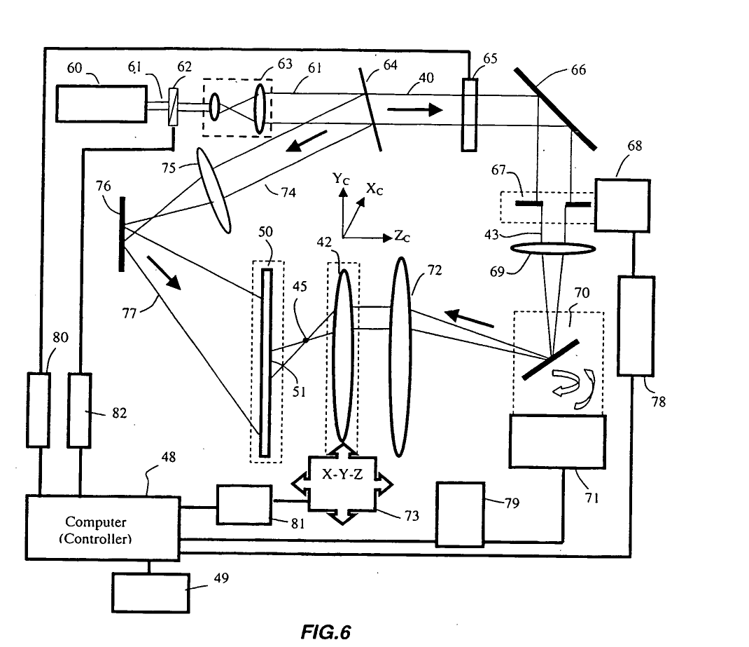

In one of said variants a first coherent radiation beam is transformed itself by varying parameters thereof for reproducing said directional radiation having variable optical parameters. The steps of this variant are illustrated with reference to FIG. 4. The coordinate system established in real space is associated with the recording medium and represented by X_{c}, Y_{c} and Z_{c} axes shown at the top right hand corner in FIG. 4. The Z_{c} axis is oriented in the depth direction perpendicularly to the flat surface of the medium (not shown in FIG. 4). The first coherent radiation beam 40 is controlled in the intensity of its radiation and oriented in said coordinate system to be along the axis 41 of an optical focusing system 42 represented by the lens having a fixed focal length. Beam 40 having the size dₓ and d_{y} in directions parallel to X_{c} and Y_{c} axes respectively is transformed by adjusting these sizes that become Dₓ and D_{y} in said directions. The thus transformed beam 43 is shifted as a whole, while retaining its axis 44 to be parallel with respect to axis 41 of optical focusing system 42. The resulting beam is focused into a focal spot 45 by optical focusing system 42 for providing directional radiation thus reproduced (symbolically depicted as diagram 46 shown by dashed line) to arise from spot 45 and extend in the direction of its maximum (pointed out by vector 47). This focal spot 45 is therefore the first type of said local region. Said steps of adjusting beam 40 in size, parallel shifting transformed beam 43 and controlling the intensity of radiation in beam 40 are handled by the computer (controller) 48 to represent accordingly variable optical parameters of directional radiation 46, namely: its solid angle, its spatial direction and an intensity in this direction. For establishing particular values of said optical parameters, computer 48 selects from computer database 49 data relating to optical characteristics of the respective local object component (e.g., angular width ••ₓ and ••_{y}, angles •ₓ and •_{y} of the individual directional radiation 18 associated with object component 12 shown in FIG. 1) and forms control signals to be used for carrying out said steps. These processes are symbolically depicted in FIG. 4 by hollow arrows. The same process is accomplished for establishing said local region (using coordinates (x, y, z) of object component 12) by carrying out the step of positioning (disclosed in detail below with reference to FIGS. 5 and 6). As a result, optical parameters of reproduced directional radiation 46, such as angular width ••₀ₓ and ••_{0y} determining its solid angle and angles •₀ₓ and •_{0y} determining its direction (along vector 47), turn out to be equal respectively to those of optical characteristics of local object component 12 or otherwise coordinated with selected data (e.g., when scaling of optical image is carried out). The procedure schematically illustrated in FIG. 4 provides for sequentially reproducing in light the individual spatial intensity (or amplitude) distribution of directional radiation associated with each of said sample of local object components. This procedure may be useful when forming a hologram of a simple or small object requiring not so many local components for its representation, or when forming holograms of directional radiation from at least some of the local components of any part of the object for testing a more complicated procedure, or for other purposes. Further details of this procedure are discussed below with reference to FIGS. 4 and 5 at the same time.

The local region (45) of arising of thus reproduced individual directional radiation (46) should be established with respect to said coordinate system associated with the recording medium (50) at a location (x₀, y₀, z₀) coordinated with the position of its associated local object component (12) in virtual space. This is carried out by positioning directional radiation 46 as a whole, maintaining its optical parameters, in three dimensions with respect to a surface of the recording medium 50 in accordance with selected data relating to the position of said local object component 12 (shown in FIG. 1) that is specified by coordinates (x, y, z). Said surface may be any of the surfaces of recording medium 50 made, e.g., as a flat layer, which is assigned as a base plane of said coordinate system. The step of positioning reproduced individual directional radiation 46 in three dimensions is carried out, for example, by moving its local region 45 together with optical focusing system 42 along its axis 41, i.e., along a normal to the surface of recording medium 50, to represent z data relating to the position of that local object component 12, while moving recording medium 50 perpendicularly to said surface normal to represent x and y data relating to said position. The step of positioning directional radiation 46 may be, of course, carried out differently. Namely, local region 45 of arising is moved perpendicularly to the normal to the surface of recording medium 50 by moving said optical focusing system 42 and correcting said beam shifting so as to retain the position of its axis 44 with respect to axis 41 and, hence, maintain optical parameters of directional radiation 46. This permits the representation of x and y data relating to the position of said local object component 12, while moving recording medium 50 along said surface normal allows the representation of z data relating to said position. The step of positioning thus reproduces individual directional radiation 46 as a whole and is handled by the computer (controller) 48 as mentioned hereinabove.

After having established the local region 45 of arising, individual directional radiation 46 directed to recording medium 50 is incident onto a corresponding area 51 thereof along with a reference beam 52 directed also onto area 51 so as to form therein a hologram portion storing said directional radiation 46. The reference beam can be produced by adjusting parameters of a second coherent radiation beam with respect to the coordinate system in accordance with selected data in different ways. In one of them, the step of adjusting the parameters can be accomplished by controlling an intensity (or amplitude) of radiation in the second coherent radiation beam and orienting it in an established direction, parallel shifting the second coherent radiation beam with respect to it itself and changing it in size. The last steps are made so that the reference beam thus produced forms an area (not shown in FIG. 5 for simplicity) in medium 50 and so provides complete coverage of the corresponding area 51 relating to the respective reproduced individual distribution of directional radiation 46.

The present invention has no peculiarities in specifying conditions relating to parameters of the reference beam such as its shape and size, an angle of its incidence or its orientation (its direction) with respect to said surface normal of the recording medium, and permits using conventional ways of changing these parameters. As shown in FIG. 5, the reference beam 52 arrives at the recording medium 50 from the direction opposite to that of arriving individual directional radiation 46, thereby forming a reflection hologram in area 51. When reference beam 52 comes onto the same surface of recording medium 50 as arriving individual directional radiation 46, a transmission type of hologram is formed in area 51.

Processes of establishing the local region of arising of reproduced individual directional radiation and its holographical recording are carried out sequentially for individual directional radiation associated with each of at least some of said sample of local object components. Individual distributions of directional radiation depicted by 53 and 54 in FIG. 5, which arise from respective local regions 55 and 56 and recorded sequentially in areas 57 and 58 of recording medium 50 after recording distribution of directional radiation 46, serve as an illustration to this embodiment of the present invention. In this embodiment the reference beam 52 is produced by adjusting parameters of the second coherent radiation beam in another way as shown in FIG. 5. Namely, this step is accomplished by controlling an intensity (or amplitude) of radiation in the second coherent radiation beam, orienting it in an established direction and changing the second coherent radiation beam in size so that reference beam 52 thus produced forms an assigned area 59 in recording medium 50 and, thereby, provides complete coverage of all said areas 51, 57 and 58. Hence, this way does not require the changing of parameters of the reference beam for recording each subsequent individual distribution of directional radiation, unlike that mentioned hereinabove. This comes about due to the fact that assigned area 59 is an entire area of recording medium 50 relating to a superimposed hologram in the case shown as the explanatory illustration in FIG. 5. Hologram portions created in areas 51, 57 and 58 are superimposed upon each other, while partially overlapping and, thus, integrated within the recording medium for forming together a superimposed hologram.

Variants of transforming the first coherent radiation beam other than those shown in FIG. 4 may be used as well for reproducing directional radiation having variable optical parameters. For example, one of them differs in that it provides for using an optical focusing system having a variable focal length (unlike focusing system 42 in FIG. 4) and adjusting its focal length (like zoom) in order to represent the solid angle of directional radiation to be reproduced. This variant as well as that shown in FIG. 4 may be used, of course, when employing instead only a part of the first coherent radiation beam. Moreover, in this case other variants can be used for reproducing directional radiation having variable optical parameters. Thus, one of them can be accomplished by orienting the first coherent radiation beam in said coordinate system along the axis of an optical focusing system, enlarging said radiation beam in size and thereafter selecting a part thereof to be used by variably restricting its cross-section. Remaining steps of this variant with respect to said part are carried out similarly to those having been used for the first coherent radiation beam itself in the variant shown in FIG. 4.

An apparatus for forming a hologram according to this embodiment of the present invention can employ conventional optical means (or techniques) similar to those in the prior art (see, e.g., U.S. Pat. No. 4,498,740) for carrying out diverse variants of this embodiment. One of structures of the relevant apparatus for forming the hologram is shown in FIG. 6.

In FIG. 6 a laser 60 generates a beam 61 of coherent radiation and directs it to and through sequentially disposed shutter 62 and beam expander 63, and therefrom to a beam splitter 64. Beam expander 63 contains telescopic lenses and, optionally, a pinhole (not shown in FIG. 6) placed essentially in the joint focus of telescopic lenses to clean up spurious (or extrinsic) light. From beam splitter 64 one portion of beam 61 is directed as a first coherent radiation beam 40 to and through a modulator 65 (for controlling its intensity) and to a first mirror 66 and then to a means 67 for adjusting beam 40 in size. Means 67 is made as a controlled two-dimensional diaphragm (or iris) and is driven by a motor 68. The transformed beam 43 passes to a lens 69 to focus the beam onto a two-dimensional deflector 70 made as an oscillatable mirror to be driven by an actuator 71 in both directions (shown by arrows) at right angles to each other. A deflector of this kind is commercially available. From deflector 70 the beam passes to and through a collimating lens 72 and to an optical focusing system 42 made as a movable lens. Said collimating lens 72 is intended to transform angular deflection of said beam into its parallel shifting with respect to an axis 41 of optical focusing system 42. The resulting beam is focused by the latter into a focal spot 45 and directed therefrom as an individual distribution of directional radiation thus reproduced (depicted by diagram 46 in FIG. 5) onto recording medium 50. Focusing system 42 is mounted on a coordinate drive 73 for moving in three dimensions and positioning reproduced individual directional radiation (46) as a whole to establish the local region of arising (focal spot 45) as described above. Every time while moving focusing system 42, deflection angles of said beam are properly corrected, if necessary, so as to retain its shifting with respect to axis 41 of focusing system 42 and, therefore, maintain optical parameters of reproduced individual directional radiation after said positioning. Such a coordinate drive is well known in the prior art. For carrying out said positioning in a wide range, a holder of recording medium 50 having a substrate could be mounted on another coordinate drive (not shown in FIG. 6) for moving recording medium 50 as well in two or three dimensions, if necessary, as has been described above.

The other portion of beam 61 is reflected by beam splitter 64 and becomes a second coherent radiation beam 74 directed to and through a lens 75 which focuses beam 74, and to a second mirror 76 which orients beam 74 in an established direction. From mirror 76 a reference beam 77 is produced to be divergent is directed to recording medium 50 to provide complete coverage of an assigned area (not labeled) thereof that is an entire area of recording medium 50 relating to a superimposed hologram to be formed. This illustrates a possibility of using a divergent reference beam 77 (or even convergent) instead of collimated (like beam 52) as shown in FIG. 5.

A computer 48 is employed as a control center for the proposed apparatus for forming a hologram (a holographic printer). Computer 48 is preprogrammed for forming control signals in accordance with data selected from computer database 49 and directing these signals through interfaces 78, 79, 80, 81 and 82 to control inputs respectively of motor 68, actuator 71, modulator 65, coordinate drive 73 and shutter 62 to coordinate properly their operation. This permits the reproduction of said individual directional radiation and establishment of optical parameters thereof by adjusting beam 40 in size, parallel shifting transformed beam 43 and controlling the intensity of radiation in beam 40, establishing local region 45 of arising of individual directional radiation thus reproduced and specifying time for exposing recording medium 50, thereto together with divergent reference beam 77 for holographically recording said reproduced individual directional radiation.

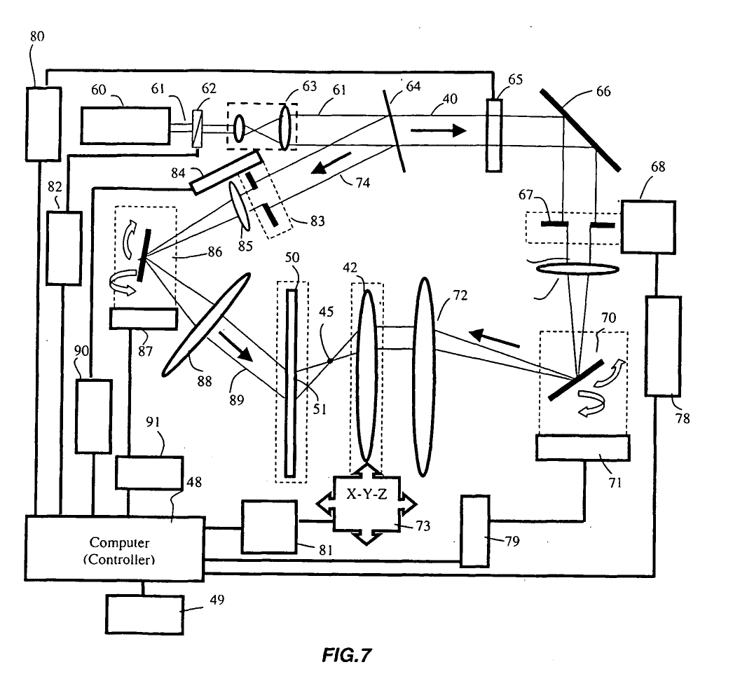

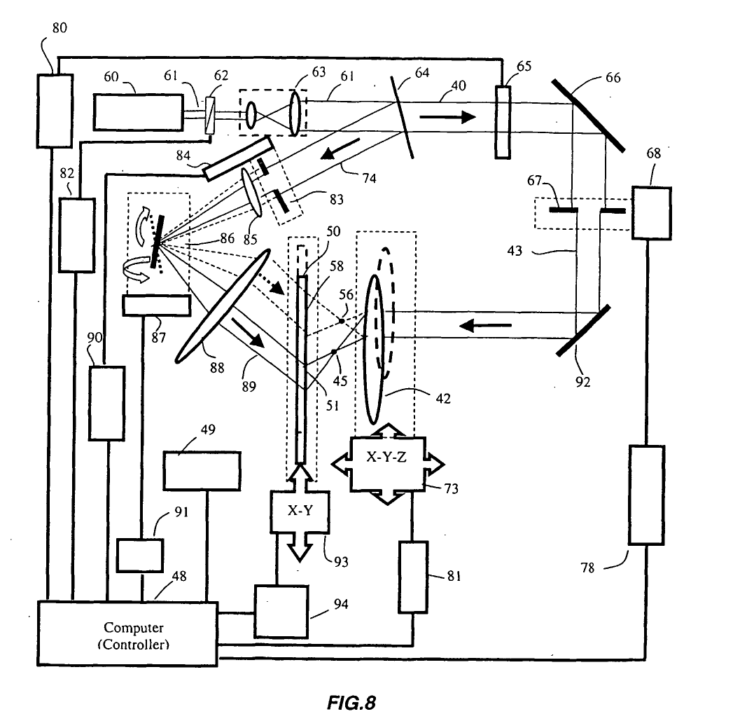

Diverse modifications in structure of the apparatus for forming the hologram can be performed according to said embodiment of the present invention. Thus, for adjusting parameters of second coherent radiation beam 74 an ensemble of means 83 being driven by a motor 84 for adjusting this beam in size, a focusing lens 85, a two-dimensional deflector 86 made as an oscillatable mirror to be driven by an actuator 87 in directions (depicted by arrows) at right angles to each other and a collimating lens 88 could be used (see FIG. 7). Said ensemble of optical means is similar to that used for transforming first coherent radiation beam 40 and intended for changing beam 74 in size, parallel shifting it with respect to itself (and axis of collimating lens 88) and orienting it in an established direction to provide complete coverage by the reference beam 89 thus produced, of a corresponding area (51) of recording medium 50. Area 51 relates to the respective reproduced individual distribution of directional radiation (such as 46 in FIG. 5). Reference beam 89 collimated in this variant forms an area about the size of the corresponding area of individual directional radiation in medium 50. Parameters of reference beam 89 should be changed when recording each subsequent individual distribution of directional radiation (53 or 54 in FIG. 5) in order to cover a corresponding area (57 or 58). This is performed (as for beam 40) by computer 48 forming respective control signals in accordance with data selected from computer database 49 and directing these signals through interfaces 90 and 91 respectively to control inputs of motor 84 and actuator 87. The software associated with producing such control signals is well known in the art and forms no part of the present invention. A modulator (like 65) may be employed as well for controlling beam 74 in its radiation intensity separately, when necessary.

The same ensemble of optical means (as shown in FIG. 7) is used in one more structure of the apparatus for forming the hologram (see FIG. 8) for adjusting parameters of second coherent radiation beam 74. But, optical means (or techniques) for transforming first coherent radiation beam 40 are simplified. Thus, unlike as shown in FIGS. 6 and 7, transformed beam 43 is directed to a third mirror 92, and a reflected beam is retained in an unchanged position in the coordinate system. In this case, the spatial direction of said reproduced individual directional radiation 46 is established by only moving optical focusing system 42 in X and Y directions with coordinate drive 73, thus changing the position of axis 41 with respect to said reflected beam. By contrast, positioning reproduced individual directional radiation 46 as a whole is carried out by moving its local region 45 together with optical focusing system 42 along axis 41 to represent z data relating to the position of local object component 12. To represent x and y data relating to its position, recording medium 50 is moved in X and Y directions, i.e., perpendicularly to its surface normal. For positioning directional radiation 46 in such a way, the holder of recording medium 50 having a substrate is mounted on another coordinate drive 93 for moving recording medium 50 in said two dimensions. Coordinate drive 93 is handled by computer 48 through an interface 94. When recording each subsequent individual distribution of directional radiation (like 54 in FIG. 5), computer 48 forms respective control signals and directs them through interfaces 81 and 94 respectively to control inputs of drive 73 and drive 93. As a result of the coordinated movements of optical focusing system 42 and recording medium 50 to their new locations (shown by dashed lines in FIG. 8) a local region 56 of arising of directional radiation 54 is established. Parameters of reference beam 89 are changed in a similar way to that described with reference to FIG. 7 for covering a corresponding area 58. Its new position is shown by dashed lines.

Thus, different variants of transforming the first coherent radiation beam in the coordinate system by varying parameters of at least one part thereof to be used for reproducing directional radiation having variable optical parameters, such as a solid angle, a spatial direction and an intensity (or amplitude) in this direction, and arising from a local region are described above, including those in FIGS. 6-8. A diversity of variants makes clear that essential are functions and capabilities of respective means in a structure of the proposed apparatus, rather than the particular implementation of any of said means. Actually, it is essential that said means handled by the computer in accordance with selected data provide reproducing individual directional radiation associated with any of said local object components in the computer database simply by changing said optical parameters and establishing their particular values relating to the respective of local object components. Meanwhile, it doesn't matter how any of optical parameters is changed and what type of optical means is used for that. To this reason, known procedures (or ways) and conventional optical means could be used for changing said optical parameters within the scope of the present invention. It is, of course, understood that various further modifications in the structure of the proposed apparatus will be apparent to those of ordinary skill in the art. On the other hand, it is not intended that the invention be limited thereto, because the essence thereof is associated not with one or some of said procedures or conventional means, but with all of them to be combined for reproducing individual directional radiation. This implies that performance capabilities of combined means allow establishing the local region of arising thus reproduced individual directional radiation and its optical parameters so as to be coordinated with said selected data and directing reproduced individual directional radiation onto a corresponding area of the recording medium. Conditions of using combined means have also peculiarities consisting in providing a coordination of optical parameters of reproduced individual directional radiation with spatial optical characteristics of its associated local object component. Besides, each of said reproduced individual directional radiation is intended for holographic recording, rather than for its viewing by the viewer, separately or in groups, in this stage. Such circumstances pay attention to the definite relationship existing between optical, computational and recording means in the proposed apparatus. Peculiarities in capabilities of said combined means and conditions of using them make clear that optical means (techniques) are used in the proposed apparatus for optically retaining individuality and definite spatial specificity of optical characteristics in reproduced individual directional radiation, independently and individually for each local object component. The fact that the procedure itself of retaining such 3-D aspects is carried out with optical means (in contrast to that in the prior art) is emphasized by using the term “optically” or, in general,—“physically”. While a relation between reproduced individual directional radiation and spatial optical characteristics is emphasized by employing a term “reproducing” in definition of the function of combined means, instead of “producing”. Such circumstances, thereby, permit displaying what kind of simulation of optical properties of the object in the virtual space is employed and demonstrating importance of the coordination for retaining individuality and definite spatial specificity of said optical characteristics in the real world and for appearing required 3-D aspects in an optical image to be produced, as discussed in Summary. Therefore, said function and capabilities of combined means as well as peculiarities in conditions of using them in the proposed apparatus are important for providing said coordination and improving conditions of the observation and perception of the 3-D optical image to be produced. That is why, they should be taken into account as essential, according to the present invention, for appearing all 3-D aspects in said optical image and attaining other purposes of visual applications in mentioned fields.

Said circumstances are unlike to that in the prior art. Actually, none of known apparatus provides for synthesizing individual directional radiation independently and individually for each of local object components for retaining individuality and definite spatial specificity of its optical characteristics in thus reproduced radiation and for preserving their 3-D aspects in the respective hologram portion. Thus, there are no means for individually establishing a solid angle of a radiation beam to be transformed and independently setting its spatial direction in the apparatus disclosed in U.S. Pat. No. 4,498,740 (see FIG. 1). Because of that, this apparatus is able to present x, y, z data relating to surface points of the object when rendering visual information stored in a hologram, but fails to create individual directional radiation. That is why, 3-D aspects in said visual information are provided with computational means. The same situation is in known apparatus disclosed in U.S. Pat. No. 3,698,787 and U.S. Pat. No. 4,655,539, wherein furthermore, a distribution of diverging radiation or a light beam expanding from a point respectively is formed by similar diffuse means that makes optical parameters thereof to be unchanged for all points used. It is also to be taken into account that both said diverging radiation and the expanding light beam should be considered as undirected, due to scattering light by conventional diffuse means in all directions (see, U.S. Pat. No. 5,907,312). And so, known apparatus have restricted functional capabilities that consist in providing only images of discrete points of light to be presented to a viewer in sectional images for further transforming them into a 3-D mental image, in which its rear side or hidden surface areas being visible. Optical means employed in U.S. Pat. No. 5,907,312 are able, in general, to overcome such a principal drawback and form any spatial intensity distribution of diffracted radiation by selecting a proper bundle of rays to be oriented in required directions. It allows eliminating hidden areas from appearing in the optical image. But, distributions of diffracted radiation in known apparatus are intended for viewing only, namely, for viewing depth plane images sequentially presented to the viewer. If so, 3-D aspects in diffracted radiation could not be retained in the optical image created in the viewer's mind because of losing them in each 2-D image perceived by the viewer. That is why, computational means should be used for recreating some of 3-D aspects that places an excessive burden thereupon because of a redundancy in information to be processed, as discussed in the Background and provides, hence, unfavorable conditions of using computational means in known apparatus.

Hence, only computational means in the structure of known apparatus turn out to be responsible for providing 3-D aspects in the obtainable image irrespective of peculiarities in conditions of using said means in Display Holography or in Imaging Techniques. Other means are used for recording or displaying results of calculations respectively so as to present proper visual information to the viewer. This is caused by employing concepts of presenting 2-D or 1-D images to the viewer in known methods and apparatus, such as sectional images and images of perspective views of the object, or images representing its surface points. Thus, it is impossible to use functions and capabilities of other means for providing 3-D aspects in the obtainable optical image until using these concepts. In other wards, this predetermines using computational means for recreating some of 3-D aspects in the viewer's mind. The employment of the term “recreating” emphasizes this circumstance. On the other hand, the fact that all 3-D aspects are lost in each of 2-D images to be presented to the viewer requires the complicated and difficult visual work for creating an illusion or impression of a 3-D mental image exhibiting some of 3-D aspects.

The situation is not changed, when recording means having a holographic recording medium are employed in the structure of known apparatus, because they are intended for storing and collecting what to be presented to the viewer. If storing 2-D or 1-D images in the hologram as respective representations where 3-D aspects being lost that nothing remains but to change concepts themselves. This confirms so the fact that capabilities of recording means in Display Holography and, specifically, the very hologram capabilities are incompletely and ineffectively employed because of lacking 3-D aspects in the holographic record. That is why recording means fail improving conditions of the observation and perception of the obtainable optical image. Moreover, the presentation of sectional images causes definite difficulties in transforming them into a single 3-D mental image as in Display Holography because their 2-D representations in a hologram are rendered simultaneously. That is why in practice, a common viewer not skilled in mental integration usually watches a set of separate sectional images, rather than a single 3-D image. This is discussed in detail in the Background with reference to U.S. Pat. No. 5,117,296, U.S. Pat. No. 5,227,898 and U.S. Pat. No. 5,592,313.

A quite other situation is in the proposed apparatus that provides appearing all required 3-D aspects in an optical image to be produced but not by way of recreating them with computational means. This is explained by the fact that combined means create distinctive conditions of using recording means and, in particular, conditions for forming a hologram. It takes place because 3-D aspects in optical characteristics of each of local object components are retained individually and independently by combined means in one of respective reproduced individual directional radiation to be recorded holographically. As a result, representations that had never been used in the prior art are stored in hologram portions. Actually, each and every representation is the respective individual spatial intensity (or amplitude) distribution of directional radiation revealing itself individuality and definite spatial specificity in the assigned field of view, when rendering the hologram. And a term “three-dimensional” used in respect of each representation emphasizes such an essential peculiarity thereof, if it is necessary for comparing with 2-D (1-D) representations stored in the hologram in Display Holography. Furthermore, each 3-D representation stored in the respective of hologram portions is individual one, as it embodies spatial optical characteristics in respective individual directional radiation and preserves 3-D aspects inherent to them. Said peculiarities signify that optical characteristics of that local component could be perceived when viewing its associated rendered radiation from different viewpoints within a respective solid angle. Said peculiarities signify as well that the viewer, when changing viewpoints in three dimensions, will watch that local object component without any interruptions until the viewer's eye is positioned within said solid angle. And so, there is no necessity, as in known apparatus, in searching and visually selecting said local object component among others in different 2-D images when perceiving its optical properties from a number of viewpoints. That is why, the actual optical image composed of individual distributions of directional radiation exhibits all required 3-D aspects preserved due to storing said 3-D representations in all of hologram portions. Further, the actual 3-D optical image exhibits full parallax by affording the viewer a full range of viewpoints of this image from every angle, both horizontal and vertical and so has no restrictions in dimensionality. Hence, said peculiarities display the importance of 3-D representations themselves for improving conditions of the observation and perception of what to be presented to the viewer. Meanwhile, said peculiarities of 3-D representations and advantages of using them are evidence of the fact that the hologram capability of preserving 3-D aspects of the obtainable optical image are employed completely and effectively in the proposed apparatus, in contrast to that in the prior art. Besides, conditions for forming a hologram and especially what to be stored therein become essential for appearing all required 3-D aspects in the obtainable optical image, in contrast to that in Display Holography. Therefore, peculiarities and advantages of using 3-D representations show essential distinctions in conditions of using recording means in the proposed apparatus and in their capabilities of providing 3-D aspects.

Apart from 3-D aspects preserved in the individual distribution of directional radiation stored as one of 3-D representations, there are other 3-D aspects associated with combining said individual distributions of directional radiation with each other when composing the optical image. This is caused by integrating hologram portions in the recording medium by at least partial superimposing some of them upon each other for forming together a superimposed hologram. The relative arrangement of hologram portions in the recording medium determines peculiarities in combining rendered individual distributions of directional radiation that are very important for perceiving variability in optical properties of fine details or in optical characteristics of separate surface fragments of the object. Said peculiarities depend not only on the spatial direction and solid angle of each of individual distributions, but also on the relative orientation of at least some of them and on relative locations of local regions of arising them. The latter should be coordinated with positions of respective fine details or surface fragments of the object. That is why, said peculiarities are an integral part of conditions for forming the hologram and one more example of using its capability for preserving 3-D aspects of the obtainable optical image. And so, they are an integral part of conditions of using recording means in the proposed apparatus and capabilities thereof, in general. Peculiarities in combining individual distributions are appeared while viewing said 3-D image, observing its right-to-left aspects and top-to-bottom aspects as well as changing an observation distance for perceiving its variability at different perspectives and understanding a depth of the object. Variability in optical properties of its details or in optical characteristics of its surface fragments reveals itself when changing viewpoints in the field of view. Such variability signifies, e.g., that the movement of the viewer in any direction will show the relative displacement of details or fragments in the image in the same direction. Such variability signifies as well that the 3-D optical image produced, depending on the viewpoint, will show certain details or fragments and will obscure other details or fragments because they are behind the former ones. Therefore, this mechanism of perceiving variability and a depth of the object while viewing its details or fragments in the actual optical image looks like that in the real world. Such results of using 3-D representations and the hologram capability itself are very important and could be obtained by specifying optical characteristics of local object components in a proper manner taking into account said peculiarities in combining individual distributions of directional radiation. Such explanations are only some illustrations of the fact that conditions of using recording means in the proposed apparatus and their capabilities in preserving all 3-D aspects provide far favorable and comfortable conditions for the observation and perception of the optical image to be produced as compared with those in known apparatus.

Actually, images of all details or surface fragments arranged in each object section are presented by known apparatus in Imaging Techniques (see, U.S. Pat. No. 5,907,312) so as to watch all of them in one of 2-D images. Variability in optical properties of said details or fragments could be perceived only, if viewing different 2-D images from respective viewpoints. Meanwhile, 2-D images are presented separately, each at precise moment of time, and sequentially, one after the other, and intended in fact for viewing from one viewpoint. Otherwise it is difficult to keep in mind 2-D images themselves for their mental transformation into the meaningful and understandable 3-D image. And on the contrary, if images of some details or fragments are captured in 2-D images from different viewpoints, the entire 3-D mental image could not be perceived at all. The plausible reason of such a result is the fact that for perceiving optical properties of any of them from respective viewpoints, 2-D images should be changed when changing viewpoints. And so, the viewer has no sufficient time for perceiving entirely all required 2-D images when searching and visually selecting in each of them any detail or fragment of interest for perceiving its optical properties from all viewpoints. Besides, a complicated and difficult visual work should be done by the viewer for perceiving variability or other peculiarities in optical properties of said details or fragments while creating the 3-D mental image. Apart from this, 2-D images are presented in the process of the movement of optical means together with the flat screen that requires means for synchronizing said process with the procedure of presenting 2-D images, as discussed hereinabove.

Neither the moving flat screen nor such synchronization means is necessary in the proposed apparatus, as a 3-D optical image is produced as a whole (entirely) and at once by rendering the hologram. Besides, no complicated or difficult visual work is required when viewing an actual 3-D optical image, rather than an impression or illusion of a 3-D image in the viewer's mind as in U.S. Pat. No. 5,907,312. This is explained by the fact that peculiarities in spatial optical properties of any details or fragments of an object in the proposed apparatus could be perceived visually while viewing them from all viewpoints they are visible, but not mentally as in the known apparatus. Further, details or fragments are presented all together in the actual optical image that provides viewing each of them separately or in combination with others without misgivings of losing the entire optical image and without restrictions in time for perceiving peculiarities in its (or their) optical properties. This is one more evidence of improving conditions for the observation and perception of the 3-D optical image due to employing 3-D representations in recording means of the proposed apparatus.

It is worth remembering that the fact of storing images of different perspective views of the object as its stereoscopic representation in the composite hologram fails to compensate the loss of 3-D aspects in each of these 2-D images. The requirement of providing them as disparate images, when presenting every time to one eye an image of a slightly different view than that presented to another eye, creates a hard condition for viewing the 3-D mental image. This is caused by a mismatch between position of said 3-D mental image and that of focal surface of both eyes. The visual work for removing such a mismatch places an additional strain on the human visual system causing weariness and eye fatigue. These circumstances are discussed in the Background with reference to U.S. Pat. No. 3,832,027, U.S. Pat. No. 4,834,476 and U.S. Pat. No. 5,748,347 along with other problems (limitations in image resolution and dimensionality, redundancy in image information).

None of said problems has the proposed apparatus that is caused by essential distinctions in conditions of using its optical and recording means as compared with known apparatus. On the other hand, this confirms advantages resulting from storing 3-D representations for preserving 3-D aspects of the optical image to be produced, instead of storing said 2-D images as 2-D representations. Besides, none of known apparatus employs capabilities of recording means in preserving 3-D aspects for affording the viewer a full range of viewpoints of the 3-D optical image from every angle, both horizontal and vertical, and improving other conditions of its observation and perception. That is why, conditions of using recording means in the proposed apparatus and, in particular, what to be stored in a hologram, and their capabilities should be taken into account as essential for attaining purposes of visual applications of the hologram(s) in mentioned fields.

Evidently, that the function and conditions of using computational means in the proposed apparatus are significantly changed as well. There is no a necessity to provide 3-D aspects in an obtainable optical image by calculating from 3-D data and processing a great deal of 2-D images of different perspective views of the object or its sectional images, as in Display Holography or Imaging Techniques. It is quite clear to those who skilled in the art that the employment of these concepts provides a considerable increase in a redundancy of information to be processed and in an information content of the hologram and, thereby, creates unfavorable conditions of using computational means. This is caused by the fact that each detail or fragment of the object should be presented in different 2-D images to be viewed from respective directions (or viewpoints) for providing 3-D aspects in its optical characteristics. That is why, a large amount of time for processing 2-D images by computational means and time for updating optical means displaying said 2-D images are limiting factors in known apparatus (see, e.g., U.S. Pat. No. 5,748,347 and U.S. Pat. No. 5,592,313). According to the present invention, it is more expedient, that computational means could be used instead for storing 3-D data relating to spatial optical characteristics and a position of each of local object components individually and independently and selecting this data directly. Said optical characteristics are associated with individual directional radiation extending from that local component in its respective spatial direction and in its respective solid angle. Said data or information is complete and exhaustive for reproducing directional radiation because its optical parameters could be established by employing capabilities of said optical means so as to be coordinated with optical characteristics of any of local object components. Hence, in particular, only data relating to said optical characteristics specified in the virtual space is required to be stored in the computer database, instead of said 2-D images themselves, as in known apparatus. Thus, this is evidence of the significant change in conditions of using computational means. An amount of calculations and computer processing time or memory for storing data processing could thereby be greatly reduced with respect to that in the prior art, as discussed in the Summary. Apart from this, a redundancy in information to be processed is avoided at all. In other words, favorable conditions of using computational means are thus created. This implies that computational means are used for storing and selecting said data relating to each local object component as well as for forming control signals in accordance with selected data to provide handling optical and recording means in their operation. As a result, the individual spatial intensity (or amplitude) distribution of directional radiation is reproduced by optical means and recorded in the respective portion of the hologram by recording means as said 3-D representation. Hence, 3-D aspects of said optical characteristics of that local object component are preserved individually and independently in their 3-D representation stored in the hologram.

This is unlike to that in the prior art, where computational means is used for providing 3-D data resulting from the computer model concerning an illumination of the object and reflection or transmission properties in each of its selected points (see, e.g., U.S. Pat. No. 4,778,262 and U.S. Pat. No. 4,969,700). However, this data is employed in numerous calculations wherein said optical properties in all object points “visible” from each of hologram elements should be taken into account for synthesizing said element. This results in increasing considerably a redundancy in information to be processed and in an information content of a computer-generated hologram. Such redundancy is arisen from both representations of each point in numerous hologram elements and high resolution requirements in conditions for forming a hologram, as discussed in the Background. That is why, such redundancy creates unfavorable conditions of using computational means and requires imposing a restriction on dimensionality of the obtainable 3-D optical image rendered without vertical parallax. Apart from this, a resolution of the 3-D optical image is limited to meet high resolution requirements to the size of hologram elements. The proposed apparatus has no such limitations.

The comparative analysis made shows, hence, how different are conditions of using computational, optical and recording means, their functions and capabilities in the proposed and known apparatus. Said analysis displays also how different is an effect of said conditions, functions and capabilities on conditions for the observation and perception of an optical image to be produced in the proposed and known apparatus. Said analysis demonstrates that the result of such effect depend mainly on what to be presented to the viewer. On the other hand, the analysis gives evidence of the fact that advantages of employing said means in the proposed apparatus could be attained when all of said means are participated in providing 3-D aspects of the obtainable optical image, in contrast to that in the prior art.

The participation or share of each means in the proposed apparatus in respect of providing 3-D aspects becomes clearer if combining means shown in FIGS. 6-8 or the like. If the latter means are combined in the manner shown above or exemplified below, essential functions, capabilities of all participating means and conditions of using them would appear more apparently. Besides, some illustrations are obtained in this way that show how known means and procedures could be employed in each of participating means. It is, of course, understood that such means and procedures are presented for the explanation only, and further modifications in the structure of each participating means will be apparent to those of ordinary skill in the art. On the other hand, it is not intended that the present invention be limited thereto, because the essence thereof is associated not with one or some of said procedures or means, but with those resulting from combining them that are defined in appended claims.

Thus, means for providing a first and a second coherent radiation beams include laser 60 and disposed sequentially along its axis a shutter 62, beam expander 63 and a beam splitter 64. Said means have two optical outputs for providing said beams 40 and 74 and control input connected through interface 82 to computer 48.

Means for transforming the first coherent radiation beam comprise modulator 65 for controlling radiation intensity, mirror 66, means 67 driven by motor 68 for adjusting beam 40 in size, lens 69, two-dimensional deflector 70 driven by actuator 71, collimating lens 72 and an optical focusing system made as a movable lens 42 (see FIGS. 6-7). The resulting beam is focused by the latter into focal spot 45 and directed therefrom as individual distribution of directional radiation thus reproduced onto recording medium 50. Said means for transforming the first coherent radiation beam have optical input coupled with splitter 64, optical output and control inputs connected through interfaces 78, 79, and 80 to computer 48 for receiving control signals therefrom.

Means for establishing the local region of arising thus reproduced individual directional radiation (45) are combined with preceding ones and made as means for positioning this individual directional radiation as a whole in three dimensions in the coordinate system and directing this directional radiation onto a corresponding area of the recording medium 50. Said positioning of individual directional radiation is carried out by mounting focusing system 42 on coordinate drive 73 for moving local region 45 with respect to a surface of recording medium 50 in accordance with selected x, y, z data relating to the position of its associated local object component in a virtual space. If positioning in a wider range is necessary, a holder of recording medium 50 having a substrate is mounted in recording means on other coordinate drive 93 (see FIG. 8) for moving recording medium 50 in two (x and y) dimensions. Said means are provided with control inputs connected through interfaces 81 (and 94) to computer 48.

Means for adjusting parameters of the second coherent radiation beam (FIG. 7, 8) include means 83 driven by motor 84 for adjusting beam 74 in size, focusing lens 85, two-dimensional deflector 86 driven by actuator 87 and collimating lens 88. Said means have optical input coupled with splitter 64, optical output and control inputs connected through interfaces 90, 91 to computer 48 for receiving respective control signals therefrom.

According to one embodiment of the present invention, individual directional radiation associated with optical characteristics of each of a representative sample of local object components is reproduced sequentially for recording in the respective of hologram portions. So, a material like dichromated gelatin having a large dynamic range or the like is required for recording medium 50. Meanwhile, a thermoplastic medium or a photopolymer could also be used to produce high-efficiency, near-real-time, phase holograms without the requirement for wet process. Following multiple exposure of all thus reproduced individual distributions of directional radiation, the recording material is rapidly developed by the heating process for the thermoplastic medium or through an ultra-violet bath for the photopolymer. Thus, medium 50 has no peculiarities in employing recording materials or their development procedures.

After each exposure of recording medium 50, said means for transforming the first coherent radiation beam, means for establishing the local region of arising thus reproduced individual directional radiation and means for adjusting parameters of the second coherent radiation beam are handled by computer 48 in accordance with data selected from database 49 for reproducing next individual directional radiation and recording it in the respective hologram portion. This hologram portion is at least partly superimposed onto preceding portions recorded in medium 50 of recording means. Each exposure is made by using shutter 62 in means for providing a first and a second coherent radiation beams. An actual 3-D optical image produced when illuminating a superimposed hologram has a complete dimensionality and exhibits all required 3-D aspects in the field of view assigned in a range of about 20° to about 90° that is usual in conventional holographic practice, or beyond this range.

It is convenient for comparing with the prior art to keep on combining means so as to consider the proposed apparatus as comprising the following ones:
computational means including a computer database having 3-D data relating to a position of each of local object components and its spatial optical characteristics associated with an individual distribution of directional radiation extending from that local object component in its respective spatial direction and in its respective solid angle and lying within an assigned field of view of the optical image to be produced and a computer for selecting data relating to said local object component separately from the database and for handling (or controlling) other means of the apparatus in their operation, when necessary, in accordance with selected data;
means for reproducing said individual directional radiation, including means for providing • first coherent radiation beam, means for transforming the first coherent radiation beam and means for establishing the local region of arising individual directional radiation thus reproduced; and
means for holographic recording said reproduced individual directional radiation, including recording means provided with a holographic recording medium, means for providing • second coherent radiation beam and means for adjusting parameters of the second coherent radiation beam.

An actual 3-D optical image is produced from individual distributions of directional radiation stored in all hologram portions as 3-D representations and rendered, when illuminating the superimposed hologram. The proposed apparatus could comprise also transmission means for on-line communication or transmission of selected data as proper one to remote users, when it is required to form a hologram.

Therefore, in particular, the participation of computational means in providing 3-D aspects of the optical image consists in specifying said optical characteristics with 3-D aspects inherent to them. Means for reproducing individual directional radiation or other optical means having the function and capabilities thereof are used for independently retaining 3-D aspects of said optical characteristics in reproduced individual directional radiation. While means for holographic recording reproduced individual directional radiation are used for preserving 3-D aspects of said optical characteristics in their 3-D representation stored in one of hologram portions. Hence, the present invention proposes a different way in providing 3-D aspects appearing in the obtainable optical image as compared with that in the prior art. This is a way of sharing a responsibility in providing 3-D aspects with all participating means in the proposed apparatus that is alternative to that using computational means only, as in known apparatus. In other words, this is the way of preserving 3-D aspects specified initially by computational means for simulating spatial optical properties of an object in the virtual space, rather than recreating some of 3-D aspects after losing them in any of preceding steps of the known way.

The implementation of the proposed way turns out to be possible because of selecting the share of each participating means that permit using their capabilities for what they doing best in this respect. Besides, it is very important that capabilities of one of means participating in this way determine conditions of using other means so that capabilities of said other means could be used most effectively for providing their step in preserving 3-D aspects of the obtainable optical image.

Thus, capabilities of computational means and optical means create conditions of using recording means so that the very hologram capabilities in preserving 3-D aspects are employed completely and effectively when holographic recording a 3-D representation of spatial optical characteristics of each local object component. And vice versa, functions and capabilities of said optical means and recording means in retaining 3-D aspects and preserving them in said 3-D representation respectively permit employing capabilities of computational means for storing and selecting data containing 3-D aspects without a redundancy in information to be processed. These examples may be continued, but it becomes quite clear that this way provides said conditions of using all means to be coordinated with each other in a best manner for preserving 3-D aspects of the obtainable optical image. That is why, the proposed way of preserving 3-D aspects is, in essence, a base of the coordination of conditions of using participating means for facilitating the viewer's visual work and improving other conditions of the observation and perception of the 3-D optical image. This explains also why the proposed said complex of concepts provides the coordination of said conditions in such a manner that said and other significant advantages over those employed in the prior art are attained, as discussed above in the Summary.

It will be apparent to those of ordinary skill in the art that the coordination of conditions of using said means may be accomplished differently depending on the particular means and procedures used in the structure of each participating means and on specific purposes of said visual applications. Meanwhile such coordination, irrespective of a variety of its implementation, provides anyway preserving 3-D aspects of an obtainable optical image. This comes about due to using individual directional radiation in the operation of each of participating means for carrying the respective of steps in the proposed way. Actually, directional radiation is employed in the operation of the proposed apparatus, according to the present invention, when:
specifying spatial optical characteristics of each of local object components by computational means, using their unique specific representation in the virtual space;
retaining 3-D aspects of optical characteristics individually and independently for said local object component by optical means;
preserving individual 3-D aspects of said optical characteristics in the respective of 3-D representations stored by recording means in one of hologram portions.

Each step is a particular share or participation of one of said means in the way of preserving 3-D aspects of the obtainable optical image in the proposed apparatus. It is quite clear from above discussions that each of steps in this way is essential and all of them are necessary for providing the coordination of conditions of using all of participating means, because in absence of any of them such a coordination becomes impossible. Therefore, this way consists briefly in specifying individual 3-D aspects computationally, retaining them optically and then preserving them holographically. While each and every individual directional radiation employed in the operation of one of participating means serves as a carrier of individual 3-D aspects. Hence, this is evidence of the fact that individual directional radiation is, in essence, a tool of the coordination of conditions of using participating means in the proposed apparatus for attaining purposes of visual applications in mentioned fields.

An outstanding result of such coordination consists in that it provides solving (or avoiding) principal problems of the prior art while improving conditions for the observation and perception of an optical image, in contrast to that in the prior art.

Thus, known methods and apparatus in Display Holography or 3-D Imaging Techniques, Computer Aided Holography or Computer Generated Holography fail solving said problems otherwise than by deteriorating conditions for the observation and perception of the obtainable optical image. Said problems are usually solved by imposing limitations upon image resolution and dimensionality and/or by causing a viewer to do a complicated and difficult visual work for creating a single 3-D mental image while viewing 2-D images. Said limitations are mainly caused by redundancy in information to be processed and in an information content of the hologram so that capabilities of computational means for processing and storing said information are limiting factor in known apparatus. Said limitations are caused also by calculating, processing and employing a lot of 2-D intermediate representations or carrying out intermediate computations. Said redundancy in information is associated in known apparatus with the representation of each object point in a great deal of 2-D images of different perspective views or sections of the object, or in numerous hologram elements. Besides, another source of a redundancy in information is high resolution requirements to conditions for forming holograms, as discussed in the Background. Thus, none of known methods and apparatus provides (or simulates) 3-D aspects in an obtainable 3-D optical image without increasing a redundancy in information to be processed for producing a hologram and in an information content of a hologram.

It is to be noted that importance of both individual directional radiation and the way of preserving 3-D aspects of the obtainable optical image is not restricted by the scope of a matter of the coordination of conditions of using said means in the proposed apparatus. This will be understood to a great extent if consider results of the comparative analysis in respect of visual information presented to the viewer.

Actually, limitations in conditions of the observation and perception of said visual information are arisen every time when it is presented as composed of 2-D independent visual elements, as in Display Holography and Imaging Techniques. This is explained by lacking 3-D aspects in each of said visual elements like images of perspective views of the object or its sectional images. The same situation takes place if providing 1-D independent visual elements like images of discrete points of light presented together as 2-D visual elements to the viewer (see, for example, U.S. Pat. No. 4,655,539, U.S. Pat. No. 3,698,787 and U.S. Pat. No. 4,498,740).

Said problems could be solved and said limitations (or restrictions) could be overcome, according to the present invention, when providing 3-D aspects in each of visual elements of the optical image to be produced as an important part of visual information to be presented to a viewer. Each of such 3-D visual elements presents independently individual visual information relating to spatial optical characteristics of one of local object components. All 3-D visual elements presented simultaneously provide total visual information perceived as an actual 3-D optical image produced.

The presentation of 3-D visual elements in the proposed apparatus affords the viewer an opportunity, while seeing any of them from all directions it is visible, to perceive peculiarities in spatial optical properties of one of object details or in spatial optical characteristics of one of its surface fragments. Whereas in known apparatus, some of said peculiarities could be perceived while seeing this detail or fragment among others in different 2-D visual elements each viewable from one of directions (viewpoints). Moreover, the presentation of 3-D visual elements simultaneously enables the viewer perceiving said peculiarities visually, when changing viewpoints, while viewing the actual 3-D optical image produced as a whole and at ones. This provides watching said peculiarities in optical properties (optical characteristics) of each detail (fragment) separately or in combination with other details (fragments) without misgivings of losing the entire optical image when changing viewpoints and without restrictions in time for perceiving said peculiarities, in contrast to that in known apparatus. In other words, the presentation of visual information composed of such 3-D visual elements permits observing the entire 3-D optical image or said peculiarities in optical properties (optical characteristics) of said details (fragments) at viewer's option. Apart from this, the presentation of such visual information gives the viewer an opportunity of watching not only peculiarities in optical properties (optical characteristics) of each detail (fragment) but also those in combining said optical properties (optical characteristics) relating to some object details (fragments). Such visual information allows perceiving variability in relative positions of details (fragments) and understanding visually a depth of the object without limitations, like in the prior art. This explains also the fact that an actual 3-D image exhibits full parallax by affording the viewer a full range of viewpoints of the image from every angle and full range of perspectives of the image from every distance, in contrast to that in the prior art. Thus, a difficult and complicated visual work should be done by the viewer in known apparatus for mentally transforming 2-D visual elements and creating in the mind an illusion or impression of a single 3-D image, as mentioned above. And so, said conditions afforded in the proposed apparatus permit facilitating the visual work for the viewer and improving other conditions for the observation and perception of the obtainable optical image as compared with those ones afforded in known apparatus. Said conditions are more comfortable and favorable than the latter ones due to the fact that taking 3-D visual information is inherent to the very nature of human's visual perception. The presentation of such 3-D visual elements in their relationship with each other allows perceiving the actual 3-D optical image in unity and entirety of optical properties of all fine details or optical characteristics of all fragments of the object or any its part desirable to be presented. Said part of the object may be each of its 3-D zones disposed in the depth direction or any of its 3-D detail visible from some segments 28 of the assigned field of view (see FIGS. 1, 2).

That is why, conditions of the observation and perception of the 3-D optical image that afforded in the proposed apparatus is very close to natural conditions that a viewer has in the real world. It enables a common viewer perceiving said optical characteristics in 3-D visual elements without acquiring any specific experience. The latter is necessary when viewing 2-D visual elements for perceiving a single 3-D mental image therein, or peculiarities in optical properties (optical characteristics) of one or some of object details (fragments) while trying to retain the entire 3-D image in the mind, as in sectional Display Holography.

In this respect proposed is a way of transforming spatial optical characteristics of each of local object components with preserving 3-D aspects inherent to them for presenting said optical characteristics to the viewer in one of 3-D visual elements. Said 3-D aspects are preserved due to using individual directional radiation in each step of this way when transferring said optical characteristics from one participating means to the other and when presenting them in the respective 3-D visual element. Therefore, an individual distribution of directional radiation is employed according to the present invention not only as a carrier of 3-D aspects inherent to spatial optical characteristics, but also as a 3-D visual element to be viewed for perceiving said optical characteristics themselves in this directional radiation. Whereas all individual distributions of directional radiation representing said optical characteristics of each of said sample of local object components are employed together for synthesizing radiation itself that presents an actual 3-D optical image to a viewer.

It becomes quite clear that individual directional radiation and this way of transforming optical characteristics are used both for embodying a nontraditional approach. It is developed for solving (or avoiding) principal problems of the prior art and overcoming main limitations (or restrictions) inherent thereto as well as for affording a viewer improved conditions of the observation of a 3-D optical image and facilitating the perception of its depth and variability at different perspectives.

The nontraditional approach consists in synthesizing radiation extending from fine details or small surface fragments of the object and representing their spatial optical properties or spatial optical characteristics individually and independently for each detail or fragment in order to present them for viewing in one of 3-D visual elements. In other words, synthesized radiation in this approach is composed of said individual distributions for simulating optical properties of the object in unity and entirety of optical properties (optical characteristics) of its details (or fragments) and presenting them in said radiation as an actual 3-D optical image. Such approach is carried out by way of transforming said optical characteristics (or properties) using individual directional radiation as a tool of the approach in each step of this way.

That is why, such an approach is nontraditional. It provides presenting optical characteristics of each local object component by synthesizing radiation extending therefrom, rather than a great deal of 2-D images containing said component, as in Display Holography and 3-D Imaging Techniques, or numerous hologram elements storing its optical characteristics as in Computer Aided Holography.

Diverse advantages are attained in the proposed method and apparatus such as described in the Summary. Main advantages are associated with facilitating a visual work for a viewer, reducing a strain on the human visual system, avoiding problems and difficulties pertaining to the observation and perception of 2-D (1-D) images and improving other conditions for the observation and perception of the obtainable optical image. Such advantages are attained by presenting 3-D visual elements for viewing said optical characteristics, or preserving anyway 3-D aspects thereof, in particular, by carrying out the coordination of conditions of using all participating means in the proposed apparatus in the manner discussed hereinabove.

Other advantages are associated with realizing improved conditions of using one of participating means or anyway resulting from these conditions.

Thus, great opportunities are offered in achieving a high degree of resolution of the optical image or its higher quality as a whole because of lacking limitations (or restrictions) on sizes of hologram elements, like in the prior art. Such limitations may be associated in known apparatus with maintaining a small area of diverging radiation at the surface of a recording medium like in U.S. Pat. Nos. 4,498,740 and 4,655,539, or with presenting disparate images if using a stereoscopic representation of an object as in U.S. Pat. No. 5,748,347, U.S. Pat. No. 3,832,027. Far severe limitations on an image resolution, other characteristics of an obtainable optical image and upon conditions of its observation and perception are imposed in Computer Aided Holography due to high resolution requirements to conditions for forming a computer-generated hologram.

On the other hand, said other advantages are associated with creating far more favorable conditions of using computational means due to avoiding a redundancy in information, if specifying and selecting directly data relating to spatial optical characteristics, and removing 2-D intermediate representations or computations, as explained in the Summary. That is why, the presentation said optical characteristics in 3-D visual elements is accomplished without the redundancy in information to be processed and an information content of a hologram, in contrast to that in the prior art. An amount of calculations for producing a hologram and computer processing time and/or memory for storing data processing can therefore be greatly reduced. Because of that, released capabilities of computational means could be used more effectively for achieving high degree of resolution of the optical image and its higher quality as well as other purposes of visual applications in mentioned fields.

This is carried out due to reducing an amount of information to be processed and/or transmitted as proper data to remote users, when it is desirable for producing a hologram. It is to be clear from above discussions that data relating to positions of local object components and their optical characteristics is complete and exhaustive information to be employed as proper data for said purposes. Significant advantages are attained, if using such data for on-line communication or transmission to remote users instead of image information containing in 2-D visual elements or a hologram itself, as in known apparatus (see U.S. Pat. No. 5,227,898 or U.S. Pat. No. 3,547,510). This is explained by changing the very format of proper data, as compared with that in the prior art. An amount of information could be reduced more considerably, if using appropriate characteristics of directivity patterns as control data for handling said optical means.

Besides, additional opportunities are offered in improving conditions of the observation and perception of the 3-D optical image because the proposed approach has no limitations in employing diverse modifications of said optical characteristics or conditions of the presentation of individual directional radiation for its recording. And so, it enables specifying said optical characteristics as having more complicated structure and/or reproducing their associated individual distributions of directional radiation simultaneously in groups at user's option, using released capabilities of computational means and extended capabilities of optical means in changing optical parameters of said directional radiation. That is why, said peculiarities in optical properties (optical characteristics) of each fine detail (small surface fragment) of the object could be presented more accurately in 3-D visual elements, while limitations in an achievable image resolution or 3-D image quality like in the prior art could be overcome. Said limitations are usually imposed to meet requirements to dynamic range capabilities of the recording material, if a necessity of recording hundreds and more relatively weak individual holograms is arisen, that is discussed with reference to U.S. Pat. No. 5,748,347, U.S. Pat. No. 4,969,700, U.S. Pat. Nos. 4,498,740 and 4,655,539. A possibility of employing diverse presentations of an individual distribution of directional radiation associated with said optical characteristics, that is discussed with reference to FIG. 2, provides performing modifications of its shape (or structure) and demonstrates flexibility of the proposed method and apparatus due to embodying the nontraditional approach.

Meanwhile, it is to be clear that the described computer-assisted method and apparatus disclosing one embodiment of the present invention could be useful above all for forming holograms of comparatively simple or small objects. Not many local components are required in such or similar applications for representing an object or its part, while an individual distribution of directional radiation associated with said optical characteristics has a simple structure so as to be reproduced completely and sequentially for one local object component at a time. Some variants of transforming the first coherent radiation beam imply varying parameters of this beam itself or one part thereof only for reproducing said directional radiation having variable optical parameters, as discussed above with reference to FIGS. 4-8. It is expedient, hence, to employ other embodiments, if forming a hologram of a complex object or its part is desirable. Other embodiments could be carried out by employing different variants of transforming the first coherent radiation beam and associated each with varying parameters of its several parts. This enables reproducing an individual distribution of directional radiation of a complicated shape (structure) sequentially or some of such individual distributions of directional radiation simultaneously in groups at user's option. It is to be understood that the main and other advantages of embodying said approach are attained for each variant of said beam transformation, as any individual directional radiation having a simple or complicated spatial structure is reproduced independently. Each of 3-D visual elements presenting optical characteristics of one of local object component to the viewer has so its inherent 3-D aspects irrespective of the way of storing said optical characteristics in one hologram portion: separately or together with those in one of groups of local object components. The latter way is important, as it provides preserving individual 3-D aspects, while avoiding problems relating to dynamic range capabilities of the photosensitive recording material. It is accomplished by storing 3-D representations of said optical characteristics of each group of local object components in one respective hologram portion. Whereas in known methods and apparatus, a great deal of images of 2-D or 1-D representations depending on a number of viewpoints should be recorded separately for preserving 3-D aspects (see, e.g., U.S. Pat. No. 5,748,347 or U.S. Pat. No. 4,498,740). The same number of exposures would have to be taken as well. Hence, the proposed way of avoiding said problems turns out to be quite different from that used in the prior art and very useful not only for preserving individual 3-D aspects, but also for reducing considerably a number of exposures and attaining other specific additional advantages. It will be discussed hereinafter in detail while describing different variants of said other embodiments of the present invention.

Thus, directional radiation having variable optical parameters is reproduced in one variant as a bundle of multitudinous rays for better representing complicated optical characteristics of local object components specified in the virtual space. This variant of transforming the first coherent radiation beam provides for enlarging this beam in size, dividing the resulting object beam into a multitude of parts by spatial modulating thereof to form a bundle of rays and select each of rays intended to be oriented in different pre-established direction with respect to the coordinate system. The rays to be selected are varied in number, while selecting those rays that intended to be oriented in required directions and controlling an intensity (or amplitude) of radiation in each selected ray to represent accordingly variable optical parameters of directional radiation to be reproduced. Selected rays being directed in their pre-established directions are oriented so as if all of them emanate from a single local spot. Thus reproduced directional radiation is appeared as arising from a single local spot being, therefore, the second type of said local region. Known optical means based on using diffraction elements and a spatial light modulator (SLM) controlled with the computer could be used for reproducing each spatial intensity or amplitude distribution of diffracted radiation. SLM has a large aperture number and is disposed so as to provide correct matching its pixels with diffraction elements. Only required diffraction elements corresponding to pixels selected under control of the computer are illuminated with laser light of the specified intensity for producing rays of said bundle. Advantages of employing such optical means in the proposed apparatus as compared with that in U.S. Pat. No. 5,907,312 are discussed above in the comparative analysis.

Another variant is based on using an ensemble of partial radiation beams and has two versions. The first version can be used for reproducing directional radiation having variable optical parameters. Each beam is produced from a respective part of a first coherent radiation beam by means of the SLM similar to that in the preceding variant and could be composed of different rays. Each of said rays is associated with radiation transmitted through one corresponding SLM pixel selected and specified in degree of modulation (or in modulation factor) under control of the computer. A number of different pixels to be selected, and so a number of rays to be selected for producing said partial radiation beam, could be changed differently. This version provides for enlarging the first coherent radiation beam in size, dividing this beam into fractions with the aid of SLM and selecting those ones to be used to form the ensemble of partial radiation beams each having variable parameters. Therefore, each selected fraction of said radiation beam turns out to be oriented separately in the coordinate system along the axis of its relating optical focusing system. In the selected fraction at least one part to be used is selected by variably restricting a cross-section of that fraction. This is accomplished by selecting respective pixels of SLM with the computer. The following steps of this version with respect to said part of that fraction is similar to those ones having been used for the first coherent radiation beam itself in the variant shown in FIG. 4. Thus, these steps include adjusting each selected part of that fraction in size, parallel shifting this part with respect to the axis of said optical focusing system, and controlling an intensity (or amplitude) of radiation in this part of that fraction of the first coherent radiation beam. This provides required variations in parameters of one respective of partial radiation beams to be produced, namely, in its solid angle, its spatial direction and an intensity (or amplitude) in this direction. The resulting fractional beam is focused by said optical focusing system into a sole focal spot established for said ensemble in the coordinate system to produce said respective partial radiation beam having variable parameters and provide extending this beam from said sole focal spot. This is accomplished by said optical focusing system for all of partial radiation beams selected into the ensemble for reproducing thus said directional radiation having variable optical parameters, and so said sole focal spot is the third type of said local region of arising this directional radiation. Parameters of partial radiation beams and their number in each ensemble could be varied in this first version in a wide range depending on a structure and a solid angle of the specific individual distribution of directional radiation to be reproduced (like depicted by diagrams 15, 18 in FIG. 1) This permits presenting peculiarities in optical properties (optical characteristics) of each fine detail (small surface fragment) of the object more accurately in 3-D visual elements and thereby providing a better reproduction of details and shades of the object(s) thus affording a viewer higher image quality thereof. On the other hand, if optical characteristics of some of local object components are specified by similar distributions of directional radiation, the same number of partial radiation beams could be used in each said ensemble. Variations in parameters of all partial radiation beams and in their number in any ensemble are carried out in common by employing the SLM handled with the computer. The computer forms control signals and directs them to the SLM for selecting respective pixels and establishing their associated degrees of modulation. As a result of such proper matched variations, all variable optical parameters of thus reproduced directional radiation are represented. And if particular values of these optical parameters are established to be coordinated with selected data relating to optical characteristics of the respective of local object components, its associated individual directional radiation is reproduced. In such a way individual directional radiation associated with each of at least a number of said local object components in the computer database could be reproduced as well.

The second version of this variant provides for similar steps for producing an ensemble of partial radiation beams each having variable parameters such as a solid angle, a spatial direction and an intensity (or amplitude) in this direction. However, variations in parameters of each selected part of the first coherent radiation beam in this version are carried out in somewhat a different way to represent themselves variable parameters of one of partial radiation beams to be produced. This version employs the presentation, wherein the individual distribution of directional radiation relating to each of at least the number of local object components is specified in the virtual space as composed of constituent spatial intensity (or amplitude) distributions of directional radiation with respect to said reference system. The step of changing parameters of each of partial radiation beams selected into the ensemble with respect to the coordinate system is carried out, therefore, to represent data relating to one of constituent distributions associated with appropriate optical characteristics of any of the sample of local object components. All partial radiation beams selected into the ensemble are produced, like in the first version, to be extended from a sole focal spot for reproducing thus directional radiation to be coordinated with appropriate optical characteristics of each respective of at least the number of local object components in the computer database. Directional radiation is arisen from said sole focal spot being, hence, one special type of said local region. Particular values of parameters of each partial radiation beam of the ensemble in this second version are established to be coordinated with selected data relating to one respective constituent distribution of directional radiation associated with appropriate optical characteristics of the respective local object component. Hence, each partial radiation beam reproduces its respective constituent distribution and, along with all of partial radiation beams of the ensemble, said individual directional radiation associated with this local object component as a whole. It is to be understood that each ensemble to be produced has its own sole focal spot for reproducing its respective individual directional radiation.

Thus, in contrast to the first version, a number of partial radiation beams in any ensemble is determined in the second version by that of constituent distributions associated with the respective local object component. Whereas parameters of each partial radiation beam are varied in a restricted range defined, e.g., by appropriate characteristics of the directivity pattern relating to one respective of constituent distributions associated with this local object component. Meanwhile, the second version allows to take advantages of specifying previously (in advance) data relating to partial radiation beams selected in all said ensembles in the computer database.

Described variants of transforming the first coherent radiation beam by varying parameters of its respective parts are useful for reproducing individual distributions of directional radiation having complicated, e.g., multilobed structures like depicted by diagram 24 in FIG. 2. It is quite clear that such structures can be represented more accurately if using said variants rather than one embodiment, wherein an individual distribution of directional radiation is completely (entirely) reproduced. The very shape of such presentation permits providing a higher image quality by changing a direction and solid angle of each partial radiation beam within a solid angle of said individual distribution as a whole. Meanwhile, flexibility of diverse modifications in a shape of any individual distribution of directional radiation allow attaining said purposes of visual applications, while preserving individuality and definite spatial specificity in said optical characteristics to be presented in this directional radiation to a viewer. This comes about due to embodying the nontraditional approach in each of said variants.

Besides, variations in parameters of selected parts of the first coherent radiation beam are made in both variants with the aid of the SLM that offers opportunities of providing such transformations together for producing simultaneously a respective number of bundles of rays (or ensembles of partial radiation beams). It is especially valuable, if their single local spots (or sole focal spots) of emanating rays (or partial radiation beams) are located at their locations in one respective of planes parallel to a base plane of the coordinate system. Actually, it requires using the same number of said optical focusing systems and the SLM having much more pixels to be handled by the computer for establishing parameters of rays (or partial radiation beams) of all bundles (or ensembles). Said number relates, e.g., to all local object components arranged in one object section. Each variant provides so simultaneous reproducing individual spatial intensity (or amplitude) distributions of directional radiation associated with optical characteristics of all said local object components arranged in one of object sections at a time. Every variant (any version of the variant employing ensembles of partial radiation beams) is carried out, if data representing an object in the computer database is divided into sections parallel to a reference plane of the reference system and disposed in the virtual space in the depth direction. It implies that one respective plane, wherein sole focal spots are located, is disposed in respect to the base plane at a position coordinated with that of said object section in respect to the reference plane. One of surfaces of the recording medium made as a flat layer, or those of its flat substrate may be assigned in this case as the base plane. Lenses having parallel optical axes and the same focal lengths can be used as said optical focusing systems and disposed in the matrix manner in a plane parallel with the base plane. The less pitch of lenses therein the better a 3-D optical image resolution in a depth plane, while the more SLM pixels optically coupled with each lens the better an angular resolution of the respective individual distribution of directional radiation that could be achieved.

Apart from flexibility in modifications of the shape (or spatial structure) of each individual distribution of directional radiation to be reproduced or in its optical parameters to be established in variants discussed above or in a further variant to be discussed below, the proposed method and apparatus have also flexibility in further optical transformations to meet different requirements of said visual applications and in diverse presentations of said individual distribution for recording it separately or together with those ones relating to the same group of local object components. This is evidence of gaining flexibility in diversifying variants for attaining a variety of additional specific advantages or particular purposes of visual applications in mentioned fields, depending on the variant selected. This comes about due to embodying the nontraditional approach in each variant described above or created as a result of combining different variants when carrying out such kinds of flexibility. Great opportunities are thereby offered in attaining said main advantages and those of additional specific advantages that are desirable in the specific situation of visual applications at user's choice.

Thus, the presentation of 3-D visual elements each having its individual 3-D aspects in the proposed apparatus facilitates the visual work, reduces a strain on the human visual system and makes conditions for the observation and perception of the optical image more favorable and comfortable for a viewer. This example serves as an illustration of attaining main advantages, when comparing with known apparatus based on presenting depth plane (sectional) images to a viewer separately, one image at a precise moment of time (U.S. Pat. No. 5,907,312), or together (U.S. Pat. No. 5,117,296, U.S. Pat. No. 5,227,898 and U.S. Pat. No. 5,592,313). Said favorable and comfortable conditions are created because of storing 3-D visual information in 3-D representations. This affords the viewer full range of viewpoints for watching said peculiarities in optical properties (optical characteristics) of each detail (fragment) separately or in combination with others in contrast to that when viewing images of details or fragments in 2-D visual elements.

Besides, when individual distributions of directional radiation associated with local object components arranged in each object section are reproduced simultaneously for holographically recording them in one combined area of the recording medium, problems pertaining to dynamic range capabilities of the photosensitive recording material, such as in U.S. Pat. No. 4,498,740 and U.S. Pat. No. 4,655,539, could be overcome as well.

On the other hand, the obtainable image resolution could also be increased due to avoiding limitations in the image resolution that are associated with requirements to sizes of hologram elements like in U.S. Pat. No. 4,778,262 and U.S. Pat. No. 4,969,700, or U.S. Pat. No. 4,498,740 and U.S. Pat. No. 4,655,539. This circumstance is explained by the fact that sizes of each of combined areas are comparable with recording medium dimensions and illustrates so the possibility of attaining additional specific advantages being very important in many of visual applications. Meanwhile, high degrees of the image resolution or image quality are not required in some situations, e.g., if users at remote work sites desire making snapshots of objects for rapid searching and selecting those being interesting thereto. In such a variant an amount of information to be processed or transmitted to remote users and an amount of time for forming a hologram should be reduced as much as possible. In particular, a shape of each individual directional radiation is to be simplified essentially as compared with that in variants discussed above. While individual distributions of directional radiation should be reproduced simultaneously, e.g., for all said local object components arranged in one of object sections at a time, for recording all of them holographically in one combined area of the medium. The SLM controlled by the computer and said optical focusing systems could be used in this variant as well. It is, of course, understood that various further modifications for attaining additional specific advantages or achieving particular purposes of visual applications will be apparent to those of ordinary skill in the art.

Thus, said variant using ensembles of partial radiation beams has its additional specific advantages, inasmuch as it does not require specifying data relating to all selected rays as the former variant using bundles of multitudinous rays. It is most important when information should be communicated (transmitted) to remote users, if it is desirable for forming a hologram. Actually, those who skilled in the art can determine, which pixels should be selected and what degrees of modulation should be specified for them from data relating to parameters of any partial radiation beam and a proposed distribution of radiation therein (e.g., of a Gaussian form). In other words, all data necessary to reproduce that partial radiation beam by optical means could be calculated from its parameters using conventional computer programs and nothing more than said parameters are required in this case. The computer could be preprogrammed for such calculations, when said parameters are represented by appropriate characteristics of one respective directivity pattern in the virtual space as mentioned above. If using such a presentation, each individual directional radiation has a desirable spatial structure. While, an amount of relevant information or proper data to be communicated (or transmitted) could be considerably reduced, since data relating to characteristics of each directivity pattern is used by the computer as said control data. After performing said calculations, the computer forms control signals and directing them to SLM pixels for reproducing the partial radiation beam. An amount of information relating to an ensemble of partial radiation beams is evidently less if comparing with that relating to a bundle of multitudinous rays. The difference is increased with the number of individual distributions of directional radiation to be reproduced. An embodiment based on using ensembles of partial radiation beams for reproducing simultaneously individual spatial intensity (or amplitude) distributions of directional radiation associated with optical characteristics of all said local object components arranged in one of object sections at a time is considered so as a first preferable embodiment.

The further variant of transforming a first coherent radiation beam by varying parameters of its respective parts is based on using an ensemble of partial radiation beams as well and has similar versions as another variant discussed before. The first version thereof is used for reproducing directional radiation having variable optical parameters. But, in contrast to the first version of said another variant, each partial radiation beam of an ensemble is formed separately to make it emanating from its respective individual spot and extending through a sole local spot established for such an ensemble in the coordinate system. This could be carried out by enlarging the first coherent radiation beam in size, dividing thereof into fractions and selecting those ones to be used to form an ensemble of partial radiation beams each having variable parameters and extending through the sole local spot. Each selected fraction of said radiation beam is oriented in the coordinate system separately to be along the axis of an optical focusing system relating to that fraction. At least one part to be used in that fraction is selected by variably restricting a cross-section of that fraction by means of SLM. Required variations in parameters of one of said partial radiation beams to be produced are provided by adjusting each selected part of that fraction in size, parallel shifting this part with respect to the axis of said optical focusing system, and controlling an intensity (or amplitude) of radiation in this part of that fraction. Said parameters include accordingly a solid angle, a spatial direction and an intensity (or amplitude) in this direction. The resulting fractional beam is focused by said optical focusing system into its respective individual spot to produce said partial radiation beam emanating from this individual spot and having variable parameters and provide its extending through said sole local spot. The latter is accomplished for all of partial radiation beams selected into the ensemble for reproducing directional radiation having variable optical parameters and arising from said sole local spot being, therefore, the fourth type of said local region. Variations in parameters of all partial radiation beams of such ensemble are carried out in common, as in the first version of said another variant, by employing the SLM handled with the computer. As a result of such proper matched variations, variable optical parameters of thus reproduced directional radiation are represented. And if particular values of these optical parameters are established to be coordinated with selected data relating to optical characteristics of the respective of local object components, its associated individual directional radiation is reproduced. In such a way individual directional radiation associated with each of at least a set of such local object components in the computer database could be reproduced as well.

A difference between the first and the second versions of the further variant is similar to that between such versions in another variant, regardless of said difference between the variants themselves, of course. Thus, in the second version variations in parameters of each selected part of the first coherent radiation beam are carried out to represent variable parameters of one of partial radiation beams to be produced. All of partial radiation beams selected into the ensemble are produced (like in the first version of the further variant) as extending through a sole local spot established for such an ensemble. This permits reproducing in common directional radiation to be coordinated with appropriate optical characteristics of each respective of at least a set of such local object components. Directional radiation is arisen so from said sole local spot being, therefore, other special type of said local region. Particular values of parameters of each partial radiation beam of the ensemble are established in this second version to be coordinated with selected data relating to one respective of constituent distributions of directional radiation associated with appropriate optical characteristics of the respective of local object components. Each partial radiation beam reproduces its respective constituent distribution and, along with all of partial radiation beams of the ensemble, individual directional radiation associated with this local object component as a whole. A number of partial radiation beams selected in any ensemble is determined by that of constituent distributions associated with the respective of local object components. While parameters of each partial radiation beam are varied in a restricted range defined, e.g., by appropriate characteristics of a directivity pattern relating to one respective of constituent distributions associated with this local object component. Hence, the second version provides flexibility in transformations so that parameters of each partial radiation beam can be coordinated separately, and permits to take advantages of specifying previously (in advance) data relating to partial radiation beams for all such ensembles in the computer database.

Apart from this flexibility of transformations, the further variant provides other specific additional advantages that could be attained if individual spots of emanating all partial radiation beams selected into such ensemble are located at their respective locations in one of planes parallel with a base plane of the coordinate system. It is so indeed, if the former plane is disposed with respect to this base plane at a position coordinated with a position of a representative plane (like P₁ in FIG. 3) for individual directional radiation associated with the respective of such local object components (like 31, 36, 37 and 38). The individual spatial intensity (or amplitude) distribution of directional radiation associated with optical characteristics of any of local object components arranged in the respective zone (like 31 in Zone 1, FIG. 3) can thus be reproduced as a whole when using similar optical focusing systems for forming all partial radiation beams together. Specific optical focusing systems to be selected and particular parameters of partial radiation beams to be established are determined by constituent distributions of directional radiation associated with appropriate optical characteristics of that local object component. It becomes obvious, when viewing its constituent distributions 32, 33, 34 and 35 originating respectively from separate spots j₁₁, j₁₂, j₁₃ and j₁₄ in representative plane P₁ of Zone 1 and taking into account that each of partial radiation beams reproduces one of these constituent distributions. This explains also that a set of ensembles of partial radiation beams emanating from individual spots located at their locations in one of planes parallel to a base plane of the coordinate system can be produced simultaneously. This comes about, if said locations are coordinated with positions of separate spots of originating associated constituent distributions in the representative plane of the respective zone. Thereby, individual spatial intensity or amplitude distributions of directional radiation associated with optical characteristics of all such local object components arranged in one of zones at a time can be reproduced.

Such result is highly important, as it provides synthesizing radiation extending from fine details or surface fragments in a part of the object and representing optical properties (or optical characteristics) of each detail (or fragment) independently and individually, as it takes place in natural conditions in the real world. This comes about because said optical characteristics of all local object components visible from each viewpoint in the assign field of view are presented simultaneously to the viewer to form a 3-D optical image visible therefrom. In other words, such presentation of optical properties (or optical characteristics) permits retaining individual 3-D aspects relating to each detail (or fragment) separately, while taking into account a position of the latter in a respective zone. And so, in particular, it allows eliminating hidden areas from appearing in the optical image of said zone and the entire object and providing said optical image variability when changing viewpoints. Said variability is provided in the proposed method and apparatus by proper specifying optical characteristics of each of such local object components in the computer database, while using only one exposure for a zone. None of known methods and apparatus provides (or simulates) such variability or some 3-D aspects in an optical image of a 3-D zone without increasing a number of exposures and a redundancy in information to be processed and in the information content of a hologram. Besides, individual distributions of directional radiation associated with optical characteristics of all such local object components arranged in said zone in the proposed apparatus can be reproduced at ones without the mechanical movement of optical means (techniques) in the depth direction. That is why, such a presentation is proposed as the second preferable embodiment of the present invention. It is to be noted that advantages of the further variant are attained in addition to those attained in the first preferable embodiment. This situation is unlike to that in the system disclosed in U.S. Pat. No. 5,227,898, wherein data representing an object as divided into depth regions disposed in a 3-D virtual space is compressed by projecting the volume within each 3-D region into a respective depth plane. Each 3-D region in this apparatus is represented so by a 2-D image of the compressed depth plane that removes 3-D aspects from the holographic record and the additional exposure is to be made for each viewpoint afforded.

The proposed presentation is carried out, if data representing the object in the computer database is divided into three-dimensional zones disposed in the virtual space in the depth direction with respect to the reference system having a reference plane, and a plurality of depth planes parallel to the reference plane is disposed in the same direction so as to have one of depth planes in each of zones. This plane is used as a representative plane for individual directional radiation associated with said optical characteristics of each of such local object components arranged in the respective zone. Said one of planes parallel to the base plane is disposed in respect thereto at a position coordinated with a position of the representative plane of the respective zone in respect to the reference plane. Lenses having parallel optical axes and the same focal lengths can be used as said similar optical focusing systems and disposed in the matrix manner in a plane parallel with the base plane. Each lens is optically coupled with respective SLM pixels handled with the computer in degrees of modulation for producing one partial radiation beam. Parameters of that partial radiation beam are established by varying parameters of a selected part in the respective fraction of the first coherent radiation beam with said SLM pixels, as discussed above. And so, the respective set of ensembles of partial radiation beams emanating from individual spots at their locations is produced simultaneously. Such lenses are commercially available as a microlens matrix. A rectangular array of lenses resembling each a sphere section and spacing equally in both directions is employed in the prior art, e.g., in the fly's eye display (see FIG. 3A in U.S. Pat. No. 5,581,378). It is used for recording an image of an object on a photographic plate, while the camera is moving. During playback the developed photographic plate is illuminated for viewing a different stereo pair at a different viewpoint. But, the fly's eye approach is difficult to realize (or simulate) electronically, since both horizontal and vertical parallax information must be displayed simultaneously. Such limitations are overcome when embodying said nontraditional approach. Actually, synthesized radiation presented as 3-D visual elements instead of 2-D images permits affording all 3-D aspects in an optical image without increasing redundancy in information to be processed and in the information content of the hologram. The microlens matrix optically coupled with SLM pixels can be used in both preferable embodiments. It is convenient so to describe together the implementation of both embodiments unless definite peculiarities and specific advantages of one of them are to be disclosed.

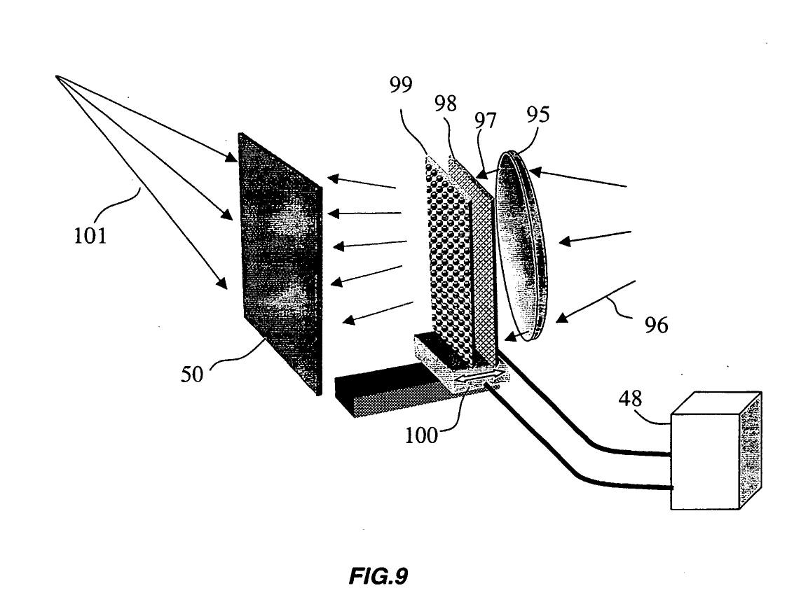

FIG. 9 illustrates a general view of a computer-assisted apparatus for forming a hologram that can be used for carrying out both the first and the second preferable embodiments of the present invention. Part of conventional optical means, such as a laser, a shutter and a beam splitter of said means for providing a first and a second coherent radiation beams (see FIG. 7), are not shown in FIG. 9 for simplicity. While a beam expander is presented by collimating lens 95 intended to receive first coherent radiation beam 96 expanding along an axis of lens 95 and direct collimated beam 97 to spatial light modulator (SLM) 98 and therethrough to microlens matrix 99. Lens 95 has a large aperture to cover all pixels of SLM 98 disposed so as to provide correct matching a pitch of its pixels with that of microlenses in matrix 99. The relation of these pitches should be an integer number, in particular. Each microlens can be used for producing either one ensemble of partial radiation beams extending from a sole focal spot or one partial radiation beam extending through a sole local spot of a respective ensemble, depending on that the first or the second preferable embodiment is to be carried out. And so, each microlens is to be selected and matched with the respective number of pixels of SLM 98. Microlens matrix 99 and SLM 98 are mounted on a coordinate drive 100 for moving together along Z_{c} axis of the coordinate system in directions shown by the hollow arrow. This enables positioning all individual spatial intensity (or amplitude) distributions of directional radiation simultaneously reproduced by SLM 98 and matrix 99 in respect to the base plane of the coordinate system, while remaining optical parameters thereof. As a result, their local regions are established at locations coordinated with positions of their associated local object components. Local regions (sole focal spots) in the first preferable embodiment are located in one of planes parallel to the base plane and disposed with respect to this base plane at a position coordinated with a position of the respective of object sections with respect to the reference plane. Said positioning of directional radiation allows, hence, representing z data relating to positions of local object components in the virtual space. While their x and y data is represented by locations of microlens selected in matrix 99 in accordance with position data. That is why, it is sufficient to establish the local region of arising thus reproduced individual directional radiation associated with one of said local object components arranged in each of object sections in accordance with position data relating to this local object component. Said coordinate system established in the real world (space) is associated with recording medium 50 so that its Z_{c} axis is oriented along a normal to one of flat surfaces of recording medium 50 that is assigned as the base plane. All reproduced individual distributions of directional radiation (not labeled in FIG. 9) are directed along with a divergent reference beam 101 to recording medium 50 to form therein a hologram portion in a corresponding combined area. The reference beam is produced by adjusting parameters of a second coherent radiation beam in accordance with selected data. It could be carried out by focusing the second coherent radiation beam and orienting an expanding beam in an established direction in said coordinate system with optical means (like lens 75 and mirror 76 in FIG. 6) to provide complete covering the corresponding combined area. Procedures of reproducing, positioning individual distributions and their holographic recording are handled (or controlled) with the computer 48 through respective interfaces (not shown).

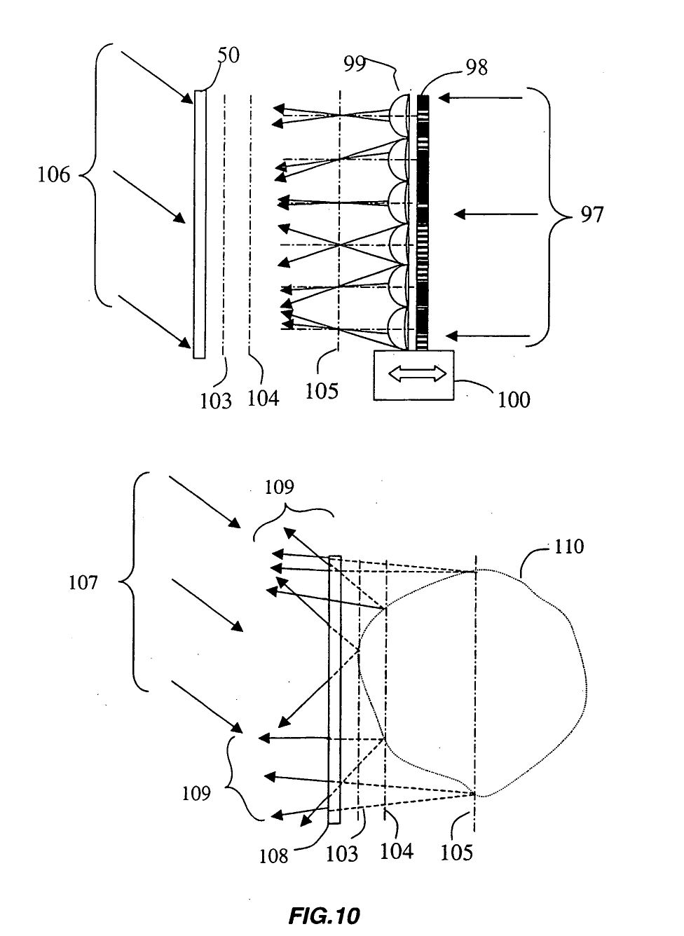

Some peculiarities of such procedures in the second preferable embodiment are explained below with reference to FIG. 10. Each partial radiation beam (not labeled) to be produced is formed from collimated beam 97 by selecting with SLM 98 one its fraction to be transmitted through one microlens of matrix 99. Parameters of said partial radiation beam could be varied by selecting respective pixels of SLM 98 and establishing their associated degrees of modulation under control of the computer. As it is apparent from FIG. 10, a number of selected pixels and their positions with respect to the axis of one microlens determine a solid angle and spatial direction of said partial radiation beam to be produced. While a particular value of its intensity (or amplitude) in this direction is determined by degrees of modulation established in selected pixels. The resulting fractional beam is focused by said microlens into an individual spot located at the intersection of said microlens axis and one respective of planes 103-105 to produce said partial radiation beam as emanating from this individual spot and having established parameters. All partial radiation beams of one ensemble extend through a sole local spot (not shown) established for such an ensemble. Said sole local spot is a respective local region of arising thus reproduced individual directional radiation. A location of this local region is changed depending on parameters of partial radiation beams selected into the ensemble and locations of their individual spots. Thus, it is not necessary to select only neighboring partial radiation beams produced by adjacent microlenses for reproducing individual directional radiation extending from adjacent local object components, as in the first preferable embodiment. This becomes obvious, if viewing constituent distributions (represented by arrows in FIG. 3) originating from their separate spots disposed in the representative plane P₂ of Zone 2 or P₃ of Zone 3 for composing their associated individual distribution of directional radiation relating to one local object component arranged in said zone. Besides, individual spots of emanating partial radiation beams selected into different ensembles could be even coincided as spots of their respective constituent distributions denoted by j₁₂ and disposed in the representative plane P₁ of Zone 1. This implies that two (in this particular case) or more parts in the respective fraction of collimated beam 97 should be selected with SLM 98, while taking into account that each of partial radiation beams thus produced reproduces one of those constituent distributions. All of this is evidence of flexibility in transformations of beam 97 that could be employed in the second preferable embodiment for attaining specific additional advantages, when producing simultaneously a set of ensembles of partial radiation beams emanating from individual spots located at their locations in one of planes 103-105. When a position of this plane in respect to the base plane is coordinated with that of a representative plane of a respective zone in respect to the reference plane, individual spatial intensity or amplitude distributions of directional radiation associated with optical characteristics of all such local object components arranged in one of zones at a time can thus be reproduced. No movement of matrix 99 and SLM 98 within that zone is required to establish all local regions of arising reproduced individual distributions except for that when positioning the respective set of ensembles of partial radiation beams in common for establishing individual spots thereof in one of planes 103-105. The procedure of positioning each set of ensembles is carried out by moving matrix 99 and SLM 98 mounted on coordinate drive 100 in the direction of the normal to the surface of medium 50 that is assigned as the base plane of the coordinate system. It is to be understood that planes 103-105 may be spaced differently as in FIG. 10 or equally like representative planes P₁, P₂, P₃ in FIG. 3, depending, e.g., on a complexity of zones. Another specific advantage of the second preferable embodiment is associated with more effective employment of microlens in matrix 99 and SLM pixels as compared with the first one, wherein peripheral microlens and pixels are employed more often. On the other hand, inside microlens and pixels can be used as well in the first preferable embodiment for reproducing individual distributions relating to some of said local object components arranged outside selected sections. This makes interval between them less visible in the obtainable 3-D optical image and provides so such additional advantages of the first preferable embodiment over known apparatus in the prior art.

Meanwhile, when parameters of partial radiation beams of one set of ensembles are coordinated with selected data relating to respective constituent distributions and individual spots of emanating these beams are established at their locations in one of planes 103-105, local regions of arising all reproduced individual distributions are completely determined. That is why, it is sufficient to establish the local region of arising reproduced individual directional radiation associated with one of such local object components in each of zones in accordance with position data relating to this local object component in the virtual space. In practice, it is expedient frequently to control positions of several local object components because of imperfections of the mechanism of drive 100, in particular. Thus reproduced individual distributions of directional radiation are directed to medium 50 along with a collimated beam 106 for forming therein a hologram portion in a corresponding combined area. Reference beam 106 is produced by adjusting parameters of the second coherent radiation beam. This is accomplished by controlling an intensity (or amplitude) of radiation of the latter beam, if necessary, orienting it in an established direction with respect to said coordinate system and changing it in size so as to provide complete covering an assigned area of medium 50 by reference beam 106 thus produced. As a result, reproduced individual distributions of directional radiation associated with optical characteristics of all such local object components arranged in one respective of zones are holographically recorded. The procedure of recording a hologram may be carried out by changing reference beam 106 in size every time when recording reproduced individual distributions associated with all such local object components arranged in the respective of zones, if the assigned area relates to a corresponding combined area in medium 50. And, on the contrary, if the assigned area is an entire area of the recording medium relating to the superimposed hologram to be formed, this procedure may be carried out by retaining the size and other parameters of beam 106 to be unchanged. The latter way is useful, if each combined area is comparable in size with said entire area. Both ways could be also employed when recording the hologram according to the first preferable embodiment. Besides, both embodiments have a definite flexibility in establishing other parameters of the reference beam that could be convergent, divergent or collimated, incident on the same surface of the recording medium in respect to reproduced individual distributions or other surface thereof at user's choice. This flexibility may be used for optimizing the procedure of recording a hologram or attaining additional advantages, but parameters of reference beam 106 thus selected remain unchanged, when recording individual distributions relating to any zone of the object. It allows using a reconstructing beam 107 with the same parameters in respect to the normal to a plate 108 containing a superimposed hologram as those of reference beam 106 in respect to the normal to the surface of recording medium 50. When illuminating plate 108 with a reconstructing beam 107, all individual distributions of directional radiation (some of them denoted by 109) that stored as 3-D representations in hologram portions are rendered simultaneously to compose an actual 3-D optical image 110 of the object or its part. Said individual distributions 109 are shown as associated with local object components arranged in representative planes relating to planes 103-105 by way of illustration only. Other individual distributions of directional radiation may be similar, for example, to those denoted by diagrams 30 or 39 in FIG. 3.

Other specific advantages of the second preferable embodiment can be attained, if parameters of the reference beam are changed during the procedure of recording reproduced individual distributions relating to different zones of the object in a step-by-step way that had never been used in the prior art and will be described below.

The respective version provides for using data representing an object composed of local components and divided into 3-D zones for its further transformations to perform an image translation and scaling zones in the virtual space. Data relating to positions and optical characteristics of such local object components arranged in each of zones (like Zone 2 or Zone 3 in FIG. 3) other than one designated below as the first zone (like Zone 1) is further transformed to represent a 3-D image of each of said other zones that being formed by virtual lens optics. Such transformations are equivalent to those performed in the real world by a lens forming an image of a 3-D object disposed at a specified position in respect thereto and its axis. The location of this image and its scaling, e.g., its magnification, can be conventionally determined from said object position and a focal length of this lens, if using the approximation of geometric optics. In particular, this image location in respect to the lens may be determined to a certain extent by using the lens law. That is why, if employing said approximation, such image-forming transformations by lens-like optics in the virtual space may be easily performed for forming a 3-D image of each of said other zones and placing it onto the first zone by selecting the focal length of such virtual lens optics. As a result, a representative plane of that zone image (called also as “zone thus transformed”) turns out to be at a position being just the same as that of the representative plane of the first zone (like P₁ in Zone 1) in respect to the reference plane. In other words, data relating to each of said other zones after transformations represents its image overlaying the first zone so that the representative plane of each zone thus transformed is in the position coincided with that of the representative plane of the first zone in the reference system. While data relating to the first zone remains unchanged. It is to be noted that such data transformations are performed individually and independently for each local object component of that other zone, due to which individuality and definite spatial specificity of its optical characteristics are retained in data thus transformed.

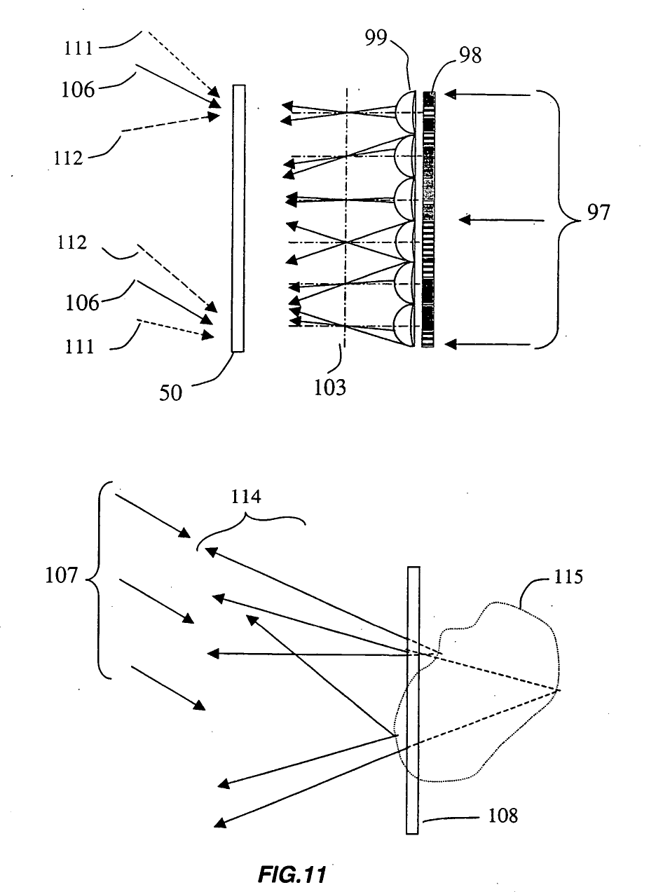

If such transformations are performed beforehand, data thus transformed could be used directly for handling means of transforming a first coherent radiation beam to provide physically reproducing in light individual distributions of directional radiation relating to all such local object components arranged in each of other zones thus transformed. The procedure of establishing local regions of arising individual distributions of directional radiation reproduced simultaneously by a respective set of ensembles of partial radiation beams is carried out in somewhat a different way than that described with reference to FIG. 10. Thus, individual spots of emanating partial radiation beams of each set of ensembles are located in one respective plane having, however, the same position (like 103 in FIG. 11), irrespective of the zone thus transformed. This comes about since representative planes of these zones are all in the position relating to that of the first zone. Means for establishing local regions of arising reproduced individual distributions of directional radiation are arranged in the proposed apparatus so as to provide establishing individual spots of emanating partial radiation beams of the set of ensembles relating to the first zone in a plane disposed at the position coordinated with that of the representative plane of the first zone and called so “a first plane”. Said means for establishing local regions remain fixed in such arrangement so that, when producing partial radiation beams of each set of ensembles relating to one of the zones thus transformed, their individual spots are established in the respective plane disposed at just the same position as that of the first plane (like 103) in respect to the base plane.

Hence, this way is essential, as no movement of microlens matrix 99 and SLM 98 is required, like that described with reference to FIG. 10 when establishing local regions of arising reproduced individual distributions relating to different zones thus transformed. An amount of time for forming the hologram may be greatly reduced, while the structure of the proposed apparatus may be essentially simplified.

When using this version of the second preferable embodiment, conditions of recording reproduced individual distributions of directional radiation associated with local object components arranged in one of zones at a time have some peculiarities. At every step after each exposure of medium 50 for recording reproduced individual distributions relating to each preceding zone, e.g. the first zone, a divergency of the reference beam is to be changed for recording reproduced individual distributions relating to the next zone. This is accomplished by adjusting parameters of the second coherent radiation beam with respect to the coordinate system to produce a reference beam having a variable divergency, change its divergency to establish its specific value and then direct as a reference beam thus adjusted towards medium 50 in the established direction in respect of the normal to the surface thereof. This procedure could be accomplished, in particular, by establishing a small spot (not labeled in FIG. 9) of emanating the reference beam (like 101 in FIG. 9) at a respective location in the coordinate system and changing its divergency so as to provide complete covering the assigned area of recording medium 50 by the reference beam thus adjusted. The specific value of its divergency to be established and the location of said small spot depend on the position of the representative plane of the respective of other zones before data transformations in respect to that of the first zone and a focal length to be selected by virtual lens optics for transforming data relating to that of other zones. The specific values and locations may be calculated in advance when using said approximation, or may be determined experimentally. But, irrespective of the way of their determination or calculation, the specific value of the divergency and the spot location are established so as to provide complete covering the assigned area of the medium 50 by the reference beam thus adjusted and, when rendering the hologram, put a 3-D image of each zone thus transformed back into the place of this zone before data transformations. This condition signifies that optical characteristics and positions of all local object components arranged in said zone are presented in 3-D visual elements to the viewer as though they were not changed at all. In short, they are changed computationally during data transformations for recording in such conditions to be changed back optically and presented like being specified initially. The range of changing said divergency may be wide enough depending on the object depth. The reference beam thus adjusted could be convergent (like 111 in FIG. 11), collimated (like 106) or divergent (like 112). Means for adjusting parameters of the second coherent radiation beam in this version may include a varifocal lens mounted on coordinate drive (similar to 100) for moving the lens along its axis, if necessary. The procedure of recording such individual distributions relating to different zones may be carried out differently: in sequence, in order of zones disposed in the virtual space, starting from any of them, e.g. from the first zone, or otherwise. This is evidence of flexibility in establishing conditions of using recording means in accordance with such version of the proposed apparatus.

Such a step-by-step way provides so creating unique conditions for forming a hologram that cause a 3-D optical image of each zone to appear, when rendering the hologram, at a location coordinated with the position of this zone in an object as that being specified before data transformations. Hence, when employing such unique conditions, each hologram portion functions not only for storing the respective 3-D representation, as in the version described with reference to FIG. 10, but also for placing properly a 3-D optical image of the respective zone in its position. In other words, each hologram portion in this version becomes functioning also as a specific holographic optical element. And so, when illuminating plate 108 with the hologram by a reconstructing beam 107, individual distributions 114 of directional radiation are rendered simultaneously to compose 3-D optical image 115 in the representation initially specified in the database. Image-plane holograms could be formed also for white-light viewing said 3-D optical image, if necessary, as shown in FIG. 11. Said unique and other conditions of using recording means for carrying out such step-by-step way are essential as they provide attaining specific additional advantages over known apparatus as well as purposes of visual applications in mentioned fields.

Thus, off-axis multiple component holographic optical elements acting as lens-like imaging device with an assigned focal length and causing a sectional image to appear at a predetermined depth along the optical axis of the known apparatus are described in U.S. Pat. No. 4,669,812 and U.S. Pat. No. 5,117,296. Known holographic optical elements are proposed to avoid problems associated with employing the complicated mechanical movement in the prior art. But, they are intended only for placing sectional images, but not for storing image information. The number of optical elements is increased with that of sectional images to be presented for providing image variability, when viewing from different viewpoints. And so, a complexity of image combining means and a bulkiness of known apparatus is also enhanced as well as other problems and limitations are arisen, as discussed in the Background.

No such additional holographic optical elements or image combining means are necessary in the proposed apparatus because hologram portions provide similar and other functions themselves, while preserving all required 3-D aspects of the optical image to be produced.

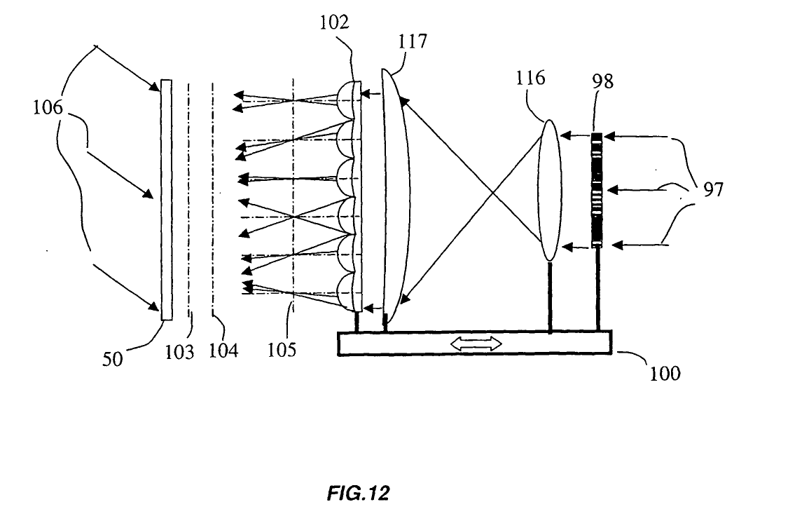

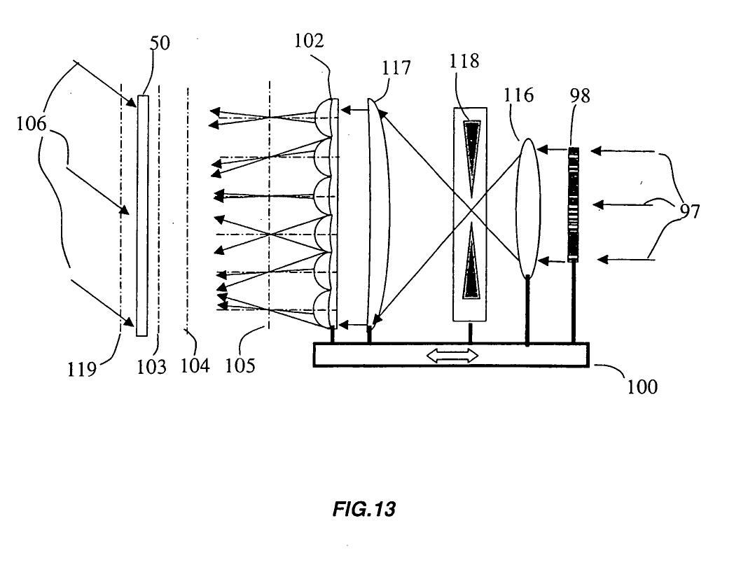

Meantime, apart from flexibility in providing diverse presentations of individual distributions of directional radiation, changing a shape (structure) of any of them and in establishing unique and other conditions of using recording means, the second preferable embodiment provides diverse modifications in the structure of means for transforming a first coherent radiation beam. These modifications could be made in both versions of the second preferable embodiment described above with reference to FIGS. 10-11, but are presented below for one of them by way of illustration only. Pixels of SLM 98 are coupled directly with microlenses of matrix 99 in said versions that makes, however, correct matching a pitch of SLM pixels with that of microlenses to be difficult because of manufacturing them in separate technologies. The possible mismatch therebetween causes distortions in a 3-D optical image like moire fringes (moire pattern) imposed thereupon. Said and other problems could be avoided in variants of the structure (see FIGS. 12-13) of means for transforming the first coherent radiation beam. Additional specific advantages could thus be attained.

One variant of the structure provides for directing beam 97 to and through SLM 98, enlarging transmitted beam fractions in size by a telescopic (telecentric) optical system formed by lenses 116 and 117 for illuminating a microlens matrix 102. All these means are mounted on coordinate drive 100. Matrix 102 may be made with a focal length other than that of matrix 99, if necessary. This variant of the structure (FIG. 12) enables optical scaling a picture of selected pixels and matching a pitch of pixels in the image of this picture at surfaces of matrix 102 with that of microlenses. Thus, this variant provides attaining the specific advantages consisting in possibility of scaling optical image to be produced without changing SLM 98 in size. Correct optical matching said pitches allow avoiding optical image distortions resulting from possible technological mismatches. Residual distortions could be removed by spatial filter 118 disposed essentially at a joint focus of lenses 116 and 117 and mounted on coordinate drive 100 as well (see FIG. 13).

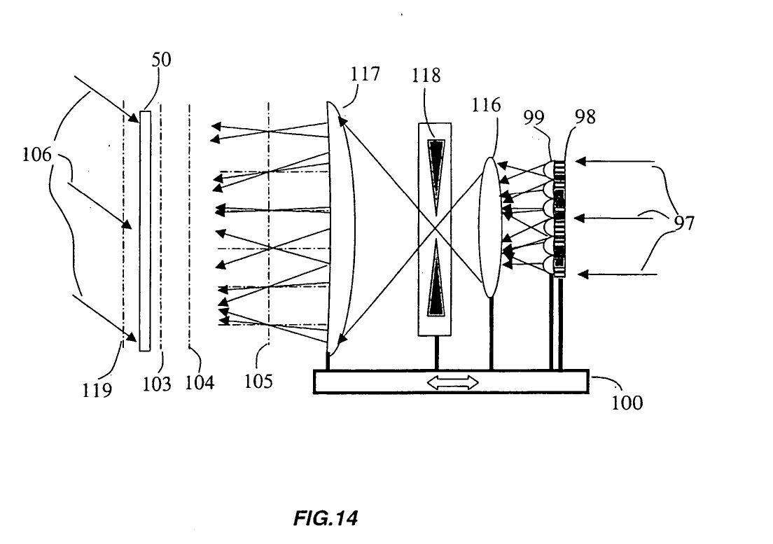

Another variant of the structure of said means is shown in FIG. 14 and provides optically scaling ensembles of partial radiation beams produced with SLM 98 and matrix 99 without increasing both of them in size. It is carried out with a telescopic (telecentric) optical system formed by lenses 116 and 117 as well as by spatial filter 118 disposed at a joint focus thereof. In this variant the first coherent radiation beam is directed to and through disposed sequentially along its axis a beam expander (not shown), SLM 98, microlens matrix 99 established parallel to the base plane and said telescopic system. Each microlens in matrix 99 is optically coupled with respective SLM pixels and disposed so as to provide matching a pitch of microlenses with that of SLM pixels. Said SLM 98, microlens matrix 99, lens 116, 117 of telescopic system and spatial filter 118 are mounted together on coordinate drive 100 installed with a possibility of moving along said axis.

It is to be noted that coordinate drive 100 is employed in one of versions of the second preferable embodiment, as shown in FIGS. 12-14, for establishing individual spots of emanating partial radiation beams of each set of ensembles in one of planes 103-105 parallel with the base plane. Whereas in other version coordinate drive 100 could be employed only for correcting an initial location of one of such planes called the first plane (like 103 in FIG. 11) in respect to the surface of recording medium 50 that is assigned as the base plane. Coordinate drive 100 and SLM 98 have control inputs connected to the computer through respective interfaces that being respective control inputs of means for establishing local regions and means for transforming the first coherent radiation beam respectively.

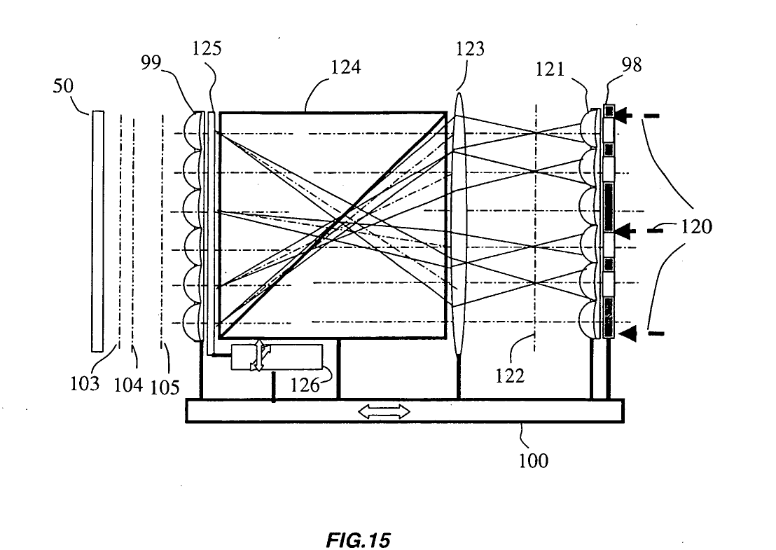

A further variant of the structure of means for transforming the first coherent radiation beam enables obtaining a higher degree of optical image resolution than that determined by SLM 98 due to creating peviously a special representative optical element. Said optical element to be created could be made of a photochromic film or other high resolution photosensitive film. The higher resolution of a photosensitive material to be used the more advantages can be attained when employing the further variant of the structure. The known photo-activated SLM may also be employed in a procedure of creating such optical element. This may be carried out with noncoherent light or coherent radiation, if necessary. This procedure and respective means will be discussed below with reference to FIG. 15.

Thus, in particular, a collimated noncoherent light beam 120 from a source (not shown in FIG. 15) is directed to disposed sequentially along its axis a spatial light modulator (SLM) 98, a first microlens matrix 121 parallel to the base plane and disposed so as to provide matching a pitch of microlenses with that of pixels of SLM 98, a lens 123, a cube beamsplitter 124 and a film of a photosensitive material 125. Each microlens is optically coupled with one of SLM pixels in the further variant for selecting one of beam fractions to be used of beam 120. Matrix 121 may be made with a focal length other than that of a second matrix 99, if necessary. Each of beam fractions is focused by its relating microlens into plane 122 parallel to the base plane and directed therefrom along said microlens axis parallel to that of lens 123 as a fractional beam (not denoted in FIG. 15) having similar parameters except for its light intensity (or amplitude). Each fractional beam thus produced with its associated intensity (amplitude) is transmitted to and through lens 123, beamsplitter 124 and focused by the lens into a light spot at a surface of the high resolution photosensitive film (or the photo-activated SLM) 125. As a result of its exposure for the period specified by the computer program, the respective pixel of the representative optical element is created (or activated) therein with a degree of modulation determined by a respective light intensity (or amplitude) established for that fractional beam. A location of the created (activated) pixel in film (SLM) 125 is determined by that of a microlens of matrix 121 in respect to the axis of lens 123, as demonstrated by a path of the selected fractional beam in FIG. 15. In a similar way all fractional beams create (activate) a collection of pixels at this step. The number of fractional beams selected by SLM 98 and produced by matrix 121 and their intensities (amplitudes) are renewed at every step under control of the computer for creating (activating) the next collections of pixels, one pixel by each selected fractional beam according to said program. This may be made in parallel, since each fractional beam is selected and produced independently. Steps of this procedure are carried out similarly by positioning film (SLM) 125 in X-Y directions perpendicular to the axis of lens 123 at the respective distances. It is expedient so that film (SLM) 125 or its holder be mounted on X-Y coordinate drive 126 having control inputs (not shown) connected through a respective interface to the computer. If positioning film (SLM) 125 at every step is accomplished by drive 126 at a distance multiple times less than the pitch of pixels in SLM 98 in X (Y) direction, an image resolution multiple times higher than that determined by SLM 98 may be obtained in said direction.

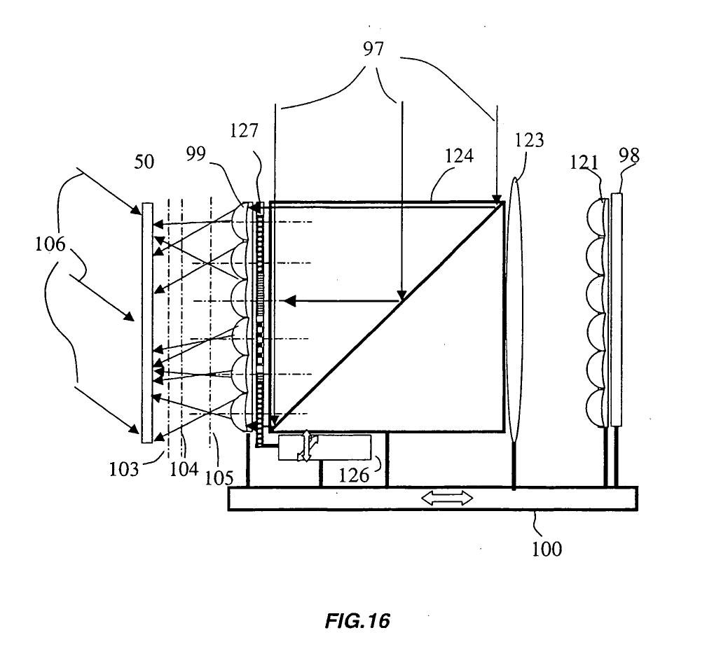

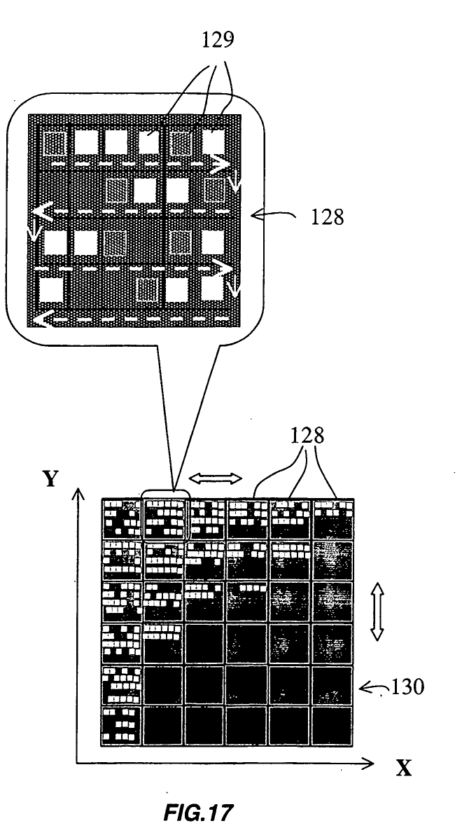

As a result of all steps of this procedure, according to the computer program, representative optical element 127 (FIG. 16) with an assigned pixel's picture having multitude pixel maps 128, as demonstrated partly in FIG. 17, is completely created (or activated). This procedure is carried out simultaneously in all pixel maps 128 and may be different depending on the way of positioning film (SLM) 125 by coordinate drive 126 for creating (activating) pixels 129 in each map 128 of said picture 130. In particular, this procedure is carried out by sequential shifting film (SLM) 125 along dashed arrows as shown in detail in the inset in FIG. 17. It is, of course, understood that various further sequences or ways will be apparent to those of ordinary skill in the art. Thus, specifically, a pitch of pixels may be established to be different in each representative optical element 127 from that in others to provide representing more realistically said peculiarities in optical properties of fine object details or in optical characteristics of separate surface fragments in the respective of zones of the object. The assigned pixel's picture implies that each of maps 128 is optically coupled with one microlens of matrix 99 and disposed so that any of pixels 129 has its assigned location in respect of an axis of said microlens. This is highly important as provides correct optical matching a pitch of pixels 129 in representative element 127 with that of microlenses in matrix 99 and even compensating the technological inaccuracy in manufacturing the piece of matrix 99 employed. Actually, this allows making such matching as perfect as possible by correcting separately, if necessary, the location of any pixel 129 in every map 128 in representative element 127, in contrast to that in previous variants described with reference to FIGS. 12-14. Moreover, such matching is carried out without increasing a complexity of the structure of said means and so provides accuracy determined by that of positioning drive 126. The flexibility of this procedure allows, hence, avoiding all problems resulting from separate technologies of manufacturing SLM 98 and microlens matrix 99 and obtaining higher 3-D optical image quality as a whole. Degrees of modulation and locations of created (activated) pixels 129 in each map 128 in respect to the axis of its relating microlens of matrix 99 encode parameters of the partial radiation beam to be produced and employed in one ensemble for reproducing one of individual distributions of directional radiation. That is why, pixels optically coupled with its microlens in such manner are called in respect thereto as assigned pixels of optical element 127. The procedure of creating (activating) representative optical element 127 is repeated until the creation of all pixels 129 in maps 128 of picture 130 is completed. Optical parameters of individual distributions of directional radiation associated with all local object components arranged in one of zones are encoded thus by locations of pixels 129 in maps 128 of an assigned picture 130 created (activated) in respective optical element 127 and by a distribution of their degrees of modulation. In other words, said optical parameters are completely represented by the assigned picture 130, and to this reason optical element 127 is called herein as a “representative optical element”.

A procedure of employing said optical element 127 in the further variant of the structure of said means in accordance with the second preferable embodiment is illustrated with reference to FIG. 16. Means for providing • first coherent radiation beam direct this beam to a beam expander (not shown) and therefrom to another face of beamsplitter 124, than that being faced to lens 123, and therefrom to said optical element 127 with pixel's picture 130. Optical element 127 has spatially distributed optical properties encoded by assigned pixels optically coupled as mentioned above with respective microlens of second matrix 99 so as to provide dividing the first coherent radiation beam into parts in accordance with selected data relating to all local object components arranged in one zone and spatial modulating each such part separately. As a result, a set of ensembles of partial radiation beams is produced simultaneously thereby reproducing individual distributions of directional radiation relating to said zone for recording them in one of hologram portions. After finishing the procedure of recording said hologram portion, this picture 130 of pixels 129 is deleted from optical element 127. Whereas coordinate drive 100 with said SLM 98, matrixes 99 and 121, lens 123, beamsplitter 124 and first drive 126 mounted all together on drive 100 is moved in a new position for establishing individual spots of emanating partial radiation beams of the next set of ensembles in the next of planes 103-105. This is accomplished in one version of the second preferable embodiment. In other version drive 100 remains in the initial position so that individual spots of emanating partial radiation beams are established at their locations in the respective plane just at the same position as the first plane (such as 103 in FIG. 11). Thereafter the procedure of creating (activating) pixels 129 of the following picture in optical element 127 is repeated with the aid of said means under control of the computer. And so, it is expedient to employ the photo-activated SLM as said film (SLM) 125. SLM 98, first 126 and second 100 drives have control inputs being those ones of respective means. It is, of course, understood that various further modifications will be apparent to those of ordinary skill in the art. Thus, a polarizing kind of cube beamsplitter 124 may be used for reducing the loss of radiation in beam 97 and light beam 120. There are no restrictions in using other means for creating representative optical elements to be employed in the further variant. For example, means for scanning film (SLM) 125 with laser light controllable in its intensity (or amplitude) may be employed in accordance with the computer program for creating (activating) pixels 129 in each map 128 of every picture 130 as described above or otherwise.

The discussion made of the further variant of the structure of said means in the proposed apparatus shows that pictures 130 of pixels 129 relating to all zones of the object contain together all necessary information to be used for forming portions of the hologram of this object. That is why, such information could be used as proper data to be transmitted (or communicated) to users for forming a hologram at remote work sites, when necessary, and attaining thus said and other additional advantages.

Described embodiments of the present invention demonstrate that diverse presentations of individual distributions of directional radiation associated with said optical characteristics of local object components as well as variants of transforming a first coherent radiation beam for reproducing them could be used in the proposed method and apparatus. Presentations, variants or further modifications of a structure of the apparatus provide attaining a variety of specific additional advantages, such as obtaining a higher degree of optical image resolution or image quality as a whole, or reducing time for forming a superimposed hologram and so forth. But, regardless of said presentation, variant or modification to be employed, this method and apparatus provides attaining said main advantages, such as facilitating a visual work, reducing a strain on the human visual system, improving other conditions for the observation and perception of the obtainable optical image. More favorable conditions of using computational means as compared with those in the prior art could be also created. Said and other advantages mentioned hereinabove are attained due to embodying the nontraditional approach in the proposed method and apparatus.

It is to be understood that embodiments described can by no means be regarded as limiting the present invention, but are to be interpreted as illustrative to promote understanding of its essence, and that various changes and improvements may be effected therein by those who skilled in the art without departing from the scope or spirit of this invention as defined in the appended claims.

1. A method for forming a hologram that can be illuminated to produce a three-dimensional optical image of an object, comprising the steps of:
a) providing a computer database with three-dimensional data representing said object, said data composed of local components, said local components being specifiable in a three-dimensional virtual space with respect to a reference system in said virtual space by at least the position and optical characteristics associated with individual spatial intensity (or amplitude) distributions of directional radiation extending from said local object components in terms of respective spatial directions and solid angles of said local object components,
b) selecting data relating to each of a representative sample of said local object components having associated individual directional radiation directions lying within an assigned field of view of said three-dimensional optical image,
c) reproducing in light said individual spatial intensity (or amplitude) distribution of directional radiation associated with each local object component in said sample of local object components using a first coherent radiation beam and transforming said first coherent radiation beam in a coordinate system in real space by varying parameters of at least one part of said coordinate system in accordance with said selected data, thus reproducing individual directional radiation, said reproduced individual directional radiation being made to arise from a local region to create a local region of arising and having optical parameters revealing-individuality and definite spatial specificity in said assigned field of view so as to provide the appearance of three-dimensional aspects of said optical image,
d) establishing each said local region of arising of said reproduced individual directional radiation with respect to said coordinate system to be at a location coordinated with the position of its associated local object component in virtual space and directing said reproduced individual directional radiation onto a corresponding area of a recording medium,
e) holographically recording said reproduced individual directional radiation using a second radiation beam coherent with said first radiation beam, adjusting parameters of said second beam with respect to said coordinate system in accordance with said selected data to produce a reference beam and directing said reference beam onto said area of said recording medium along with said reproduced individual directional radiation so as to form in said area a hologram portion for storing said reproduced individual directional radiation and preserving its optical parameters with individuality and definite spatial specificity in said assigned field of view, said hologram portion being a three-dimensional representation of said individual spatial intensity (or amplitude) distribution of directional radiation associated with each respective local object component, its optical characteristics and its position in virtual space, and
f) integrating said hologram portions by at least partially superimposing some of said hologram portions upon each other within said recording medium, forming a superimposed hologram capable, when illuminated, of simultaneously rendering all individual spatial intensity (or amplitude) distributions of directional radiation stored in all of said hologram portions, thereby producing an actual three-dimensional optical image of at least a part of said object, said actual image having a complete dimensionality and exhibiting all required three-dimensional aspects of said object.

2. The method according to claim 1, wherein said data representing said object in said computer database is divided into three-dimensional zones disposed in virtual space in the depth direction with respect to said reference system.

3. The method according to claim 1, wherein said data representing said object in the computer database is divided into sections disposed in virtual space in the depth direction with respect to said reference system.

4. The method according to claim 1, wherein said reference system is associated with said object.

5. The method according to claim 1, wherein said reference system has a reference plane.

6. The method according to claim 5, wherein a plurality of depth planes is used in said virtual space containing said object and are disposed therein in the depth direction to be parallel with said reference plane of said reference system.

7. The method according to claim 1, wherein said coordinate system is associated with said recording medium.

8. The method according to claim 7, wherein said coordinate system associated with said recording medium has a base plane.

9. The method according to claim 8, wherein, when said recording medium is being made as a flat layer, one surface of said flat layer is assigned to be said base plane.

10. The method according to claim 8, wherein, when said recording medium has a flat substrate, one of surfaces of said flat substrate is assigned to be said base plane.

11. The method according to claim 1, wherein said part of said object includes each surface area of said object that is visible from at least one segment of said assigned field of view.

12. The method according to claim 1, wherein said local object components arranged in virtual space are respective fragments of any surface area of said object.

13. The method according to claim 12, wherein, when using data representing any of said respective fragments of said surface area in said computer database, which contain several surface points, optical characteristics and position of said fragments are specified in virtual space with respect to said reference system as being averaged accordingly over all said surface points.

14. The method according to claim 1, wherein said local object components arranged in virtual space are fine details of said object or respective fragments of any other detail of said object.

15. The method according to claim 1, wherein, when using said data representing said object in said computer database, which is divided into sections disposed in virtual space in the depth direction with respect to said reference system, local components of said object include those respective fragments of any surface area of said object which are arranged in at least one of said object sections.

16. The method according to claim 1, wherein each local object component has a size not exceeding that determined by the resolution limit of an unaided eye.

17. The method according to claim 1, wherein, when using said data representing said object composed of local components for further transformations in said computer database to perform size scaling of said object in virtual space, step (a) additionally includes:
proportionally changing positions of local components of said object in virtual space with respect to said reference system and establishing resulting positions such that the distance between any two adjacent local object components does not exceed a distance determined by the resolution limit of an unaided eye.

18. The method according to claim 1, wherein step (b) is carried out with a sampling density not below a value determined by the resolution limit of an unaided eye.

19. The method according to claim 1, wherein said individual spatial intensity (or amplitude) distribution of directional radiation of said sample of local object components in said computer database is specified in virtual space with respect to said reference system by selecting a bundle of a multitude of rays, each ray in said bundle of rays being specifiable by an intensity (or amplitude) of radiation and different pre-established direction, and said each ray lying within a solid angle of said local object component's individual distribution of directional radiation and said each ray oriented along its pre-established direction as if all of said each rays were to emanate from associated local object components.

20. The method according to claim 1, wherein said individual spatial intensity (or amplitude) distribution of directional radiation of said sample of local object components in said computer database is specified in virtual space with respect to said reference system by appropriate characteristics of a directivity pattern having its origin at the position of the respective local object component and characteristics including an angular width, a spatial direction of its maximum and a radiation intensity (or amplitude) value in said spatial direction.

21. The method according to claim 20, wherein in at least one group of local object components in said computer database said optical characteristics associated with individual spatial intensity (or amplitude) distributions of directional radiation are specified by similar characteristics of respective directivity patterns in virtual space, each said pattern having the same angular width and the same spatial direction of its maximum for any local object component in the same group in order to provide the possibility of representing particular peculiarities in optical properties of each corresponding surface area of said object.

22. The method according to claim 21, wherein individual spatial intensity (or amplitude) distributions of directional radiation associated with some of said local object components in the same group are specified with partial overlapping in virtual space to provide a more realistic representation of said peculiarities in the optical properties of said surface areas of said object.

23. The method according to claim 21, wherein, when using at least two of such groups, each directivity pattern relating to the optical characteristics of local object components in one group has different characteristics in terms of angular width and/or spatial direction of maximum when compared to characteristics of any of the directivity patterns of any other group in order to provide the possibility of representing individuality and definite spatial specificity in said assigned field of view of the optical properties of each corresponding surface area of said object.

24. The method according to claim 1, wherein said individual spatial intensity (or amplitude) distribution of directional radiation of each of a minimum number of local object components in said computer database is specified in virtual space as being composed of constituent spatial intensity (or amplitude) distributions of directional radiation each originating from said local object component and being oriented in said reference system along different lines lying within a solid angle specified for said local object component's individual distribution of directional radiation as a whole in order to provide flexibility for diverse modifications in the shape of any individual distribution of directional radiation and the possibility of representing particular peculiarities in the optical characteristics of each separate corresponding surface fragment of said object.

25. The method according to claim 24, wherein constituent spatial intensity (or amplitude) distributions of directional radiation associated with each of some of said local object components are specified with partial overlapping in virtual space to provide a more realistic representation of said peculiarities in the optical characteristics of separate surface fragments of said object.

26. The method according to claim 24, wherein said individual spatial intensity (or amplitude) distribution of directional radiation of each of said local object components in said computer database is specified in virtual space by appropriate characteristics of directivity patterns each relating to one of said constituent spatial intensity (or amplitude) distributions of directional radiation associated with said local object component, having an origin at a position of said local object component and characteristics including an angular width, a spatial direction of maximum oriented along a respective line of said constituent distribution and a radiation intensity (or amplitude) value in said spatial direction.

27. The method according to claim 1, wherein said individual spatial intensity (or amplitude) distribution of directional radiation of each of at least one set of local object components in said computer database is specified in virtual space as being composed of constituent spatial intensity (or amplitude) distributions of directional radiation, each originating from a separate spot and oriented in said reference system along different lines originating from said separate spot and lying within a solid angle specified for said local object component's individual distribution of directional radiation as a whole and each individual distribution extending through its associated local object component in order to provide a flexibility of diverse modifications in the shape of any individual distribution of directional radiation and the possibility of representing particular peculiarities in optical characteristics of each corresponding separate surface fragment of said object.

28. The method according to claim 27, wherein constituent spatial intensity (or amplitude) distributions of directional radiation associated with each of some of said local object components are specified with partial overlapping in virtual space to provide a more realistic representation of said peculiarities in optical characteristics of separate surface fragments of said object.

29. The method according to claim 27, wherein said individual spatial intensity (or amplitude) distribution of directional radiation of each of said local object components in said computer database is specified in virtual space by appropriate characteristics of directivity patterns each relating to one of said constituent spatial intensity (or amplitude) distributions of directional radiation associated with said local object component, having an origin at a position of its respective separate spot and characteristics including an angular width, a spatial direction of maximum oriented along a respective line of said constituent distribution and a radiation intensity (or amplitude) value in said spatial direction.

30. The method according to claim 27, wherein, when using in said virtual space containing said object a plurality of depth planes disposed in the depth direction parallel with a reference plane of said reference system, separate spots from which originates all constituent spatial intensity (or amplitude) distributions of directional radiation associated with said respective local object components specified in said computer database are located at points of intersection of respective lines and a same depth plane, which is a representative plane for individual directional radiation associated with said local object component.

31. The method according to claim 30, wherein if said respective local object components are arranged in said representative plane for its associated individual directional radiation, a position of said point of intersection corresponds to the position of said local object component in said representative plane.

32. The method according to claim 30, wherein said representative plane associated with any of said local object components is one of said depth planes in which said local object component is arranged or which is the nearest depth plane to said local object component in the depth direction.

33. The method according to claim 30, wherein, when using data representing said object in said computer database divided into three-dimensional zones disposed in virtual space in the depth direction, one depth plane is disposed in each of said zones as a representative plane for individual directional radiation associated with each of said local object components arranged in a respective zone.

34. The method according to claim 33 wherein each of said representative planes is disposed in the middle of its respective zone.

35. The method according to claim 30, wherein said reference plane is disposed in virtual space with respect to said object at a position relating to that established for a surface of said recording medium.

36. The method according to claim 35, wherein said reference plane is disposed to pass through said object in virtual space.

37. The method according to claim 1, wherein the step (c) further includes:
transforming said first coherent radiation beam, by varying parameters of at least one part of said first coherent radiation beam, to be used for reproducing directional radiation having variable optical parameters such as solid angle, spatial direction and intensity (or amplitude) in a direction, changing said variable optical parameters with respect to said coordinate system to represent data relating to optical characteristics of any of said sample of local object components in said computer database, said directional radiation reproduced as if arising from a local region, and
establishing particular values of said optical parameters of said reproduced directional radiation to be coordinated with selected data relating to optical characteristics of said respective local object component for reproducing its associated individual directional radiation.

38. The method according to claim 37, wherein the step of transforming said first coherent radiation beam further includes:
orienting said first coherent radiation beam in said coordinate system to be along an axis of an optical focusing system having a fixed focal length,
adjusting said radiation beam in size, parallel shifting said radiation beam with respect to said axis of said optical focusing system and controlling an intensity (or amplitude) of radiation in said radiation beam to represent said variable optical parameters of directional radiation to be reproduced, and
focusing said adjusted beam into a focal spot using said optical focusing system to provide reproduced directional radiation as if arising from said focal spot, said focal spot defined as a first type of said local region.

39. The method according to claim 37, wherein the step of transforming said first coherent radiation beam further includes:
orienting said first coherent radiation beam in said coordinate system to be along an axis of an optical focusing system having a variable focal length,
adjusting said variable focal length of said optical system, parallel shifting said radiation beam with respect to said axis of said optical focusing system and controlling an intensity (or amplitude) of radiation in said radiation beam to represent said variable optical parameters of directional radiation to be reproduced, and
focusing said adjusted beam into a focal spot using said optical focusing system to provide reproduced directional radiation as if arising from said focal spot, said focal spot defined as a first type of said local region.

40. The method according to claim 37, wherein the step of transforming said first coherent radiation beam further includes:
orienting said first coherent radiation beam in said coordinate system to be along an axis of an optical focusing system, enlarging said radiation beam in size and thereafter selecting a part of said enlarged beam to be used by variably restricting its cross-section,
adjusting said selected part of said enlarged beam in size, parallel shifting said selected part with respect to said axis of said optical focusing system, and controlling an intensity (or amplitude) of radiation in said selected part to represent said variable optical parameters of directional radiation to be reproduced, and
focusing said adjusted beam into a focal spot using said optical focusing system to provide reproduced directional radiation as if arising from said focal spot, said focal spot defined as a first type of said local region.

41. The method according to claim 37, wherein the step (c) is carried out sequentially for individual directional radiation associated with each local object component of said sample of local object components.

42. The method according to claim 37, wherein the step of transforming said first coherent radiation beam further includes:
enlarging said first coherent radiation beam in size, dividing a resulting object beam into a multitude of parts by spatial modulation to form a bundle of rays and selecting each of the rays in said bundle of rays which is intended to be oriented in a different pre-established direction with respect to said coordinate system,
varying the number of rays to be selected, selecting rays intended to be oriented in required directions, and controlling an intensity (or amplitude) of radiation in each selected ray to represent said variable optical parameters of directional radiation to be reproduced, and
directing said selected rays in respective pre-established directions, oriented as if all of said selected rays emanated from a single local spot and thereby providing reproduced directional radiation as if arising from a single local spot, said single local spot defined as a second type of said local region.

43. The method according to claim 37, wherein the step of transforming said first coherent radiation beam further includes:
enlarging said first coherent radiation beam in size, dividing said enlarged beam into fractions and selecting fractions to be used to form an ensemble of partial radiation beams each having variable parameters,
orienting each selected fraction in said coordinate system separately to be along an axis of its relating optical focusing system and selecting at least one part in said each fraction to be used by variably restricting a cross-section of said each fraction,
adjusting each said part in size, parallel shifting each said part thereof with respect to said axis of said optical focusing system, and controlling an intensity (or amplitude) of radiation in said part of that fraction of said radiation beam to provide required variations in parameters of one of the respective partial radiation beams to be produced, said parameters including a solid angle, a spatial direction and an intensity (or amplitude) in said spatial direction,
focusing said resulting fractional beam using said optical focusing system into a single focal spot established for said ensemble in said coordinate system to produce said respective partial radiation beam having variable parameters such that said partial radiation beam extends along with all other partial radiation beams selected into said ensemble from said single focal spot, said single focal spot defined as a third type of said local region, for reproducing directional radiation having variable optical parameters, and
varying parameters of all partial radiation beams of said ensemble in common to represent as a result of matched variations said variable optical parameters of reproduced directional radiation to be coordinated with optical characteristics of each of at least a number of respective said local object components in said computer database.

44. The method according to claim 43, wherein, when using data representing said object in said computer database divided into sections disposed in virtual space in the depth direction to be parallel with a reference plane of said reference system, the step of transforming said first coherent radiation beam is carried out by varying parameters of required parts said first coherent radiation beam to produce simultaneously a respective number of said ensembles of partial radiation beams extending from single focal spots located all at respective locations in planes parallel with a base plane of said coordinate system and disposed with respect to said base plane at a position coordinated with a position of one of said respective object sections with respect to said reference plane and thereby physically reproduce in light said individual spatial intensity (or amplitude) distributions of directional radiation associated with optical characteristics of all said local object components arranged in one object section at a time.

45. The method according to claim 37, wherein the step of transforming said first coherent radiation beam further includes:
enlarging said first coherent radiation beam in size, dividing said enlarged beam into fractions and selecting some of said fraction to be used to form an ensemble of partial radiation beams each having variable parameters and extending through a sole local spot established for said ensemble in said coordinate system,
orienting each selected fraction in said coordinate system separately along an axis of a related optical focusing system and selecting at least one part of each selected fraction to be used by variably restricting a cross-section of said fraction,
adjusting each selected part in size, parallel shifting said adjusted part with respect to said axis of said optical focusing system, and controlling an intensity (or amplitude) of radiation in said adjusted part to provide required variations in parameters of one of the partial radiation beams to be produced, said parameters including a solid angle, a spatial direction and an intensity (or amplitude) in said spatial direction,
focusing the resulting fractional beam using said optical focusing system into a respective individual spot to produce said partial radiation beam emanating from said individual spot having variable parameters and provide extension of said partial radiation beam along with all of the partial radiation beams selected into said ensemble through said sole local spot, said sole local spot defined as a fourth type of said local region for reproducing directional radiation having variable optical parameters, and
varying parameters of all partial radiation beams of said ensemble in common to represent as a result of matched variations said variable optical parameters of said reproduced directional radiation to be coordinated with optical characteristics of each of at least a set of said respective local object components in said computer database.

46. The method according to claim 45, wherein, when having in said virtual space containing the object a plurality of depth planes disposed in the depth direction to be parallel with a reference plane of said reference system, individual spots of all emanating partial radiation beams selected into said ensemble are located at respective locations in one plane parallel with a base plane of said coordinate system and disposed with respect to said base plane at a position coordinated with a position of one respective depth plane being a representative plane for individual directional radiation associated with said respective local object component to thereby physically reproduce in light said individual spatial intensity (or amplitude) distribution of directional radiation as a whole associated with optical characteristics of each respective local object component.

47. The method according to claim 45, wherein, when having in said virtual space containing the object a plurality of depth planes disposed in the depth direction parallel with a reference plane of said reference system and using data representing said object in said computer database divided into three-dimensional zones disposed in the same direction so to have in each of said zones one of said depth planes as a representative plane for individual directional radiation associated with each of said local object components arranged in a respective zone, the step of transforming said first coherent radiation beam is carried out by varying parameters of the required parts of said first coherent radiation beam to produce simultaneously a respective set of said ensembles of partial radiation beams emanating from individual spots located in one respective plane parallel with a base plane of said coordinate system and disposed with respect to said base plane at a position coordinated with a position of said representative plane of said respective zone with respect to said reference plane and thereby physically reproducing in light said individual spatial intensity (or amplitude) distributions of directional radiation associated with optical characteristics of all said local object components arranged in one of said zones at a time.

48. The method according to claim 1, wherein in step (c), when said individual distribution is specified as composed of constituent spatial intensity (or amplitude) distributions of directional radiation in virtual space with respect to said reference system, further includes:
transforming said first coherent radiation beam by varying parameters of respective parts of said first coherent radiation beam to be used for producing an ensemble of partial radiation beams each having variable parameters such as solid angle, spatial direction and intensity (or amplitude) in said spatial direction, changing parameters of each partial radiation beam selected into said ensemble with respect to said coordinate system to represent data relating to said constituent distributions associated with appropriate optical characteristics of any of said sample of local object components in said computer database and provide reproduced directional radiation by all of said partial radiation beams of said ensemble in common as if arising from a local region;
establishing particular values of parameters of each partial radiation beam of said ensemble, which are coordinated with selected data relating to respective constituent distributions of directional radiation associated with appropriate optical characteristics of a respective local object component for reproducing said constituent distribution and, along with all of said partial radiation beams of said ensemble, said individual directional radiation associated with said local object component as a whole.

49. The method according to claim 48, wherein the step of transforming said first coherent radiation beam further includes:
enlarging said first coherent radiation beam in size, dividing said enlarged beam into fractions and selecting fractions to be used for producing said ensemble of partial radiation beams each having variable parameters,
orienting each selected fraction in said coordinate system separately along an axis of a related optical focusing system and selecting at least one part in said fraction to be used by variably restricting a cross-section of said fraction,
adjusting each selected part of said fraction in size, parallel shifting each adjusted part with respect to said axis of said optical focusing system, and controlling the intensity (or amplitude) of radiation of each adjusted part in order to represent said variable parameters of one partial radiation beam to be produced, and
focusing the resulting fractional beam using said optical focusing system into a sole focal spot established for said ensemble in said coordinate system to produce said partial radiation beam having variable parameters and provide for extension of said partial radiation beam along with all of the other partial radiation beams selected into said ensemble from said sole focal spot, creating a special type of said local region, thus reproducing directional radiation which is coordinated with appropriate optical characteristics of each of at least a number of respective said local object components in said computer database.

50. The method according to claim 49, wherein, when using data representing said object in said computer database, which is divided into sections disposed in virtual space in the depth direction parallel with a reference plane of said reference system, the step of transforming said first coherent radiation beam is carried out by varying parameters of required parts of said first radiation beam to produce simultaneously a respective number of said ensembles of partial radiation beams extending from sole focal spots all located at respective locations in one plane parallel with a base plane of said coordinate system and disposed with respect to said base plane at a position coordinated with a position of one of the respective object sections with respect to said reference plane and provide thereby a physical reproduction in light of said individual spatial intensity (or amplitude) distributions of directional radiation associated with all of said local object components arranged in one of said object sections at a time.

51. The method according to claim 48, wherein the step of transforming said first coherent radiation beam further includes:
enlarging said first coherent radiation beam in size, dividing said enlarged beam into fractions and selecting fractions to be used for producing said ensemble of partial radiation beams each having variable parameters and extending through a sole local spot established for said ensemble in said coordinate system,
orienting each selected fraction in said coordinate system separately along an axis of a relating optical focusing system and selecting at least one part in said fraction to be used by variably restricting a cross-section of said fraction,
adjusting each selected part of the fraction in size, parallel shifting each adjusted part with respect to said axis of said optical focusing system, and controlling the intensity (or amplitude) of radiation of each part in order to represent said variable parameters of one partial radiation beam to be produced, and
focusing the resulting fractional beam using said optical focusing system into a respective individual spot to produce said partial radiation beam emanating from said individual spot and having variable parameters and provide for extension of said partial radiation beam along with all of partial radiation beams selected into said ensemble through said sole local spot, defined as a special type of said local region, thus reproducing directional radiation to be coordinated with appropriate optical characteristics of each of at least a set of said respective local object components in said computer database.

52. The method according to claim 51, wherein, when having in the virtual space containing said object a plurality of depth planes disposed in the depth direction parallel with a reference plane of said reference system and using data representing said object in said computer database which is divided into three-dimensional zones disposed in the same direction so to have in each of said zones one of said depth planes as a representative plane for individual directional radiation associated with each of said local object components arranged in said respective zone, the step of transforming said first coherent radiation beam is carried out by varying parameters of the required parts of said first coherent radiation beam to produce simultaneously a respective set of said ensembles of partial radiation beams emanating from individual spots located in one respective plane parallel with a base plane of said coordinate system and disposed with respect to said base plane at a position coordinated with a position of said representative plane of said respective zone with respect to said reference plane and provide thereby a physical reproduction in light of said individual spatial intensity (or amplitude) distributions of directional radiation associated with all of said local object components arranged in one of said zones at a time.

53. The method according to claim 1, wherein step (d) is carried out by positioning of said local region of arising as a whole, maintaining optical parameters of said local region in three dimensions with respect to a surface of said recording medium in said coordinate system in accordance with selected position data relating to an associated local object component.

54. The method according to claim 53, wherein the step of positioning reproduced individual directional radiation in three dimensions is carried out to allow for movement of said local region of arising along a normal to said surface of said recording medium to represent z data relating to the position of said local object component in virtual space, while moving said recording medium perpendicularly to its surface normal to represent x and y data relating to said position.

55. The method according to claim 53, wherein the step of positioning reproduced individual directional radiation in three dimensions is carried out to allow for moving said local region of arising perpendicularly to a normal to said surface of said recording medium to represent x and y data relating to the position of said local object component in virtual space, while moving said recording medium along its surface normal to represent z data relating to said position.

56. The method according to claim 53 wherein step (d) is carried out sequentially for individual directional radiation associated with each respective local object component of said sample of local object components in virtual space.

57. The method according to claim 1, wherein, when using data representing said object in said computer database which is divided into sections disposed in virtual space in the depth direction and physically reproducing in light individual spatial intensity (or amplitude) distributions of directional radiation associated with all of said local object components arranged in one of said object sections at a time, the step of establishing said local region of arising is carried out for individual directional radiation associated with one of said local object components arranged in each of said object sections in accordance with selected position data relating to said local object component in virtual space.

58. The method according to claim 1, wherein, when using data representing said object in said computer database which is divided into three-dimensional zones disposed in virtual space in the depth direction and physically reproducing in light individual spatial intensity (or amplitude) distributions of directional radiation associated with all of said local object components arranged in one of said zones at a time, the step of establishing said local region of arising of is carried out for individual directional radiation associated with one of said local object components in each of said zones in accordance with selected position data relating to said local object component in virtual space.

59. The method according to claim 1 wherein step (e) is carried out sequentially for individual directional radiation associated with each of at least some of said sample of local object components and the step of adjusting parameters of said second coherent radiation beam in accordance with selected data further includes:
controlling an intensity (or amplitude) of radiation in said second coherent radiation beam and orienting it in an established direction with respect to said coordinate system, and
parallel shifting said second coherent radiation beam with respect to itself and changing its size to provide complete coverage by said reference beam thus producing a corresponding area of said recording medium relating to said respective reproduced individual spatial intensity (or amplitude) distribution of directional radiation associated with each local object component.

60. The method according to claim 1, wherein, when using data representing said object in said computer database which is divided into sections disposed in virtual space in the depth direction, the step of holographically recording said reproduced individual directional radiation is carried out for individual spatial intensity (or amplitude) distributions of directional radiation associated with all of said local object components arranged in one of said object sections at a time and the step of adjusting parameters of said second coherent radiation beam in accordance with selected data further includes:
controlling an intensity (or amplitude) of radiation in said second coherent radiation beam and orienting it in an established direction with respect to said coordinate system, and
changing said second coherent radiation beam in size to provide complete coverage by said reference beam thus producing a corresponding combined area of said recording medium relating to reproduced individual spatial intensity (or amplitude) distributions of directional radiation associated with optical characteristics of all local object components arranged in the respective object section.

61. The method according to claim 1, wherein, when using data representing said object in said computer database which is divided into three-dimensional zones disposed in virtual space in the depth direction, the step of holographically recording said reproduced individual directional radiation is carried out for individual spatial intensity (or amplitude) distributions of directional radiation associated with all of said local object components arranged in one of said zones at a time and the step of adjusting parameters of said second coherent radiation beam in accordance with selected data further includes:
controlling an intensity (or amplitude) of radiation in said second coherent radiation beam and orienting it in an established direction with respect to said coordinate system, and
changing said second coherent radiation beam in size to provide complete coverage by said reference beam thus producing an assigned area of said recording medium and thereby holographically recording reproduced individual distributions of directional radiation associated with all of said local object components arranged in said respective zone.

62. The method according to claim 61, wherein said assigned area is an entire area of said recording medium relating to said superimposed hologram.

63. The method according to claim 61, wherein said assigned area is a corresponding combined area of said recording medium relating to reproduced individual distributions of directional radiation associated with all of said local object components arranged in said respective zone.

64. The method according to claim 1, wherein, when having in said virtual space containing said object a plurality of depth planes disposed in the depth direction which are parallel with a reference plane of said reference system, using data representing said object in said computer database which is divided into three-dimensional zones disposed in the same direction so as to have in each of said zones a depth plane which is a representative plane for individual directional radiation associated with each of said local object components arranged in said respective zone, and specifying said individual spatial intensity (or amplitude) distribution of said directional radiation as being composed of constituent spatial intensity (or amplitude) distributions of directional radiation originating from separate spots located in said representative plane, the step of physical reproduction in light is carried out for individual spatial intensity (or amplitude) distributions of directional radiation associated with all of said local object components arranged in one of said zones at a time, and
the step of transforming said first coherent radiation beam is carried out by varying parameters of required parts of said first coherent radiation beam to produce simultaneously a respective set of ensembles of partial radiation beams emanating all from individual spots located in a respective plane which is parallel with a base plane of said coordinate system and disposed with respect to said base plane at a position coordinated with the position of said representative plane of said respective zone with respect to said reference plane, each of said partial radiation beams in said respective ensemble having variable parameters to be coordinated with selected data relating to one of said constituent distributions of directional radiation associated with appropriate optical characteristics of said respective local object component in said respective zone for reproducing said constituent distribution and, along with all of said partial radiation beams of said ensemble to which said constituent distribution belongs, a whole individual directional radiation associated with said local object component, reproducing an individual directional radiation pattern arising from a local region and having optical parameters which reveal individuality and definite spatial specificity in said assigned field of view to provide the appearance of three-dimensional aspects in said optical image.

65. The method according to claim 64, wherein, when using data representing said object composed of local components and divided into three-dimensional zones for further transformations in said computer database to perform image translation and scaling of zones in virtual space,
the step of providing a computer database with three-dimensional data comprises additionally a step of transforming data relating to positions and optical characteristics of said local object components arranged in each of said zones other than one designated as a first zone to represent a three-dimensional image of such other zones in virtual space by lens optics and placed by appropriate selection of focal length onto said first zone to have a representative plane of said respective zone transformed at a position being the same as that of said representative plane of said first zone with respect to said reference plane,
the step of transforming a first coherent radiation beam is carried out to provide physical reproduction in light of the individual spatial intensity (or amplitude) distributions of directional radiation, associated with optical characteristics of all such local object components arranged in the respective thus transformed zone other than the first, the reproduction being by the respective set of ensembles of partial radiation beams emanating from individual spots located in said respective plane disposed with respect to said base plane at the position being the same as that coordinated with the position of said representative plane of said first zone,
the step of holographically recording said reproduced individual directional radiation is carried out for individual spatial intensity (or amplitude) distributions of directional radiation associated with all said local object components arranged in one zone at a time and, when using data for any of said transformed zones, further includes:
adjusting parameters of said second coherent radiation beam with respect to said coordinate system to produce a reference beam having a variable divergency and emanating in an established direction from a small spot located with respect to said base plane at a different location depending on a respective focal length selected by said lens optics when transforming data relating to said respective zone other than said first zone, and
establishing said small spot at said respective location and changing the divergency of said small spot to provide complete coverage by said reference beam of an assigned area of said recording medium and thereby holographically recording said reproduced distributions of directional radiation relating to said respective zones.

66. A method for forming a hologram that can be illuminated to produce a three-dimensional optical image of an object, comprising the steps of:
a) providing a computer database with 1) three-dimensional data representing said object composed of local components and divided into three-dimensional zones disposed in virtual space in the depth direction with respect to a reference system, and 2) a plurality of depth planes disposed in the same direction parallel with a reference plane of said reference system with one depth plane in each of said zones, and in said database each local component is specified by at least position and optical characteristics associated with an individual spatial intensity (or amplitude) distribution of directional radiation extending from said local component in a respective spatial direction and in a respective solid angle and being composed of constituent spatial intensity (or amplitude) distributions of directional radiation originating from separate spots located in said respective depth plane which is a representative plane for individual directional radiation associated with each of said local object components arranged in said respective zone,
b) selecting data relating to each of a representative sample of said local object components having an associated individual directional radiation lying within an assigned field of view of said three-dimensional optical image,
c) physically reproducing in light individual spatial intensity (or amplitude) distributions of directional radiation associated with optical characteristics of all said local object components arranged in one zone at a time using a first coherent radiation beam and transforming said first radiation beam in a coordinate system by varying parameters of required parts if said first radiation beam to produce simultaneously a respective set of ensembles of partial radiation beams all emanating from individual spots located in a respective plane parallel with a base plane of said coordinate system and disposed with respect to said base plane at a position coordinated with a position of said representative plane of said respective zone with respect to said reference plane, each of said partial radiation beams in said respective ensemble having variable parameters to be coordinated with selected data relating to one of constituent distributions of directional radiation associated with appropriate optical characteristics of said respective local object component in said respective zone for reproducing said constituent distribution and, along with all other partial radiation beams of said respective ensemble, a whole individual directional radiation pattern associated with said local object component, said reproduced individual directional radiation arising from a local region and having optical parameters revealing individuality and definite spatial specificity in an assigned field of view to provide the appearance of three-dimensional aspects of said optical image,
d) establishing a local region of arising of reproduced individual directional radiation associated with each said local object components in said respective zone with respect to said coordinate system to be at a location coordinated with the position of said local object component in said zone and directing said reproduced individual spatial intensity (or amplitude) distributions of directional radiation associated with optical characteristics of all said local object components arranged in said respective zone onto a corresponding combined area of a recording medium,
e) holographically recording said reproduced distributions of directional radiation relating to said respective zone using a second radiation beam coherent with said first radiation beam, adjusting parameters of said second radiation beam with respect to said coordinate system in accordance with selected data and directing a produced reference beam onto said combined area of said recording medium along with said reproduced distributions of directional radiation to form in said combined area a single hologram portion for storing said reproduced distributions of directional radiation and preserve optical parameters of each respective individual distribution of directional radiation with its individuality and definite spatial specificity in said assigned field of view, said single hologram portion being a three-dimensional representation of respective individual spatial intensity (or amplitude) distributions of directional radiation, optical characteristics and positions in virtual space associated with said local object components arranged in said respective zone, and
f) integrating all of said single hologram portions by at least partially superimposing some of said single hologram portions upon each other within said recording medium for forming a superimposed hologram capable, when illuminated, of rendering simultaneously respective individual spatial intensity (or amplitude) distributions of directional radiation stored in all of said single hologram portions thereby producing an actual three-dimensional optical image of at least a part of said object, said actual image having a complete dimensionality and exhibiting all required three-dimensional aspects of said object.

67. The method according to claim 66, wherein each of said constituent spatial intensity (or amplitude) distributions of directional radiation associated with each local object component arranged in each of said zones originates from a respective separate spot located at a point of intersection of said representative plane in said respective zone and a different line, is oriented in said reference system along said line lying within a solid angle specified for a respective individual distribution of directional radiation as a whole and extending through an associated local object component, and is specified in virtual space by appropriate characteristics of a relating directivity pattern having an origin at a position of said respective separate spot and characteristics including an angular width, a spatial direction of maximum oriented along said respective line of said constituent distribution and a radiation intensity (or amplitude) value in said spatial direction.

68. The method according to claim 66, wherein the step of transforming said first coherent radiation beam further includes:
enlarging said first coherent radiation beam in size, dividing said enlarged beam into fractions and selecting those fraction to be used for producing said respective ensemble of partial radiation beams with variable parameters,
orienting each selected fraction in said coordinate system separately to be along an axis of a related optical focusing system and selecting a respective part in said fraction for producing said partial radiation beams of said respective ensemble by variably restricting a cross-section of said fraction,
adjusting said selected part of said fraction in size, parallel shifting said adjusted part with respect to said axis of said optical focusing system, and controlling an intensity (or amplitude) of radiation in said adjusted part to represent accordingly variable parameters of said partial radiation beam such as solid angle, spatial direction and intensity (or amplitude) in said spatial direction, and
focusing the resulting fractional beam using said optical focusing system into a respective individual spot to produce said partial radiation beam emanating from said individual spot and having variable parameters, changing said variable parameters with respect to said coordinate system and establishing particular values to be coordinated with appropriate optical characteristics of said respective local object component, said optical characteristics relating to one of associated constituent distributions of directional radiation, to produce said respective partial radiation beam emanating from said individual spot with said respective individual distribution of directional radiation extending through said local region of origin and thereby reproduce said constituent distribution of directional radiation.

69. The method according to claim 66, wherein the step of adjusting parameters of said second coherent radiation beam in accordance with selected data further includes:
controlling an intensity (or amplitude) of radiation in said second coherent radiation beam and orienting said second radiation beam in an established direction with respect to said coordinate system, and
changing said second coherent radiation beam in size to provide complete coverage, by the reference beam thus produced, of an assigned area of said recording medium and thereby holographically recording said reproduced individual spatial intensity (or amplitude) distributions of directional radiation associated with all of said local object components arranged in said respective zone.

70. The method according to claim 69, wherein said assigned area is an entire area of said recording medium relating to said superimposed hologram.

71. The method according to claim 64, wherein, when using data representing said object composed of local components and divided into three-dimensional zones for further transformations in said computer database to perform image translation and scaling of zones in virtual space,
the step of providing a computer database with three-dimensional data additionally includes transforming data relating to positions and optical characteristics of said local object components arranged in each of said zones other than one designated as a first zone to represent a three-dimensional image of respective said other zone in virtual space by lens optics and placed by an appropriate selection of focal length onto said first zone so to have a representative plane of said respective zone transformed at a position the same as that of said representative plane of said first zone with respect to said reference plane,
the step of transforming said first coherent radiation beam is carried out to provide physical reproduction in light of individual spatial intensity (or amplitude) distributions of directional radiation, associated with optical characteristics of all said local object components arranged in a respective transformed zone other than said first, said reproduction by a respective set of ensembles of partial radiation beams emanating from individual spots located in said respective plane disposed with respect to said base plane at the position the same as that coordinated with the position of said representative plane of said first zone,
the step of holographically recording said reproduced individual directional radiation is carried out for individual spatial intensity (or amplitude) distributions of directional radiation associated with all of said local object components arranged in one zone at a time and, when using data for any of said transformed zones, further includes:
adjusting parameters of said second coherent radiation beam with respect to said coordinate system to produce a reference beam having a variable divergency and emanating in an established direction from a small spot located with respect to said base plane at a different location depending on said respective focal length selected by said lens optics when transforming data relating to said respective other zones, and
establishing said small spot and changing the divergency of said small spot to provide complete coverage by said reference beam of an assigned area of said recording medium and thereby holographically recording said reproduced distributions of directional radiation relating to said respective zones.

72. The method according to claim 71, wherein the step of adjusting parameters of said second coherent radiation beam further includes:
orienting said second coherent radiation beam in said coordinate system to be in an established direction along an axis of a lens system and adjusting said second radiation beam in size to represent a required range of varying divergency of a produced reference beam, and
focusing said second radiation beam into said small spot using said lens system to produce said reference beam emanating from said spot and having variable divergency, and positioning said reference beam as a whole, while maintaining remaining optical parameters of said reference beam, together with said lens system, with respect to said base plane to establish a spot of emanation of said reference beam at said respective location.

73. An apparatus for forming a hologram that can be illuminated to produce a three-dimensional optical image of an object, comprising:
a) computational means including:
a computer database provided with three-dimensional data representing said object as composed of local components in a three-dimensional virtual space in respect to a reference system and relating to at least a position of each local component and optical characteristics associated with an individual spatial intensity (or amplitude) distribution of directional radiation extending from said local object component in a respective spatial direction and in a respective solid angle and lying within an assigned field of view of said optical image, and
a computer for selecting data relating to each of a representative sample of said local object components separately and handling other means of the said in carrying out functions and operation, or in providing conditions of employment of said other means, when necessary, in accordance with selected data;
b) means for reproducing said individual directional radiation, including:
means for providing a first coherent radiation beam,
means for transforming said first coherent radiation beam in a coordinate system by varying parameters of at least one part of said first radiation beam to be used in accordance with selected data for physically reproducing in light an individual special intensity or amplitude distribution of directional radiation having optical parameters coordinated with optical characteristics of an associated local object component, revealing individuality and definite spatial specificity in said assigned field of view to provide the appearance of three-dimensional aspects in said optical image and arising from a local region, and
means for establishing said local region of arising individual directional radiation reproduced with respect to said coordinate system at a location coordinated with the position of said associated local object component in virtual space and for directing said reproduced individual radiation to be holographically recorded onto a corresponding area of a recording medium,
all said means having control inputs connected to said computer; and
c) means for holographic recording of said reproduced individual directional radiation, including:
means for providing a second radiation beam coherent with said first radiation beam,
means for adjusting parameters of said second coherent radiation beam with respect to said coordinate system in accordance with selected data and for directing a reference beam thus produced onto said area of said recording medium along with said reproduced individual directional radiation so as to form in said area a hologram portion storing said reproduced individual directional radiation and preserving its individuality and definite spatial specificity in said assigned field of view, a respective spatial intensity or amplitude distribution of directional radiation stored in said hologram portion being a three-dimensional representation of optical characteristics of its associated local object component in the virtual space, and
recording means provided with said recording medium and adapted for integrating hologram portions in said recording medium by at least partial superimposing of some of said hologram portions upon each other for forming together a superimposed hologram capable, when illuminated, of rendering simultaneously said respective spatial intensity (or amplitude) distributions of directional radiation store in all hologram portions, thereby producing an actual three-dimensional optical image of at least a part of said object, said actual image having a complete dimensionality and exhibiting all required three-dimensional aspects of said object,
all said means having control inputs connected to said computer.

74. The apparatus according to claim 73, wherein means for transforming said first coherent radiation beam are adapted for reproducing distributions of directional radiation simultaneously in groups, one group at a time, said directional radiation having variable optical parameters, such as a solid angle, a spatial direction and an intensity (or amplitude) in said spatial direction, to be changed with respect to said coordinate system to establish particular values coordinated with selected data relating to optical characteristics of said respective local object component and reproduce its associated individual directional radiation.

75. The apparatus according to claim 74 wherein, when using data representing said object in said computer database as divided into sections parallel to a reference plane of said reference system and disposed in said virtual space in the depth direction, means for transforming said first coherent radiation beam are adapted for reproducing simultaneously in groups individual spatial intensity (or amplitude) distributions of directional radiation relating to all local object components arranged in one of said object sections at a time and arising from local regions located locations in respective planes parallel to a base plane of said coordinate system and disposed with respect to said base plane at a position coordinated with a position of said object section with respect to said reference plane.

76. The apparatus according to claim 75, wherein means for transforming said first coherent radiation beam include disposed along an axis of said first radiation beam a beam expander, a spatial light modulator (SLM) and a microlens matrix parallel to said base plane, each microlens being optically coupled with respective SLM pixels and disposed so as to match a pitch of microlenses with that of SLM pixels, while means for establishing local regions of arising for individual directional radiation thus reproduced include a coordinate drive installed capable of moving along said axis with said SLM and said microlens matrix mounted on said drive for positioning individual distributions of directional radiation reproduced and establishing local regions of said directional radiation in one respective plane parallel to the said plane, said SLM and coordinate drive having control inputs being those of said means respectively.

77. An apparatus for forming a hologram that can be illuminated to produce a three-dimensional optical image of an object, comprising:
a) computational means including:
a computer database provided with three-dimensional data representing said object as composed of local components and divided into three-dimensional zones disposed in a virtual space in the depth direction in respect to a reference system having a reference plane and with a plurality of depth planes parallel to said reference plane and disposed in the same direction so as to have one of said depth planes in each of said zones wherein said data relates to at least a position of each local object component and optical characteristics associated with an individual spatial intensity or amplitude distribution of directional radiation extending from said local object component in a respective spatial direction and in a respective solid angle, lying within an assigned field of view of said optical image and being composed of constituent spatial intensity (or amplitude) distributions of directional radiation originating from separate spots located in said respective depth plane being a representative plane for individual directional radiation associated with each of said local object components arranged in said respective zone, and
a computer for selecting data relating to each of a representative sample of said local object components separately and handling other means of said apparatus in carrying out functions and operation, or in providing conditions of employment of said other means, when necessary, in accordance with selected data;
b) means for reproducing individual distributions of directional radiation, including
means for providing a first coherent radiation beam,
means for transforming said first coherent radiation beam in a coordinate system by varying parameters of respective parts of said first radiation beam to be used in accordance with selected data to produce simultaneously a set of ensembles of partial radiation beams emanating from individual spots located at locations in one plane parallel to a base plane of said coordinate system and disposed with respect to said base plane at a position coordinated with a position of a representative plane of a respective zone with respect to said reference plane, in any of said ensembles each of said partial radiation beams having parameters coordinated with selected data relating to one of constituent distributions of directional radiation associated with appropriate optical characteristics of respective said local object components in said zone for reproducing said constituent distribution and, along with all of said partial radiation beams of said ensemble, an individual spatial intensity (or amplitude) distribution of directional radiation having optical parameters coordinated with said optical characteristics of said local object component, revealing individuality and definite spatial specificy in said assigned field of view to provide the appearance of three-dimensional aspects in said optical image and arising from a local region, and to provide, thereby, a physical reproduction in light of individual spatial intensity (or amplitude) distributions of directional radiation associated with optical characteristics of all said local object components arranged in one of said zones at a time, and
means for establishing said local regions of arising for reproduced individual distributions of directional radiation with respect to said coordinate system at locations coordinated with positions of associated local object components arranged in said respective zones and for directing said reproduced individual distributions of directional radiation to be recorded holographically onto a corresponding combined area of a recording medium,
all said means having control inputs connected to said computer; and
c) means for holographic recording of said reproduced individual distributions of directional radiation, including:
means for providing a second radiation beam coherent with said first radiation beam,
means for adjusting parameters of said second coherent radiation beam with respect to said coordinate system in accordance with selected data and for directing a reference beam thus produced onto said combined area of said recording medium along with said reproduced individual distributions of directional radiation so as to form in said area a single hologram portion storing each of said reproduced individual distributions of directional radiation and preserving its individuality and definite spatial specificity in said assigned field of view, a respective of spatial intensity or amplitude distributions of directional radiation stored in said single hologram portion being a three-dimensional representation of optical characteristics of an associated local object component arranged in said zone in the virtual space, and
recording means provided with said recording medium and adapted for integrating all of said single hologram portions in said recording medium by at least partial superimposing some of said single hologram portions upon each other for forming a superimposed hologram capable, when illuminated, of rendering simultaneously said spatial intensity (or amplitude) distributions of directional radiation stored in all of said hologram portions, thereby producing an actual three-dimensional optical image of a least a part of said object, said actual image having a complete dimensionality and exhibiting all required three-dimensional aspects of said object in said superimposed hologram,
all said means having control inputs connected to said computer.

78. The apparatus according to claim 77, wherein means for transforming said first coherent radiation beam include disposed along an axis of said first radiation beam a beam expander, a spatial light modulator (SLM) and a microlens matrix parallel to said base plane, each microlens being optically coupled with respective SLM pixels and disposed so as to match a pitch of microlenses with that of SLM pixels, while means for establishing local regions of arising of reproduced individual distributions of directional radiation include a coordinate drive installed capable of moving along said axis with said SLM and said microlens matrix mounted on said drive for positioning each set of ensembles of partial radiation beams and establishing individual spots in one plane parallel to said base plane, said SLM and said drive having control inputs being those of said means, respectively.

79. The apparatus according to claim 78, wherein means for transforming said first coherent radiation beam include a telescopic system disposed between said SLM and said microlens matrix, mounted on said drive.

80. The apparatus according to claim 79, wherein means for transforming said fist coherent radiation beam include a spatial filter disposed at a joint focus of lenses of said telescopic system, mounted on said drive.

81. The apparatus according to claim 77, wherein means for transforming said first coherent radiation beam include disposed sequentially along an axis of said first radiation beam a beam expander, a spatial light modulator (SLM), a microlens matrix parallel to said base plane and a telescopic system with a spatial filter disposed at a joint focus of lenses of said telescopic system, each microlens being optically coupled with respective SLM pixels and disposed so as to match a pitch of microlenses with that of pixels, while means for establishing local regions of arising of reproduced individual distributions of directional radiation include a coordinate drive installed capable of moving along said axis with said SLM, microlens matrix, telescopic system and spatial filter all mounted on said drive for positioning each set of ensembles of partial radiation beams and establishing individual spots in one plane parallel to said base plane, said SLM and said coordinate drive having control inputs being those of said means respectively.

82. The apparatus according to claim 77, wherein, if data relating to positions and optical characteristics of said local object components arranged in each of said zones other than one designated as a first zone is further transformed to represent a three-dimensional image of each of said other zones, being formed by virtual lens optics and placed onto said first zone by selecting a focal length of said lens optics so as to have the representative plane of each of said zones thus transformed at a position being the same as that of a representative plane of said first zone, then
means for establishing local regions of arising of reproduced individual distributions of directional radiation are arranged so as to provide for establishing individual spots of emanating partial radiation beams relating to said first zone in a first plane disposed at a position coordinated with that of said representative plane of said first zone and remain fixed in said arrangement so that, when producing partial radiation beams relating to each of said zones thus transformed, said individual spots are established in said respective plane disposed at the same position as that of said first plane,
while means for adjusting parameters of said second coherent radiation beam are adapted for producing a reference beam having a variable divergency and changing its divergency for establishing a specific value so as to provide complete covering of said assigned area of said recording medium by said adjusted reference beam and, when rendering said hologram, put a 3-D image of each zone thus transformed back into the place of this zone before data transformations.

83. An apparatus for forming a hologram that can be illuminated to produce a three-dimensional optical image of an object, comprising:
a) computational means including:
a computer database provided with three-dimensional data representing said object as composed of local components and divided into three-dimensional zones disposed in a virtual space in the depth direction with respect to a reference system having a reference plane and with a plurality of depth planes parallel to said reference plane and disposed in the same direction so as to have one of said depth planes in each of said zones wherein said data relates to at least a position of each local object component and optical characteristics associated with an individual spatial intensity or amplitude distribution of directional radiation extending from said local object component in a respective spatial direction and in a respective solid angle, lying within an assigned field of view of said optical image and being composed of constituent spatial intensity (or amplitude) distributions of directional radiation originating from separate spots located in a respective depth plane being a representative plane for individual directional radiation associated with each of said local object components arranged in a respective zone, and
a computer for selecting data relating to each of a representative sample of said local object components separately and handling other means of said apparatus in carrying out functions and operation, or in providing conditions of employment of said other menas, when necessary, in accordance with selected data;
b) means for reproducing individual distributions of directional radiation, including:
means for providing a first coherent radiation beam,
means for transforming said first coherent radiation beam in a coordinate system by varying parameters of parts of said first radiation beam, which include means for creating at least one representative optical element having spatially distributed optical properties encoded so as to divide said first coherent radiation beam into parts in accordance with selected data relating to all local object components arranged in one of said zones and spatially modulating each of said parts separately and means for employing said representative optical element to produce simultaneously one set of ensembles of partial radiation beams emanating from individual spots located at locations in one plane parallel to a base plane of said coordinate system and disposed with respect to said base plane at a position coordinated with that of said representative plane of said respective zone in respect to said reference plane, in any of said ensembles each of partial radiation beams having parameters coordinated with selected data relating to one of constituent distributions of directional radiation associated with appropriate optical characteristics of the respective of said local object components in said zone for reproducing said constituent distribution and, along with all of said partial radiation beams of said ensemble, an individual spatial intensity (or amplitude) distribution of directional radiation as a whole having optical parameters coordinated with optical characteristics of said local object component, revealing individuality and definite spatial specificy in said assigned field of view to provide the appearance of three-dimensional aspects in said optical image and arising from a local region, and to provide, thereby, a physical reproduction in light of individual spatial intensity (or amplitude) distributions of directional radiation associated with optical characteristics of all said local object components arranged in one of said zones at a time, and
means for establishing local regions of arising of reproduced individual distributions of directional radiation with respect to said coordinate system at locations coordinated with positions of associated local object components arranged in said respective zones and for directing said reproduced individual distributions of directional readition to be recorded holographically onto a corresponding combined area of a recording medium,
all said means having control inputs connected to said computer; and
c) means for holographic recording of said reproduced individual distributions of directional radiation, including:
means for providing a second radiation beam coherent with said first radiation beam,
means for adjusting parameters of said second coherent radiation beam with respect to said coordinate system in accordance with selected data and for directing a reference beam thus produced onto said combined area of said recording medium along with said reproduced individual distributions of directional radiation so as to form in said area a single hologram portion storing each of said reproduced individual distributions of directional radiation and preserving individuality and definite spatial specificity in said assigned field of view, respective spatial intensity or amplitude distributions of directional radiation stored in said single hologram portion being a three-dimensional representation of optical characteristics of its associated local object component arranged in said zone in the virtual space, and
recording means provided with said recording medium and adapted for integrating all of said single hologram portions in said recording medium by a least partial superimposing of some of said portions upon each other for forming a superimposed hologram capable, when illuminated, of rendering simultaneously said spatial intensity (or amplitude) distributions of directional radiation stored in all of said hologram portions, thereby producing an actual three-dimensional optical image of a least a part of said object, said actual image having a complete dimensionality and exhibiting all required three-dimensional aspects of said object in said superimposed hologram,
all said means having control inputs connected to said computer.

84. The apparatus according to claim 83, wherein means for creating at least one representative optical element include a source for a collimated noncoherent light beam and disposed sequentially along an axis of said light beam a spatial light modulator (SLM), a first microlens matrix parallel to said base plane and disposed so as to match a pitch of microlenses with that of SLM pixels, a lens, a cube beamsplitter and a film of photosensitive material, as well as a frist coordinate drive, each microlens being optically coupled with one of said SLM pixels for selecting one beam fraction, focusing said fraction into a plane parallel to said base plane and directing said fraction along said microlens axis parallel to that of said lens as a fractional beam transmitted to and through said lens and said beamsplitter and focused by said lens into said film for creating therein the respective pixel of said optical element, said film being mounted on said first coordinate drive for positioning it in X-Y directions perpendicular to said axis of said lens and for creating one pixel of said optical element by each fractional beam selected at every step until creating using all of said fractional beams said representative optical element with an assigned pixel's picture,
means for employing said representative optical element including a beam expander for receiving said first coherent radiation beam and directing it to another face of said beamsplitter other that a face facing said lens, and to and through said optical element thus created to a second microlens matrix parallel to said base plane and disposed so as to provide optical coupling of each microlens with assigned pixels of said optical element and, thereby, to produce simultaneously said set of ensembles of partial radiation beams, while
means for establishing local regions of arising of reproduced individual distributions of directional radiation including a second coordinate drive installed capable of moving along said lens axis in a Z direction with said SLM, microlens matrixes, lens, beamsplitter and first drive all mounted on the second drive for positioning each set of ensembles of partial radiation beams and establishing individual spots in one plane parallel to said base plane, said SLM, said first and said second coordinate drives having control inputs being those of said means respectively.
